(19) United States
(12) Patent Application Publication
(10) Pub. No.: US 2023/0074720 A1
(43) Pub. Date: Mar. 9, 2023

(54) DATA AND POWER NETWORK OF A FACILITY

(71) Applicant: View, Inc., Milpitas, CA (US)

(72) Inventors: Stephen Clark Brown, San Mateo, CA (US); Nitesh Trikha, Pleasanton, CA (US); Todd Daniel Antes, San Jose, CA (US); Feliciano Vicente Gomez-Martinez, Los Gatos, CA (US); Alexander Rumer, Mountain View, CA (US); Jack Kendrick Rasmus-Vorrath, Mountain House, CA (US); Justin Francis McHargue, San Diego, CA (US)

(21) Appl. No.: 17/904,156

(22) PCT Filed: Feb. 12, 2021
(86) PCT No.: PCT/US2021/017946

§ 371 Date: Aug. 12, 2022

Related U.S. Application Data
(63) Continuation-in-part of application No. 17/609,671, filed on Nov. 8, 2021.
Application No. 17/609,671 is a continuation-in-part of application No. 17/406,301, filed on Aug. 19, 2021.
Application No. 17/406,301 is a continuation of application No. 15/709,339, filed on Sep. 19, 2017, now Pat. No. 11,205,926.
Application No. 15/709,339 is a continuation-in-part of application No. 17/385,810, filed on Jul. 26, 2021.
Application No. 17/385,810 is a division of application No. 16/099,424, filed on Nov. 6, 2018, now Pat. No. 11,114,742.
Application No. 16/099,424 is a continuation-in-part of application No. 16/949,978, filed on Nov. 23, 2020.
Application No. 16/949,978 is a continuation of application No. 16/849,540, filed on Apr. 15, 2020, now Pat. No. 11,462,814.
Application No. 16/849,540 is a continuation of application No. 15/529,677, filed on May 25, 2017, now Pat. No. 10,673,121.
Application No. 15/529,677 is a continuation-in-part of application No. 16/946,140, filed on Jun. 8, 2020.
Application No. 16/946,140 is a continuation of application No. 16/295,142, filed on Mar. 7, 2019, now Pat. No. 10,704,322.
Application No. 16/295,142 is a continuation of application No. 15/268,204, filed on Sep. 16, 2016, now Pat. No. 10,253,558.
Application No. 15/268,204 is a continuation-in-part of application No. 16/949,800, filed on Nov. 13, 2020.
Application No. 16/949,800 is a continuation of application No. 16/439,376, filed on Jun. 12, 2019, now Pat. No. 10,859,887.
Application No. 16/439,376 is a continuation of application No. 15/365,685, filed on Nov. 30, 2016, now Pat. No. 10,365,532.
Application No. 15/365,685 is a continuation of application No. 15/268,204, filed on Sep. 16, 2016, now Pat. No. 10,253,558.
Application No. 15/268,204 is a continuation-in-part of application No. 17/168,721, filed on Feb. 5, 2021, now Pat. No. 11,543,723.
Application No. 17/168,721 is a continuation of application No. 16/380,929, filed on Apr. 10, 2019, now Pat. No. 10,955,718.
Application No. 16/380,929 is a continuation of application No. 16/297,461, filed on Mar. 8, 2019, now Pat. No. 10,908,471.
Application No. 16/297,461 is a continuation of application No. 15/910,931, filed on Mar. 2, 2018, now Pat. No. 10,942,413.
Application No. 15/910,931 is a continuation of application No. 15/739,562, filed on Dec. 22, 2017, now Pat. No. 11,003,041.
Application No. 16/380,929 is a continuation-in-part of application No. 15/320,725, filed on Dec. 20, 2016, now Pat. No. 10,481,459.
Application No. 15/320,725 is a continuation-in-part of application No. 16/447,169, filed on Jun. 20, 2019.
Application No. 16/447,169 is a continuation-in-part of application No. PCT/US19/30467, filed on May 2, 2019.
(60) Provisional application No. 63/146,365, filed on Feb. 5, 2021.
(60) Provisional application No. 63/027,452, filed on May 20, 2020.
(60) Provisional application No. 62/978,755, filed on Feb. 19, 2020.
(60) Provisional application No. 62/977,001, filed on Feb. 14, 2020.
(60) Provisional application No. 62/850,993, filed on May 21, 2019.
(60) Provisional application No. 62/845,764, filed on May 9, 2019.
(60) Provisional application No. 62/379,163, filed on Aug. 24, 2016.
(60) Provisional application No. 62/352,508, filed on Jun. 20, 2016.
(60) Provisional application No. 62/340,936, filed on May 24, 2016.
(60) Provisional application No. 62/333,103, filed on May 6, 2016.
(60) Provisional application No. 62/084,502, filed on Nov. 25, 2014.
(60) Provisional application No. 62/220,514, filed on Sep. 18, 2015.
(60) Provisional application No. 62/220,514, filed on Sep. 18, 2015.
(60) Provisional application No. 62/191,975, filed on Jul. 13, 2015.
(60) Provisional application No. 62/190,012, filed on Jul. 8, 2015.
(60) Provisional application No. 62/019,325, filed on Jun. 30, 2014.
(60) Provisional application No. 62/688,957, filed on Jun. 22, 2018.
(60) Provisional application No. 62/768,775, filed on Nov. 16, 2018.
(60) Provisional application No. 62/803,324, filed on Feb. 8, 2019.
(60) Provisional application No. 62/858,100, filed on Jun. 6, 2019.
(60) Provisional application No. 62/666,033, filed on May 2, 2018.

(51) Int. Cl. H02J 50/10; H02J 50/12; H02J 50/20; H02J 50/30; E06B 9/24; G02F 1/153; G02F 1/163

(52) U.S. Cl. CPC H02J 50/10; H02J 50/12; H02J 50/20; H02J 50/30; E06B 9/24; G02F 1/153; G02F 1/163; E06B 2009/2464

(57) ABSTRACT

A data communications network in or on a building facilitates wired and wireless connectivity. The network may include wiring that convey electrical power, and two type of communication signals. The network may facilitate control of a plurality of devices in an enclosure (e.g., facility) such as sensors, emitters, and/or tintable windows. The disclosure includes network power management.

### PRIORITY APPLICATIONS

This application claims benefit from U.S. Provisional Patent Application Ser. No. 63/146,365, filed Feb. 5, 2021, from U.S. Provisional Patent Application Ser. No. 63/027,452, filed May 20, 2020, from U.S. Provisional Patent Application Ser. No. 62/978,755, filed Feb. 19, 2020; from U.S. Provisional Patent Application Ser. No. 62/977,001, filed Feb. 14, 2020. This application is a continuation in part of International Patent Application Serial No. PCT/US20/32269, filed May 9, 2020, which claims priority to (i) U.S. Provisional Patent Application Ser. No. 62/850,993, filed May 21, 2019, and to (ii) U.S. Provisional Patent Application Ser. No. 62/845,764, May 9, 2019. This application is a continuation in part of U.S. patent application Ser. No. 15/709,339, filed Sep. 19, 2017. This application is also a continuation in part of U.S. patent application Ser. No. 16/099,424, filed Nov. 6, 2018, that is a National Stage Entry of International Patent Application Serial No. PCT/US17/31106, filed May 4, 2017, that claims benefit (i) from U.S. Provisional Patent Application Ser. No. 62/379,163, filed Aug. 24, 2016, (ii) from U.S. Provisional Patent Application Ser. No. 62/352,508, filed Jun. 20, 2016, (iii) from U.S. Provisional Patent Application Ser. No. 62/340,936, filed May 24, 2016, and (iv) from U.S. Provisional Patent Application Ser. No. 62/333,103, filed May 6, 2016. This application is a continuation in part of U.S. patent application Ser. No. 16/949,978, filed Nov. 23, 2020, which is a continuation of U.S. patent application Ser. No. 16/849,540, filed Apr. 15, 2020, that is a continuation of U.S. patent application Ser. No. 15/529,677, filed May 25, 2017, issued as U.S. patent Ser. No. 10/673,121 on Jun. 2, 2020, that is a National Stage Entry of International Patent Application Serial No. PCT/US15/62387, filed Nov. 24, 2015, which claims benefit from U.S. Provisional Patent Application Ser. No. 62/084,502, filed Nov. 25, 2014. This application is a continuation in part of U.S. patent application Ser. No. 16/946,140, filed Jun. 8, 2020, which is a continuation of U.S. patent application Ser. No. 16/295,142, filed Mar. 7, 2019, and issued as U.S. Pat. No. 10,704,322 on Jul. 7, 2020, which is a continuation of U.S. patent application Ser. No. 15/268,204, filed Sep. 16, 2016, and issued as U.S. Pat. No. 10,253,558 on Apr. 9, 2019, which claims benefit from U.S. Provisional Patent Application Ser. No. 62/220,514, filed Sep. 18, 2015. This application is a continuation in part of U.S. patent application Ser. No. 16/949,800, filed Nov. 13, 2020, which is a continuation of U.S. patent application Ser. No. 16/439,376, filed Jun. 12, 2019, and issued as U.S. Pat. No. 10,859,887 on Dec. 8, 2020, which is a continuation of U.S. patent application Ser. No. 15/365,685, filed Nov. 30, 2016, and issued as U.S. Pat. No. 10,365,532 on Jul. 30, 2019, which is a continuation of U.S. patent application Ser. No. 15/268,204, filed Sep. 16, 2016, and issued as U.S. Pat. No. 10,253,558 on Apr. 9, 2019, which claims benefit from U.S. Provisional Patent Application Ser. No. 62/220,514, filed Sep. 18, 2015. This application is also a continuation in part of U.S. patent application Ser. No. 17/168,721 filed Feb. 5, 2021, which is a continuation of U.S. patent application Ser. No. 16/380,929, filed Apr. 10, 2019, which (A) is a continuation of U.S. patent application Ser. No. 16/297,461, filed Mar. 8, 2019, and issued as U.S. Pat. No. 10,908,471 on Feb. 2, 2021, which is a continuation of U.S. patent application Ser. No. 15/910,931, filed on Mar. 2, 2018, which is a continuation of U.S. patent application Ser. No. 15/739,562, filed Dec. 22, 2017, (B) that is a National Stage Entry of International Patent Application Serial No. PCT/US16/41176, filed Jul. 6, 2016, which claims benefit (i) from U.S. Provisional Patent Application Ser. No. 62/191,975, filed Jul. 13, 2015, and (ii) from U.S. Provisional Patent Application Ser. No. 62/190,012, filed Jul. 8, 2015, and (C) Ser. No. 16/380,929 is also a continuation in part of U.S. patent application Ser. No. 15/320,725, filed Dec. 20, 2016, issued as U.S. Pat. No. 10,481,459 on Nov. 19, 2019, which is a National Stage Entry of International Patent Application Serial No. PCT/US15/38667, filed Jun. 30, 2015, which claims benefit from U.S. Provisional Patent Application Ser. No. 62/019,325, filed Jun. 30, 2014; each of which is incorporated herein by reference in its entirety.

### BACKGROUND

As high data rate wireless and wired connectivity becomes not only expected, but at times a necessity, facilities (e.g., buildings) may not only allow transmission of wireless signals, but may also facilitate such transmission and/or facilitate robust wired networks. This would particularly be the case, as wireless connectivity moves to higher frequency carrier bands (e.g., such as is the case with fifth generation (5G) wireless networking) and/or as the physical infrastructure of facilities (e.g., buildings) becomes increasingly network connected.

A cable network that individually addresses a plurality of centrally controlled targets (e.g., devices, or components) can be complex and expensive to materialize as the number of targets it is communicatively coupled to increase. The targets can be of different types (e.g., sensor, antenna, output device and/or tintable window, e.g., comprising an optically switchable device). The complexity of the cable network may escalate further when the network is requested to facilitate streaming a plurality of functionalities (e.g., voice, image, data, and/or electrical current), to and/or from those targets. When a target (e.g., third party device) couples to the network, it may cause the network to collapse or otherwise malfunction (e.g., due to excessive (e.g., electrical) power consumption). When the cable system becomes lengthy and/or includes a plurality of junctions (e.g., nodes), a signal transmitted through this network may be prone to damping such that it may drown in the noise and not be decipherable (e.g., it may degrade as it propagates along the network). Some signals (e.g., 5G signals) that can minimally (e.g., cannot) penetrate into enclosures (e.g., facilities such as buildings) may be required to be transited into the enclosure from an external environment via the cable network. The cable network can become more extensive and/or complex as a number, span, and/or volume of: (e.g., parallel) cable lines, targets, data, communication, and/or electrical power distribution, increases. In some embodiments, distribution of electrical power comprises distribution of any of the electrical power components, e.g., distribution of electrical current. Therefore, a network having conventional cabling type and topology may become expensive and/or unsuitable for such high-density applications.

### SUMMARY

Various aspects disclosed herein alleviate as least part of the above referenced shortcomings.

The present disclosure provides systems, apparatuses, and/or non-transitory computer-readable medium (e.g., software) that facilitate wired and/or wireless connectivity within an enclosure.

In some aspects disclosed herein is a coaxial cable controlled to transmit a plurality of stream types confined to different (e.g., distinguishable) frequency windows. For example, a single stream type can be confined to one or more (e.g., distinguishable) frequency windows. Power to the targets can be controlled (e.g., managed and/or restricted). The targets may be identified, and optionally their identity may be verified (e.g. via blockchain) before being fully connected to the communication network that includes the cabling. The nodes communicatively coupled to the network and/or cable architecture of the network cabling may be designed to preserve and/or enhance the intensity of the signal transmitted through the network. The cable network may facilitate signal transmitted from an external environment to the enclosure into an internal enclosure environment and vice versa, e.g., by using external and internal antennas. The system can include a direct current (abbreviated herein as “DC”) power distributer, a repeater, range extender, and/or signal transponder. Examples of blockchain usage, identification, security, and control systems can be found in U.S. Provisional Patent Application Ser. No. 62/858,634, filed Jun. 7, 2019, entitled, “SECURE BUILDING SERVICES NETWORK,” that is incorporated herein by reference in its entirety.

In another aspect, a system for power and communication transmission in a facility, the system comprises: (a) a cabling system having a cable configured to transmit electrical current, a first communication type utilized for control of at least one device of the facility, and a second communication type configured for media communication, which cabling system is configured to operatively couple to the at least one device; (b) a first antenna configured to receive signals of the second communication type external to the facility and transmit signals of the second communication type externally to the facility, which first antenna is operatively coupled to the cabling system; (c) a second antenna configured to (i) receive signals of the second communication type internal to the facility, and (ii) transmit signals of the second communication type internally in the facility, which second antenna is operatively coupled to the cabling system; and (d) at least one controller operatively coupled to the cabling system and configured to control the at least one device using the first communication type.

In some embodiments, the cable is configured to simultaneously transmit electrical current, the first communication type, and the second communication type. In some embodiments, the first communication type and the second communication type have no overlapping signal frequencies. In some embodiments, the first communication type is in one frequency window. In some embodiments, the first communication type comprises a plurality of frequency windows. In some embodiments, the second communication type is in one frequency window. In some embodiments, the second communication type comprises a plurality of frequency windows. In some embodiments, the cabling system is operatively coupled to one or more signal frequency filters. In some embodiments, the cabling system is operatively coupled to one or more signal amplifiers and/or repeaters. In some embodiments, the second communication type comprises fourth generation (4G) and/or fifth generation (5G) cellular communication. In some embodiments, the second communication type comprises analog radio-frequency signals. In some embodiments, the first antenna is a directional antenna. In some embodiments, the second antenna is part of a distributed antenna system. In some embodiments, the second antenna is disposed in one of a plurality of edge distribution frame devices disposed in the facility. In some embodiments, the electrical current is a direct current. In some embodiments, electrical current directed to the at least one device is at most about 48 volts direct current. In some embodiments, the cable of the cabling system is a coaxial cable. In some embodiments, the cabling system comprises an optical cable. In some embodiments, the facility comprises floors and wherein the cabling system comprises an optical cable that transits the first communication type and/or the second communication type between the floors. In some embodiments, the facility comprises a plurality of control panels and wherein the cabling system comprises an optical cable that transits the first communication type and/or the second communication type between the plurality of control panels. In some embodiments, the cabling system comprises a distribution junction. In some embodiments, the distribution junction distributes the power unevenly. In some embodiments, the distribution junction distributes the first communication type and/or second communication type unevenly. In some embodiments, the distribution junction is passive. In some embodiments, the distribution junction comprises an active element. In some embodiments, the active element is a controller. In some embodiments, the at least one controller is configured to generate the first communication type. In some embodiments, the at least one controller is configured to operatively couple to a building management system. In some embodiments, the first communication type is generated and/or utilized by the at least one device. In some embodiments, the at least one device comprises a sensor, emitter, antenna, tintable window, lighting, security system, heating ventilation and air conditioning system (HVAC). In some embodiments, the sensor is sensitive to movement. In some embodiments, the sensor comprises an accelerometer. In some embodiments, the emitter comprises a light emitter or a sound emitter. In some embodiments, the sensor comprises an infrared, ultraviolet, or visible light sensor. In some embodiments, the sensor is sensitive to at least one environmental characteristic comprising humidity, carbon dioxide, temperature, sound, electromagnetic, volatile organic compound, or pressure. In some embodiments, the sensor comprises a gas sensor sensitive to gas type, movement, and/or pressure. In some embodiments, the device is part of a device ensemble comprising one or more devices enclosed in a housing. In some embodiments, the one or more devices comprise at least two devices of the same type. In some embodiments, the one or more devices comprise at least two devices that are of different types. In some embodiments, the facility is a multi-story building. In some embodiments, the cabling system services at least a portion of the multi-story building. In some embodiments, the multi-story building is a skyscraper.

In another aspect, a method of power and communication transmission in a facility, the method comprises: performing at least one operation using any of the systems disclosed above.

In another aspect, an apparatus for power and communication transmission in a facility, the apparatus comprising at least one controller configured to operatively couple to the system and perform, or direct performance of, at least one operation using any of the systems disclosed above. In some embodiments, the at least one controller comprises circuitry. In some embodiments, at least two of the at least one operation is performed by the same controller of the at least one controller. In some embodiments, at least two of the at least one operation is performed by different controllers of the at least one controller.

In another aspect, a non-transitory computer readable program product for power and communication transmission in a facility, the non-transitory computer program product containing instructions inscribed thereon which, when executed by one or more processors, cause the one or more processors to execute at least one operation using any of the systems disclosed above. In some embodiments, the one or more processors are operatively coupled to the system. In some embodiments, at least two of the at least one operation is executed by the same processor of the one or more processors. In some embodiments, at least two of the at least one operation is executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, an apparatus for controlling at least one device of a facility, the apparatus comprises at least one controller having a circuitry, which at least one controller is configured to: (a) couple to a cabling system having a cable configured to transmit electrical current, a first communication type utilized for control of the at least one device, and a second communication type configured for media communication, which cabling system is configured to operatively couple to the at least one device; (b) couple to a first antenna configured to receive signals of the second communication type external to the facility and transmit signals of the second communication type externally to the facility; (c) couple to a second antenna configured to receive signals of the second communication type internal to the facility and transmit signals of the second communication type internally in the facility; (d) direct the second communication type from the first antenna to the second antenna; direct the second communication type from the second antenna to the first antenna; operatively couple to the at least one device of the facility; and (e) use, or direct usage of, the first communication type to control the at least one device of the facility. In some embodiments, the at least one controller comprises circuitry. In some embodiments, at least two of (a) to (e) are performed by the same controller of the at least one controller. In some embodiments, at least two of (a) to (e) are performed by different controllers of the at least one controller.

In another aspect, a non-transitory computer readable program product for controlling at least one device of a facility, the non-transitory computer readable program product having instructions that, when read by at least one processor, cause the at least one processor to execute operations comprises: (a) transmitting, or directing transmission, through a cable electrical current, a first communication type utilized for control of the at least one device, and a second communication type configured for media communication, which cable is part of a cabling system to which the at least one device is operatively coupled; (b) directing signals of the second communication type received by a first antenna to a second antenna and received by the second antenna to the first antenna, which first antenna is configured to receive signals of the second communication type external to the facility and transmit signals of the second communication type externally to the facility, which second antenna configured to receive signals of the second communication type internal to the facility and transmit signals of the second communication type internally in the facility; and (c) controlling, or directing control of, the at least one device by using the first communication type.

In some embodiments, the one or more processors are operatively coupled to the cabling system. In some embodiments, at least two of the operation are executed by the same processor of the one or more processors. In some embodiments, at least two of the operation are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, a method for controlling at least one device of a facility, the method comprises: (a) transmitting through a cable (i) an electrical current, (ii) a first communication type utilized for control of the at least one device, and (iii) a second communication type configured for media communication, which cable is part of a cabling system to which the at least one device is operatively coupled; (b) directing signals of the second communication type received by a first antenna to a second antenna, and received by the second antenna to the first antenna, which first antenna is configured to receive signals of the second communication type external to the facility and transmit signals of the second communication type externally to the facility, which second antenna configured to receive signals of the second communication type internal to the facility and transmit signals of the second communication type internally in the facility; and (c) controlling the at least one device by using the first communication type.

In some embodiments, the method further comprises simultaneously transmitting the electrical current, the first communication type, and the second communication type, on the cable. In some embodiments, the method further comprises providing and/or using the first communication type and the second communication type such that the first communication type has no overlapping signal frequencies with the second communication type. In some embodiments, the method further comprises providing and/or using the first communication type in one frequency window. In some embodiments, the method further comprises providing and/or using the first communication type in a plurality of frequency windows. In some embodiments, the method further comprises providing and/or using the second communication type in one frequency window. In some embodiments, the method further comprises providing and/or using the second communication type in a plurality of frequency windows. In some embodiments, the method further comprises operatively coupling the cabling system to one or more signal frequency filters. In some embodiments, the method further comprises operatively coupling the cabling system to one or more signal amplifiers and/or repeaters. In some embodiments, the method further comprises providing and/or using the second communication type as a fourth generation (4G) and/or fifth generation (5G) cellular communication. In some embodiments, the method further comprises providing and/or using the second communication type as analog radio-frequency signals. In some embodiments, the method further comprises providing and/or using the first antenna as a directional antenna. In some embodiments, the method further comprises providing and/or using the second antenna as a part of a distributed antenna system. In some embodiments, the method further comprises disposing the second antenna in one of a plurality of edge distribution frame devices disposed in the facility. In some embodiments, the method further comprises providing and/or using the electrical current as a direct current. In some embodiments, the method further comprises providing and/or using the electrical current as a direct current of at most about 48 volts. In some embodiments, the method further comprises providing and/or using the cable of the cabling system as a coaxial cable. In some embodiments, the method further comprises providing and/or using the cabling system that includes an optical cable. In some embodiments, the facility comprises floors. In some embodiments the method further comprises providing and/or using the cabling system that includes an optical cable that is configured to transmit (i) the first communication type and/or (ii) the second communication type, between the floors. In some embodiments, the facility comprises a plurality of control panels. In some embodiments, the method further comprises providing and/or using the cabling system that includes an optical cable that is configured to transmit (i) the first communication type and/or (ii) the second communication type, between the plurality of control panels. In some embodiments, the method further comprises providing and/or using a distribution junction as part of the cabling system. In some embodiments, the method further comprises the distribution junction distributing the power unevenly. In some embodiments, the method further comprises the distribution junction distributing the first communication type and/or second communication type unevenly. In some embodiments, the method further comprises providing and/or using the distribution junction as a passive element. In some embodiments, the method further comprises providing and/or using the distribution junction as an active element. In some embodiments, the method further comprises providing and/or using the active element as a controller. In some embodiments, the cabling system is operatively coupled to a building management system. In some embodiments, the method further comprises generating and/or utilizing the first communication type by the at least one device. In some embodiments, the method further comprises providing and/or using the at least one device that includes a sensor, emitter, antenna, tintable window, lighting, security system, a heating ventilation and air conditioning system (HVAC), or any combination or plurality thereof. In some embodiments, the sensor is configured to sense movement. In some embodiments, the sensor comprises an accelerometer. In some embodiments, the emitter comprises a light emitter or a sound emitter. In some embodiments, the sensor comprises an infrared, an ultraviolet, or a visible light sensor. In some embodiments, the method further comprises wherein the sensor is configured to sense at least one environmental characteristic comprising humidity, carbon dioxide, temperature, sound, electromagnetic, volatile organic compound, or pressure. In some embodiments, the sensor comprises a gas sensor sensitive to: gas type, movement, and/or pressure. In some embodiments, the method further comprises configuring the device to be part of a device ensemble comprising one or more devices enclosed in a housing. In some embodiments, the method further comprises configuring the one or more devices to be at least two devices of the same type. In some embodiments, the method further comprises configuring the one or more devices to be at least two devices of a different type. In some embodiments, the method further comprises configuring the facility to be a multi-story building. In some embodiments, the method further comprises configuring the cabling system to service at least a portion of the multi-story building. In some embodiments, the multi-story building is a skyscraper. In some embodiments, the method further comprises providing and/or using the cabling system as a trunk line cable. In some embodiments, the method further comprises providing and/or using a distribution junction configured for operatively coupling the trunk line cable to a branch line cable.

In another aspect, an apparatus for controlling at least one device of a facility, the apparatus comprises at least one controller having a circuitry, which at least one controller is configured to: (i) operatively couple to a cabling system comprising: a trunk line cable configured to transmit electrical current, a first communication type utilized for control of at least one device, and a second communication type configured for media communication, a branch line cable configured to transmit the electrical current, and (i) the first communication type, and/or (ii) the second communication type, which branch line is configured to couple to the at least one device; a distribution junction comprising a first connection, a second connection, and a third connection, which junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; (g) operatively couple to the at least one device; and (h) use, or direct usage of, the first communication type to control the at least one device.

In some embodiments, the at least one controller is configured to receive, or direct receipt of, an electrical power request (e.g., electrical current request) from the at least one device. In some embodiments, the at least one controller is configured to receive, or direct receipt of, an electrical power requirement (e.g., electrical current requirement) from the at least one device. In some embodiments, the at least one controller is configured to direct the electrical current along the trunk line cable to the at least one device, which electrical current is transmitted through the distribution junction. In some embodiments, transmission of the electrical current through the distribution junction is conducted without control of the at least one controller. In some embodiments, the distribution junction is configured to be not controlled by a first controller configured to control: (i) the electrical current, (ii) the first communication type, (iii) the second communication type, or (iv) any combination thereof. In some embodiments, the distribution junction is controlled by a second controller different than the first controller. In some embodiments, the distribution junction is not controlled by a controller. In some embodiments, the distribution junction is passive. In some embodiments, the distribution junction comprises a controller that controls (i) the electrical current, (ii) the first communication type, and/or (iii) the second communication type, transmitted through the distribution junction. In some embodiments, the distribution junction is active. In some embodiments, the at least one controller is configured to control the directed electrical current in response to the electrical power requirement (e.g., electrical current requirement) received from the at least one device. In some embodiments, the at least one controller is configured to formulate, or direct formulation of, a time schedule for operation of the at least one device. In some embodiments, the at least one controller is configured to determine, or direct determination of, a duration of time it will take for a given process to occur on the device. In some embodiments, the at least one controller is configured to determine, or direct determination of, when the at least one device is required to operate In some embodiments, the at least one controller is configured to determine, or direct determination of, (i) an operational mode, (ii) a scheme for the at least one device, or (iii) any combination or plurality thereof. In some embodiments, the determination is based at least in part on operation of at least one other device operatively coupled to the network. In some embodiments, the operational mode comprises continuous operation and/or intermittent operation. In some embodiments, the at least one device includes a first device having a first operational mode and a second device having a second operational mode, and the at least one controller is configured to interlace, or direct interlacing of, the first and second operational modes. In some embodiments, the at least one device includes a first device configured to issue a first request, and a second device configured to issue a second request, and wherein the at least one controller is configured to interlace, or direct interlacing of, the first request and the second request. In some embodiments, the at least one device is a third-party device. In some embodiments, the at least one controller is configured to manage, or direct managing of, the at least one device. In some embodiments, the at least one controller is configured to operate, or direct operation of, the at least one device. In some embodiments, the at least one controller is configured to identify, or direct identification of, how the at least one controller is operatively coupled (i) to a channel of a plurality of channels, and/or (ii) to a device of the at least one device. In some embodiments, the at least one controller is configured to prioritize, or direct prioritization of, a power budget for the at least one device and/or the channel according to a logic. In some embodiments, the logic comprises business logic. In some embodiments, the logic comprises a spatial designation. In some embodiments, the spatial designation comprises a prioritization of spaces of the facility. In some embodiments, the spatial designation comprises a space of a kind (e.g., of a type). In some embodiments, the spatial designation comprises a space having at least one characteristic comprising a height, a width, a length, a floor area, a volume, a temperature, a humidity level, a pollutant level, a radon level, a particulate level, a carbon dioxide level, a volatile organic compounds (VOCs) level, a pollen level, a residential space, a commercial space, an office space, a space comprising one or more cubicles, a dining space, a living space, a bedroom space, a garage, a factory, a basement, a storage area, a rest room, a closet, a hallway, a corridor, a windowless space, a space having one or more windows, a space having an exterior wall, a space having only interior walls, a thermally insulated space, a thermally uninsulated space, an acoustically insulated space, an acoustically uninsulated space, or any combination thereof. In some embodiments, the spatial designation comprises an occupancy level. In some embodiments, the at least one controller is configured to determine, or direct determination of, the occupancy level by using at least one occupancy sensor. In some embodiments, the at least one occupancy sensor comprises a geolocation, infrared, or visible sensor. In some embodiments, the geolocation sensor is configured to detect electromagnetic radiation comprising ultra-wideband (UWB) radio waves, ultra-high frequency (UHF) radio waves, or radio waves utilized in global positioning system (GPS). In some embodiments, the at least one controller is configured to determine, or direct determination of, the occupancy level based at least in part on dead-reckoning. In some embodiments, the spatial designation comprises an occupancy zone. In some embodiments, the logic comprises a schedule, or one or more external conditions external to the facility. In some embodiments, the logic comprises (i) a device specification (ii) a device power request, (iii) a device power requirement for the at least one device, (iv) a power request from the at least one device, (v) a predicted power usage by the at least one device, (vi) machine learning (ML), (vii) one or more scheduling constraints, (vii) historical data, (viii) product management, or (ix) one or more reasonable inferences. In some embodiments, the device power requirement specifies one or more specifications comprising (i) an amount of power, (ii) a delivery time for the power, or (iii) a delivery duration for the power. In some embodiments, the at least one controller is configured to use, or direct usage of, the power budget prioritization to generate a power distribution scheme for the channel of the plurality of channels, and/or the device of the at least one device. In some embodiments, the at least one controller is configured to distribute, or direct distribution of, electrical power (e.g., electrical current) to the channel of the plurality of channels and/or the device of the at least one device. In some embodiments, the at least one device comprises a plurality of devices, and the at least one controller is configured to define, or direct defining of, a priority listing of devices for electrical power usage among the plurality of devices. In some embodiments, the at least one controller is configured to monitor, or direct monitoring of, electrical power distribution to the plurality of devices, and wherein the plurality of devices is coupled to a network. In some embodiments, the at least one controller is configured to receive, or direct receipt of, an electrical power (e.g., electrical current) budget request from one or more of the plurality of devices. In some embodiments, the at least one controller is configured to consider, or direct consideration of, (i) the electrical power budget request, (ii) the electrical power budget request and any other power budget request, (iii) a distribution status of the electrical power in the network, (iv) a distribution projection of the electrical power in the network at a future time, (v) a historic power usage of any of the plurality of devices in the network, (vi) power usage trends of any of the plurality of devices, or (vii) any combination or plurality thereof. In some embodiments, the at least one controller is configured to generate, or direct generation of, a result pertaining to the power distribution of a device of the plurality of devices from which the at least one controller received the electrical power budget request. In some embodiments, the at least one controller is configured to intermittently supply, or direct intermittent supply of, electrical power to the device of the plurality of devices from which the at least one controller received the electrical power budget request. In some embodiments, the intermittent supply comprises regular (e.g., repeating) intervals. In some embodiments, the intermittent supply comprises irregular (e.g., non-repeating) intervals. In some embodiments, the at least one controller is configured to delay, or direct delay of, a continuous supply of electrical power (e.g., electrical current) to the device of the plurality of devices from which the at least one controller received the electrical power budget request. In some embodiments, the at least one controller is configured to disconnect, or direct disconnection of, a device of the plurality of devices in response to detecting that the device is draining electrical power above a threshold value. In some embodiments, the at least one controller is configured to terminate, or direct termination of, the second communication type to a device of the plurality of devices in response to detecting that the device is utilizing electrical power above a threshold value. In some embodiments, the at least one controller is configured to remove, or direct removal of, at least a portion of the electrical power from a device of the plurality of devices in response to detecting that the device is utilizing electrical power above a threshold value. In some embodiments, the priority listing is based at least in part on business logic. In some embodiments, the electrical power budget request is for an altered power budget. In some embodiments, the power usage trends are determined based at least in part on Machine Learning. In some embodiments, the at least one controller is operatively coupled to a network to which one or more tintable windows are operatively coupled to. In some embodiments, the at least one controller is configured to generate, or direct generation of, a model using one or more operational modes for the tintable windows. In some embodiments, the one or more operational modes include a transition of the one or more tintable windows. In some embodiments, the one or more operational modes comprise Artificial Intelligence or Machine Learning. In some embodiments, the at least one controller is configured to gather, or direct gathering of, information to generate a training set. In some embodiments, the information gathered comprises historical measurements. In some embodiments, the historical measurements are of the facility. In some embodiments, the historical measurements are of another facility. In some embodiments, the gathered information comprises synthesized measurements. In some embodiments, the gathered information is gathered from software and/or hardware of a local controller. In some embodiments, the at least one controller is configured to use, or direct utilization of, the training set to predict electrical power usage of the at least one device at a future time. In some embodiments, the at least one controller is configured to deliver, or direct delivery of, electrical power to the at least one device based at least in part on the prediction of the electrical power (e.g., electrical current) usage of the at least one device at the future time. In some embodiments, the at least one controller comprises circuitry. In some embodiments, at least two of (a) to (h) are performed by the same controller of the at least one controller. In some embodiments, at least two of (a) to (h) are performed by different controllers of the at least one controller.

In another aspect, a method of controlling at least one device of a facility, the method comprising performing at least one operation using operations of any of the at least one controller disclosed above.

In another aspect, a non-transitory computer readable program product for controlling at least one device of a facility, the non-transitory computer program product containing instructions inscribed thereon which, when executed by one or more processors, cause the one or more processors to execute operations of any of the at least one controller disclosed above. In some embodiments, the one or more processors are operatively coupled to the trunk line cable. In some embodiments, at least two of the operation are executed by the same processor of the one or more processors. In some embodiments, at least two of the operation are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, a system for controlling at least one device of a facility, the system comprising structural components of any of the structures (e.g., apparatuses) disclosed above.

In another aspect, a system for power and communication transmission, the system comprises: a trunk line cable configured to transmit an electrical current, a first communication type utilized for control of at least one device, and a second communication type configured for media communication; a branch line cable configured to transmit the electrical current, and (i) the first communication type, and/or (ii) the second communication type, which branch line is configured to couple to the at least one device; and a distribution junction having a first connection, a second connection, and a third connection, which junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable.

In another aspect, a non-transitory computer readable program product for controlling at least one device of a facility, the non-transitory computer readable program product having instructions that, when read by at least one processor, cause the at least one processor to execute operations comprises: (A) transmitting, or directing transmission, through a cabling system an electrical current, a first communication type utilized for control of the at least one device, and a second communication type configured for media communication, which cable is part of a cabling system to which the at least one device is operatively coupled, which cabling system comprises: a trunk line cable configured to transmit the electrical current, a first communication type utilized for control of at least one device, and a second communication type configured for media communication, a branch line cable configured to transmit the electrical current, and (i) the first communication type, and/or (ii) the second communication type, which branch line is configured to couple to the at least one device, and a distribution junction having a first connection, a second connection, and a third connection, which junction configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; and (B) controlling, or directing control of, the at least one device by using the first communication type.

In some embodiments, the one or more processors are operatively coupled to the trunk line cable. In some embodiments, at least two of the operation are executed by the same processor of the one or more processors. In some embodiments, at least two of the operation are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, a method for controlling at least one device of a facility, the method comprises: (A) transmitting through a cabling system an electrical current, a first communication type utilized for control of the at least one device, and a second communication type configured for media communication, which cable is part of a cabling system to which the at least one device is operatively coupled, which cabling system comprises: a trunk line cable configured to transmit the electrical current, a first communication type utilized for control of at least one device, and a second communication type configured for media communication, a branch line cable configured to transmit the electrical current, and (i) the first communication type, and/or (ii) the second communication type, which branch line is configured to couple to the at least one device, and a distribution junction having a first connection, a second connection, and a third connection, which junction configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; and (B) controlling the at least one device by using the first communication type.

In another aspect, a system for power and communication transmission, the system comprises: a trunk line cable configured to transmit an electrical current, a first communication type utilized for control of devices of a facility, and a second communication type configured for media communication; a plurality of branch line cables configured to transmit the electrical current, and (i) the first communication type, and/or (ii) the second communication type, which plurality of branch line cables are configured to couple to the devices; and at least controller that is configured to control distribution of the electrical current and/or activation of the devices by considering the electrical current transmitted in the system.

In another aspect, a n apparatus for controlling devices of a facility, the apparatus comprises at least one controller having a circuitry, which at least one controller is configured to: (A) operatively couple to a cabling system comprising: a trunk line cable configured to transmit an electrical current, a first communication type utilized for control of the devices, and a second communication type configured for media communication, a plurality of branch line cables configured to transmit the electrical current, and (i) the first communication type, and/or (ii) the second communication type, which a plurality of branch line cables are configured to couple to the devices; (B) operatively couple to the devices; and (C) control, or direct control of, distribution of the electrical current and/or activation of the devices by considering the electrical current transmitted in the system.

In some embodiments, the at least one controller comprises circuitry. In some embodiments, at least two of (A) to (C) are performed by the same controller of the at least one controller. In some embodiments, at least two of (A) to (C) are performed by different controllers of the at least one controller.

In another aspect, a non-transitory computer readable program product for controlling devices of a facility, the non-transitory computer readable program product having instructions that, when read by at least one processor, cause the at least one processor to execute operations comprises: (A) transmitting, or directing transmission, through a cabling system an electrical current, a first communication type utilized for control of the devices, and a second communication type configured for media communication, which cable is part of a cabling system to which the devices are operatively coupled, which cabling system comprises: a trunk line cable configured to transmit the electrical current, a first communication type utilized for control of the devices, and a second communication type configured for media communication, a plurality of trunk line cables configured to transmit the electrical current, and (i) the first communication type, and/or (ii) the second communication type, which branch line is configured to couple to the devices; and (B) controlling, or directing control of, distribution of the electrical current and/or activation of the devices by considering the electrical current transmitted in the system.

In some embodiments, the one or more processors are operatively coupled to the cabling system. In some embodiments, the operations (A) and (B) are executed by the same processor of the one or more processors. In some embodiments, the operations are executed by different processors of the one or more processors. In some embodiments, operation (A) is executed a processor different that the processor executing operation (B), which processor and different processor are of the one or more processors. In some embodiments, the non-transitory computer readable program product comprises a non-transitory computer readable medium. In some embodiments, the non-transitory computer readable program product comprises a non-transitory computer readable media.

In another aspect, a method for controlling at least one device of a facility, the method comprises: (A) transmitting through a cabling system an electrical current, a first communication type utilized for control of the at least one device, and a second communication type configured for media communication, which cable is part of a cabling system to which the at least one device is operatively coupled, which cabling system comprises: a trunk line cable configured to transmit the electrical current, a first communication type utilized for control of the devices, and a second communication type configured for media communication, a plurality of trunk line cables configured to transmit the electrical current, and (i) the first communication type, and/or (ii) the second communication type, which branch line is configured to couple to the devices; and (B) controlling distribution of the electrical current and/or activation of the devices by considering the electrical current transmitted in the system.

In another aspect, a system for controlling at least one device of a facility, the system comprises a trunk line cable configured to transmit an electrical current, a first communication type utilized for control of at least one device, and a second communication type configured for media communication, a branch line cable configured to (i) transmit the electrical current, (ii) the first communication type, and/or (iii) the second communication type, which branch line is configured to couple to the at least one device; a distribution junction having a first connection, a second connection, and a third connection, which distribution junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; and (g) operatively couple to the at least one device.

In some embodiments, the distribution junction is configured to facilitate bidirectional communication. In some embodiments, the distribution junction is configured to direct the electrical current along the trunk line cable from the second connection to the first connection. In some embodiments, directing the electrical current, the first communication type and/or the second communication type, is passive. In some embodiments, directing the electrical current, the first communication type and/or the second communication type is (i) active, (ii) dynamic, or (iii) active and dynamic. In some embodiments, directing the electrical current, the first communication type and/or the second communication type is facilitated by at least one controller. In some embodiments, the at least one controller is disposed in the distribution junction. In some embodiments, the at least one controller comprises a microcontroller. In some embodiments, the distribution junction is configured to direct the first communication type and/or the second communication type along the trunk line cable from the second connection to the first connection. In some embodiments, the distribution junction is configured to direct the first communication type and/or the second communication type from the branch line cable to the trunk line cable. In some embodiments, the distribution junction is configured to connect to the at least one device through the trunk line.

In another aspect, a method of controlling at least one device of a facility, the method comprises: (A) using a cabling system comprising: (I) a trunk line cable configured to transmit an electrical current, a first communication type utilized for control of at least one device, and a second communication type configured for media communication, (II) a branch line cable configured to (i) transmit the electrical current, (ii) the first communication type, and/or (iii) the second communication type, which branch line is configured to couple to the at least one device, and (III) a distribution junction having a first connection, a second connection, and a third connection, which distribution junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable, (g) operatively couple to the at least one device; and (B) controlling the at least one device at least in part by using the first communication type.

In some embodiments, the method further comprises providing and/or using the distribution junction that facilitates bidirectional communication. In some embodiments, the method further comprises providing and/or using the distribution junction to direct the electrical current along the trunk line cable from the second connection to the first connection. In some embodiments, the method further comprises providing and/or using the distribution junction to direct the first communication type and/or the second communication type along the trunk line cable from the second connection to the first connection. In some embodiments, the method further comprises providing and/or using the distribution junction to direct the first communication type and/or the second communication type from the branch line cable to the trunk line cable. In some embodiments, the method further comprises providing and/or using the distribution junction to connect to the at least one device through the trunk line. In some embodiments, the distribution junction is configured to passively direct the electrical current, the first communication type and/or the second communication type. In some embodiments, the distribution junction is configured to actively and/or dynamically direct the electrical current, the first communication type and/or the second communication type. In some embodiments, directing the electrical current, the first communication type and/or the second communication type by the distribution junction is facilitated by at least one controller. In some embodiments, the at least one controller is disposed in the distribution junction. In some embodiments, the at least one controller comprises a microcontroller.

In another aspect, an apparatus for controlling at least one device of a facility, the apparatus comprises at least one controller configured to: (A) operatively couple to a cabling system comprising: a trunk line cable configured to transmit an electrical current, a first communication type utilized for control of at least one device, and a second communication type configured for media communication; a branch line cable configured to (i) transmit the electrical current, (ii) the first communication type, and/or (iii) the second communication type, which branch line is configured to couple to the at least one device; a distribution junction having a first connection, a second connection, and a third connection, which distribution junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; (g) operatively couple to the at least one device; and (B) using, or directing usage of, the cabling system; and (C) controlling, or directing control of, the at least one device at least in part by using the first communication type.

In some embodiments, the at least one controller comprises circuitry. In some embodiments, at least two of (A) to (C) are performed by the same controller of the at least one controller. In some embodiments, at least two of (A) to (C) are performed by different controllers of the at least one controller.

In another aspect, a non-transitory computer readable program product for controlling at least one device of a facility, the non-transitory computer program product contains instructions inscribed thereon which, when executed by one or more processors operatively coupled to a cabling system of the facility, cause the one or more processors to execute operations, which cabling system comprises: a trunk line cable configured to transmit an electrical current, a first communication type utilized for control of at least one device, and a second communication type configured for media communication; a branch line cable configured to (i) transmit the electrical current, (ii) the first communication type, and/or (iii) the second communication type, which branch line is configured to couple to the at least one device; a distribution junction having a first connection, a second connection, and a third connection, which distribution junction is configured to: (a) couple along the trunk line cable by the first connection and by the second connection, (b) couple to the branch line by the third connection, (c) direct the electrical current along the trunk line cable from the first connection to the second connection, (d) direct the first communication type and/or the second communication type along the trunk line cable from the first connection to the second connection, (e) direct the electrical current from the trunk line cable to the branch line cable, and (f) direct the first communication type and/or the second communication type from the trunk line cable to the branch line cable; (g) operatively couple to the at least one device; which operations comprise: (A) using, or directing usage of, the cabling system; and (B) controlling, or directing control of, the at least one device at least in part by using the first communication type.

In some embodiments, the one or more processors are operatively coupled to the cabling system. In some embodiments, the operations are executed by the same processor of the one or more processors. In some embodiments, the operations are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, a method of controlling at least one device of a facility, the method comprises: (a) directing transmission of an electrical current from a trunk line cable to a device through a branch line cable operatively coupled to the trunk line cable through a distribution junction configured to direct an electrical current from the trunk line cable to the branch line cable; (b) monitoring an electrical power (e.g., electrical current) consumption of the device over the trunk line cable, the distribution junction, and the branch line cable; and (c) controlling the electrical current from the trunk line cable to the device in response to the monitoring.

In some embodiments, the facility comprises a building. In some embodiments, the facility is a commercial facility. In some embodiments, the facility is a residential facility. In some embodiments, the residential facility comprises a single family house. In some embodiments, the residential facility comprises a multi-family house. In some embodiments, the distribution junction is configured to direct a communication from the trunk line cable to the branch line cable. In some embodiments, the communication comprises a first communication type and a second communication type. In some embodiments, the first communication type utilizes wavelengths different from wavelengths utilized by the second communication type. In some embodiments, the communication comprises media communication. In some embodiments, the communication comprises cellular communication. In some embodiments, the cellular communication conforms to at least (i) a fourth generation, (ii) a fifth generation, or (iii) a fourth generation and a fifth generation, cellular communication protocol. In some embodiments, the communication comprises data transfer. In some embodiments, the communication adheres to a control protocol. In some embodiments, the method further comprises controlling the communication from the trunk line cable to the device in response to the monitoring. In some embodiments, the method further comprises providing and/or using the at least one device as a sensor, an emitter, or a combination thereof. In some embodiments, the method further comprises providing and/or using the at least one device as an antenna.

In another aspect, an apparatus for controlling at least one device of a facility, the apparatus comprising at least one controller configured to operatively couple to the cabling system and perform, or direct performance of, any operation of any of the methods disclosed above. In some embodiments, the at least one controller comprises circuitry. In some embodiments, at least two of the operations are performed by the same controller of the at least one controller. In some embodiments, at least two of the operations are performed by different controllers of the at least one controller.

In another aspect, a non-transitory computer readable program product for controlling at least one device of a facility, the non-transitory computer program product containing instructions inscribed thereon which, when executed by one or more processors operatively coupled to the cabling system, cause the one or more processors to execute any operation of the methods disclosed above. In some embodiments, the one or more processors are operatively coupled to the cabling system. In some embodiments, the operations are executed by the same processor of the one or more processors. In some embodiments, the operations are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, a system for controlling at least one device of a facility, the system comprising structural components of any of the structures (e.g., apparatuses) disclosed above.

In another aspect, a non-transitory computer readable program product for controlling at least one device of a facility, the non-transitory computer program product containing instructions inscribed thereon which, when executed by one or more processors operatively coupled to a cabling system of the facility and to an electrical power (e.g., electrical current) source of an electrical current, cause the one or more processors to execute operations comprises: (a) directing transmission of the electrical current from a trunk line cable of the cabling system to a device of the facility through a branch line cable operatively coupled to the trunk line cable through a distribution junction configured to direct an electrical current from the trunk line cable to the branch line cable; (b) monitoring, or directing monitor of, an electrical power (e.g., electrical current) consumption of the device over the trunk line cable, the distribution junction, and the branch line cable; and (c) controlling, or directing control of, the electrical current from the trunk line cable to the device in response to the monitoring.

In some embodiments, the non-transitory computer readable program product comprises one or more media. In some embodiments, the operations are executed by the same processor of the one or more processors. In some embodiments, the operations are executed by different processors of the one or more processors. In some embodiments, the non-transitory computer readable program product comprises a non-transitory computer readable medium. In some embodiments, the non-transitory computer readable program product comprises a non-transitory computer readable media.

In another aspect, an apparatus for controlling at least one device of a facility, the apparatus comprises at least one controller configured to: (a) operatively couple to a cabling system of the facility and to an electrical power source of an electrical current; (b) direct transmission of the electrical current from a trunk line cable of the cabling system to a device of the facility through a branch line cable operatively coupled to the trunk line cable through a distribution junction configured to direct an electrical current from the trunk line cable to the branch line cable; (c) monitor, or direct monitoring of, an electrical power consumption of the device over the trunk line cable, the distribution junction, and the branch line cable; and (d) control, or direct control of, the electrical current from the trunk line cable to the device in response to the monitoring.

In some embodiments, the at least one controller comprises circuitry. In some embodiments, at least two of (b) to (d) are performed by the same controller of the at least one controller. In some embodiments, at least two of (b) to (d) are performed by different controllers of the at least one controller.

The present disclosure provides systems, apparatuses, and/or non-transitory computer-readable medium (e.g., software) that facilitate wired and/or wireless connectivity within an enclosure and between the enclosure and an external environment. In certain implementations, a control panel is provided that is configured to provide network services to end targets (e.g., devices) in a facility (e.g., building). The end targets (e.g. devices) may be coupled together by a network including at least one coaxial cable. The control panel can include a coaxial cable connector configured to couple to the at least one coaxial cable. The control panel may include a direct-current (DC) electrical power source, a data networking head-end, and/or cellular communications head-end. In some embodiments, the DC power source is (i) coupled to the coaxial cable connector and (ii) configured to provide a DC signal to at least a portion of the at least one coaxial cable. In some embodiments, the data networking head-end is (i) coupled to the coaxial cable connector and (ii) configured to communicate with (e.g., using a communications protocol and/or over the at least one coaxial cable) at least a first subset of the end targets (e.g., devices) in the enclosure (e.g., building). In some embodiments, the cellular communications head-end is coupled to the coaxial cable connector. In some embodiments, the cellular communications head-end is coupled to at least a second subset of the end targets (e.g., devices) in the enclosure (e.g., building) through the at least one coaxial cable. In some embodiments, the cellular communications head-end is configured to provide first cellular communications to the coaxial cable connector for transmission through the second subset of the end targets (e.g., devices). In some embodiments, the cellular communications head-end is configured to receive second cellular communications from the coaxial cable connector upon receipt of the second cellular communications by the second subset of the end targets (e.g., devices).

Certain implementations may include one or more of the following features. A control panel in which the second subset of the end devices includes a cellular antenna and the cellular communications head-end is configured to transmit the first cellular communications through the cellular antenna and receive the second cellular communications upon reception of the second cellular communications by the cellular antenna. A control panel in which the second subset of the end devices includes a passive antenna and the cellular communications head-end is configured to transmit the first cellular communications through the passive antenna and receive the second cellular communications upon reception of the second cellular communications by the passive antenna. A control panel in which the data networking head-end is a G.hn head-end and the communications protocol is a G.hn protocol. A control panel in which the data networking head-end is a multimedia over coax alliance (MoCA) head-end and the communications protocol is a MoCA protocol. A control panel in which the first subset of the end devices are power-consuming devices and the control panel also includes a controller configured to manage consumption of the direct-current signal amongst the power-consuming devices by negotiating with the (e.g., electrical) power-consuming devices through the data networking head-end. A control panel that also includes a plurality of optical fiber connectors, where the control panel is configured to communicate with additional control panels through optical fibers coupled to the optical fiber connectors. A control panel in which the first subset of the end devices includes a plurality of window controllers and the control panel also includes a floor window controller, the floor window controller configured to (i) generate tint transition instructions and (ii) send the tint transition instructions to the window controllers using the data networking head-end. A control panel in which the data networking head-end is configured to generate and receive signals in a first frequency range as part of communicating in the communications protocol, where the first and second cellular communications are in a second frequency range, and where the first and second frequency ranges do not overlap.

Certain implementations may include an apparatus for controlling one or more optically-switchable windows, the apparatus including a first connector, the first connector configured to couple to a first network cable; a low-pass filter coupled to the first connector; DC-to-DC circuitry coupled to the low-pass filter, configured to receive a DC signal from the first network cable through the low-pass filter, and configured to convert the DC signal into one or more regulated DC signals; a second connector, the second connector configured to provide a first regulated DC signal from the DC-to-DC circuitry to a second network cable; one or more controllers, where the one or more controllers are collectively configured to (1) receive and be powered by one of the regulated DC signals from the DC-to-DC circuitry and (2) provide bidirectional communications between a first external device and a second external device, the first external device being coupled to the one or more controllers via the first connector and the second external device being coupled to the one or more controllers via the second connector; a third connector, the third connector configured to couple to the one or more one optically-switchable windows via a window cable; and a window controller, the window controller configured to (i) receive and be powered by one of the regulated DC signals from the DC-to-DC circuitry, (ii) receive or generate tint transition instructions, and (iii) provide tint transition signals to at least one optically-switchable window via the third connector, the tint transition signals being based on the tint transition instructions.

Certain implementations may include one or more of the following features. An apparatus in which the first external device is a control panel providing at least the DC signal, in which the second external device is an end device, and in which the one or more controllers are configured to receive a power delivery request from the end device and are configured to forward the power delivery request to the control panel. An apparatus in which the one or more controllers are configured to negotiate power consumption by the second external device of the first regulated DC signal and in which, prior to negotiating power consumption, the one or more controllers are configured to limit the power consumption by the second external device of the first regulated DC signal to a predetermined limit. An apparatus in which the one or more controllers include a G.hn interface coupled to the first connector, the G.hn interface being configured to provide bidirectional communications in a G.hn communications protocol between the first external device and the apparatus. An apparatus in which the one or more controllers include a multimedia over coax alliance (MoCA) interface coupled to the first connector, the MoCA interface being configured to provide bidirectional communications in a MoCA communications protocol between the first external device and the apparatus. An apparatus in which the one or more controllers include an Ethernet interface coupled to the second connector, the Ethernet interface being configured to provide bidirectional communications in an Ethernet protocol between the second external device and the apparatus. An apparatus in which the one or more controllers include a G.hn interface coupled to the first connector, the G.hn interface being configured to provide bidirectional communications in a G.hn communications protocol between the first external device and the apparatus, in which the one or more controllers include an Ethernet interface coupled to the second connector, the Ethernet interface being configured to provide bidirectional communications in an Ethernet protocol between the second external device and the apparatus, and in which the one or more controllers are configured to translate communications between the G.hn and Ethernet protocols. An apparatus in which the low-pass filter includes an inductor choke. An apparatus in which the DC-to-DC circuitry includes at least one of a buck converter and a boost converter. An apparatus in which the first regulated DC signal, provided to the second connector, includes a 48 volt DC signal compliant with a power-over-Ethernet protocol.

Certain implementations may include a network adapter. The network adapter includes a first connector, the first connector configured to couple to a first network cable; a low-pass filter coupled to the first connector; DC-to-DC circuitry coupled to the low-pass filter, configured to receive a DC signal from the first network cable through the low-pass filter, and configured to convert the DC signal into one or more regulated DC signals; a second connector, the second connector configured to provide one of the regulated DC signals from the DC-to-DC circuitry to a second network cable; and one or more controllers, wherein the one or more controllers are collectively configured to: (1) receive and be electrically powered by one of the regulated DC signals from the DC-to-DC circuitry, (2) bi-directionally communicate, using a first communications protocol, with a first external device, the first external device coupled to the one or more controllers via the first connector, (3) bi-directionally communicate, using a second communications protocol, with a second external device, the second external device coupled to the one or more controllers via the second connector, and (4) provide bidirectional communications between the first external device and the second external device including converting communications in the first communications protocol to communications in the second communications protocol and vice-versa.

Certain implementations may include one or more of the following features. A network adapter in which the first external device is a control panel providing at least the DC signal, in which the second external device is an end device, and in which the one or more controllers are configured to receive a (e.g., electrical) power delivery request from the end device in the first communications protocol and are configured to forward the power delivery request to the control panel in the second communications protocol. A network adapter in which the one or more controllers are configured to negotiate power consumption by the second external device of the first regulated DC signal, and in which, prior to negotiating power consumption, the one or more controllers are configured to limit the power consumption by the second external device of the first regulated DC signal to a predetermined limit. A network adapter in which the one or more controllers include a G.hn interface coupled to the first connector and in which the first communications protocol is a G.hn communications protocol. A network adapter in which the one or more controllers include a multimedia over coax alliance (MoCA) interface coupled to the first connector and in which the first communications protocol is a MoCA communications protocol. A network adapter in which the one or more controllers include an Ethernet interface coupled to the second connector and in which the second communications protocol is an Ethernet communications protocol. A network adapter in which the first connector is a coaxial cable connector and in which the second connector is a power-over-Ethernet connector. A network adapter in which the one of the regulated DC signals provided by the second connector is a 48 volt DC signal compliant with a power-over-Ethernet protocol.

Certain implementations may include a system. The system includes a control panel configured to generate a DC signal; a plurality of distribution junctions; a first coaxial cable trunk line; and a plurality of additional coaxial cable trunk lines, where the first coaxial cable trunk line is coupled between the control panel and a first one of the distribution junctions, where the additional coaxial cable trunk lines are coupled between respective pairs of the distribution junctions, where the distribution junctions, the first coaxial cable trunk line, and the additional coaxial cable trunk lines are collectively configured to (i) convey the DC signal from the control panel to each of the distribution junctions, (ii) bidirectionally convey first time-varying signals formatted in a first digital communications protocol between the control panel and each of the distribution junctions, and (iii) bidirectionally convey second time-varying signals formatted in a second digital communications protocol between the control panel and at least one of the distribution junctions, where the first time-varying signals are signals in a first band of frequencies, where the second time-varying signals are signals in a second band of frequencies, and where the first and second bands of frequencies do not overlap.

Certain implementations may include one or more of the following features. A system in which each distribution junction includes: an unbalanced transformer having a primary circuit, a secondary circuit, and a tertiary circuit, where the primary circuit is coupled to an upstream coaxial cable trunk line, where the secondary circuit is coupled to a downstream coaxial cable trunk line, where the tertiary circuit is coupled to a coaxial cable branch line specific to that distribution junction, and where a first time-varying signal that has a first (e.g., communication signal such as RF) power level and that is received by the primary circuit is divided unequally onto the second and tertiary circuits such that the second circuit receives the first time-varying signal at a second (e.g., communication signal such as RF) power level that is at least 75% of the first power level and that the tertiary circuit receives the first time-varying signal at a third (e.g., communication signal such as RF) power level that is no more than 25% of the first power level. A system in which each distribution junction includes: an unbalanced transformer having a primary circuit, a secondary circuit, and a tertiary circuit, where the primary circuit is coupled to an upstream coaxial cable trunk line, where the secondary circuit is coupled to a downstream coaxial cable trunk line, where the tertiary circuit is coupled to a coaxial cable branch line specific to that distribution junction, and where a first time-varying signal that has a first power level and that is received by the primary circuit is divided unequally onto the second and tertiary circuits such that the second circuit receives the first time-varying signal at a second power level, the tertiary circuit receives the first time-varying signal at a third power level, and the third power level is less than the second power level. A system in which at least some of the distribution junctions further include a first inductor coupling the DC signal from the upstream coaxial cable trunk line to the downstream coaxial cable trunk line associated with that distribution junction and a second inductor coupling the DC signal from the upstream coaxial cable trunk line to the coaxial cable brane line associated with that distribution junction. A system in which the second time-varying signals are cellular communications signals and in which the first one of the distribution junctions includes a branch circuit including a passive cellular antenna. A system in which the first band of frequencies associated with the first time-varying signals are lower than the cellular communications signals and in which the first one of the distribution junctions includes a low-pass filter configured to block the cellular communications signals from propagating through the first one of the distribution junctions to the rest of the distribution junctions. A system in which the first band of frequencies associated with the first time-varying signals are lower than the cellular communications signals and in which at least one of the distribution junctions includes a low-pass filter configured to block the cellular communications signals from propagating from the upstream coaxial cable trunk line to the downstream coaxial cable trunk line associated with that distribution junction. A system in which a second one of the distribution junctions is directly coupled to the first one of the distribution junctions by a first one of the additional coaxial cable trunk lines and in which the second one of the distribution junctions includes a branch circuit including an additional passive cellular antenna. A system in which the first band of frequencies associated with the first time-varying signals are lower than the cellular communications signals and in which the second one of the distribution junctions includes a low-pass filter configured to block the cellular communications signals from propagating beyond the first and second distribution junctions to the rest of the distribution junctions.

In another aspect, the present disclosure provides systems, apparatuses (e.g., controllers), and/or non-transitory computer-readable medium (e.g., software) that implement any of the methods disclosed herein.

In another aspect, the present disclosure provides methods that use any of the systems and/or apparatuses disclosed herein, e.g., for their intended purpose.

In another aspect, an apparatus comprises at least one controller that is programmed to direct a mechanism used to implement (e.g., effectuate) any of the method disclosed herein, wherein the at least one controller is operatively coupled to the mechanism.

In another aspect, an apparatus comprises at least one controller that is configured (e.g., programmed) to implement (e.g., effectuate) the method disclosed herein. The at least one controller may implement any of the methods disclosed herein.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may direct any apparatus (or component thereof) disclosed herein.

In another aspect, a computer software product, comprising a non-transitory computer-readable medium in which program instructions are stored, which instructions, when read by a computer, cause the computer to direct a mechanism disclosed herein to implement (e.g., effectuate) any of the method disclosed herein, wherein the non-transitory computer-readable medium is operatively coupled to the mechanism. The mechanism can comprise any apparatus (or any component thereof) disclosed herein.

In another aspect, the present disclosure provides a non-transitory computer-readable medium comprising machine-executable code that, upon execution by one or more computer processors, implements any of the methods disclosed herein.

In another aspect, the present disclosure provides a non-transitory computer-readable medium comprising machine-executable code that, upon execution by one or more computer processors, effectuates directions of the controller(s) (e.g., as disclosed herein).

In another aspect, the present disclosure provides a computer system comprising one or more computer processors and a non-transitory computer-readable medium coupled thereto. The non-transitory computer-readable medium comprises machine-executable code that, upon execution by the one or more computer processors, implements any of the methods disclosed herein and/or effectuates directions of the controller(s) disclosed herein.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically depicts a control system architecture and perspective view of an enclosure;

FIG. 2 schematically depicts a network infrastructure;

FIG. 3 schematically depicts an electrical circuit and shows a distribution junction housing;

FIG. 4 schematically depicts a network cable;

FIG. 5 schematically depicts signals at different frequencies;

FIG. 6 schematically depicts a network adapter;

FIG. 7 schematically depicts a control panel;

FIG. 8 schematically depicts a network infrastructure;

FIG. 9 schematically depicts a network infrastructure;

FIG. 10 schematically depicts a network infrastructure;

FIGS. 11A, 11B, and 110 schematically depicts network infrastructures;

FIG. 12 schematically depicts a cross-sectional view of an electrochromic device;

FIG. 13 schematically depicts a cross-sectional side view of a tintable window;

FIG. 14 schematically depicts a computer system;

FIG. 15 schematically depicts various facility floor network topologies.

FIG. 16A schematically depicts a facility floor network topology, and FIG. 16B depicts a view of a portion of the facility floor network;

FIGS. 17A-B schematically depicts various facility floor network topologies;

FIG. 18 schematically depicts a facility floor network topology;

FIG. 19 schematically depicts an electronic schematics of a distribution junction;

FIG. 20 schematically depicts various mechanical configurations related to distribution junctions;

FIG. 21 schematically depicts various mechanical configurations related to distribution junctions;

FIG. 22 schematically depicts an electronic schematic of a distribution junction;

FIG. 23 schematically depicts various network infrastructures;

FIG. 24 depicts a flowchart of an illustrative method of utilizing a distribution junction;

FIG. 25 depicts a flowchart depicting an illustrative method of managing a device;

FIG. 26 depicts a flowchart depicting an illustrative method of prioritizing a power budget for a device;

FIG. 27 depicts a flowchart depicting an illustrative method of managing power distribution for a device; and

FIG. 28 depicts a flowchart depicting an illustrative method of managing devices in the context of tintable windows.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.” The conjunction “and/or” is meant to have the same effect as the phrase “at least one X, Y, Z, or any combination thereof.” The conjunction “and/or” is meant to have the same effect as the phrase at least one of: X, Y, and Z.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling. The non-physical coupling may comprise signal-induced coupling (e.g., wireless coupling). Coupled can include physical coupling (e.g., physically connected), or non-physical coupling (e.g., via wireless communication).

An element (e.g., mechanism) that is “configured to” perform a function includes a structural feature that causes the element to perform this function. A structural feature may include an electrical feature, such as a circuitry or a circuit element. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

Certain disclosed embodiments provide a network infrastructure in an enclosure (e.g., a facility such as a building). The network infrastructure is available for various purposes such as for providing communication and/or electrical power (e.g., electrical current) services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes tintable (e.g., electrically switchable) windows. Examples of components of the network infrastructure include a high speed backhaul. The network infrastructure may include at least one cable, switch, physical antenna, transceivers, sensor, transmitter, receiver, radio, processor or controller (that may comprise a processor). The network infrastructure may be operatively coupled to, and/or include, a wireless network. The network infrastructure may comprising wiring.

In some embodiments, the network infrastructure may comprise a wiring. The wiring may comprise a cable. The cable may include a jacket, insulation, an electrical wire, and/or an optical fiber. The cable may comprise a cable assembly. The cable may include at least one optical cable, coaxial cable, twisted pair, direct buried cable, flexible cable, filled cable, Heliax cable, non-metallic sheathed cable, metallic sheathed cable, multicore cable, paired cable, portable cord, ribbon cable, shielded cable, single cable, structured cabling, submersible cable, twinaxial (twinax) cable, twin and earth (T&E) cable, twin-lead, and/or twisted pair. The coaxial cable may have a characteristic impedance of, e.g., of at most about 50, or 75 ohms (e.g., LMR-400).

In some embodiments, the network infrastructure provides additional coverage. The additional coverage may be beyond the one provided by the cellular carrier. The additional coverage may be (i) in the interior of the building and/or (ii) in the exterior of the building. For example, the network infrastructure may provide and/or supplement the cellular carrier's ability to provide coverage and any other capacity outside the building. For example, the network infrastructure may provide and/or supplement cellular coverage near to the facility (e.g., building). Near the facility can be, e.g., at least about 10 m, 50 m, 100 m, 500 m, or 1000 meters (m) from an edge of the facility. Near the facility can be between any of the aforementioned values (e.g., from about 10 m to about 1000 m, from about 10 m to about 500 m, or from about 500 m to about 1000 m). Near the building may be within a line of site of the facility. In some cases, a facility and its associated network infrastructure can serve as a cellular tower.

High speed and high frequency communications protocols, such as fifth generation (5G) communication protocol, face challenges before they can be widely accepted and deployed. For example, compared to lower frequency communications bands, high frequency bands may require more antennas. For example, it is estimated that to deploy a 5G cellular service in a given area will require over twice as many antennas as are required to provide the same level of cellular service for fourth generation (4G) communication protocol. Some of those antennas may be provided in a facility or a portion of a facility. Consider the example of providing 5G coverage in an urban canyon, such as a street in major metropolitan area such as Manhattan N.Y., or Singapore. 5G service may require many antennas to provide adequate coverage and adequate capacity in these cities. Currently, there is insufficient public space (e.g., telephone poles) where a carrier could deploy additional antennas to provide adequate 5G coverage (and/or other cellular capacity). The private buildings that line an urban canyon can provide locations for 5G antennas.

5G and other high frequency protocols may be susceptible to attenuation. 5G communications (particularly at their high frequency bands such as in the range of from about 6 to about 30 GHz) can be susceptible to attenuation by conductive structures such as, e.g., reinforced concrete in walls, aluminum coated thermal insulation (e.g., in facility walls and floors), Low-E films on glass, and/or electrochromic devices on glass. To address this, active elements such as repeaters may be provided in a facility. For example, cellular repeaters may be disposed on or proximate the walls, windows, floors, and/or ceilings that attenuate wireless signals.

When describing the cellular protocols disclosed herein, 5G is frequently used as an example. However, the disclosed embodiments pertain to any wireless communications protocol or combination of protocols.

The communications infrastructure described herein may serve various functions, some of which are listed here.

In some embodiments, one or more systems and/or apparatuses described herein are configured to selectively attenuate (e.g., block) and/or transmit wireless signals, e.g., in a controllable manner. In various embodiments, a system and/or apparatus is configured such that transmission of wireless communications is based at least in part on location, and/or time. In various embodiments, a system, an apparatus, or any component thereof, is configured such that it is at least partially automatically controlled (e.g., fully automatically controlled). One or more components of the system and/or apparatus described herein is fully automatically controlled. Controlled may include attenuated, modulated, varied, managed, curbed, disciplined, regulated, restrained, supervised, manipulated, and/or guided. In some embodiments, control is accomplished by using controllable active elements that receive, analyze, manipulate (e.g., convert and/or compare) and/or retransmit signals. For example, (i) a receiving antenna may face in one direction on one side of a facility (e.g., of a wall or a window) and (ii) a transmitter antenna may face in another (e.g., opposite or substantially opposite) direction on the other side of facility (e.g., on another wall or window). Between the receiver and the transmitter, the active element can include one or more transceivers and/or other signal converters. In some embodiments, (I) when the active element is active (e.g., “on”), it is transmitting signal, and (II) when the element is inactive (e.g., “off”), it is not transmitting signal.

In some embodiments, an active element that receives and retransmits wireless communications signals (e.g., automatically) is a repeater. The repeater may boost signal and/or transmit it to a location that would not otherwise receive the signals. A repeater (or other active element) may include a particular antenna combination. The antenna combination may include one type of antenna on the inside of the facility (e.g., building) and a different type of antenna on the outside of the facility (or on opposites of an internal wall or window). In relation to the description of various antenna types herein, some embodiments employ a handle antenna on the outside the building operatively coupled to one of the other antennas (e.g., a microstrip antenna) on the inside of the building. In some implementations, one or both antennas are disposed on a mullion feature such as a beauty cap. The antenna may comprise an isotropic, dipole, monopole, array, loop, conical, aperture, traveling wave, or random wire antenna. The loop antenna may include large loops (e.g., Quad, or Half-loop), interbetween (e.g., Halo), and/or small loops (e.g., Ferrite) antenna.

It has been observed that electrochromic windows may provide signal blocking in the range of from about 10 dB to about 20 dB of insertion loss (e.g., depending on the transmission frequency). Greater loss may occur at higher frequencies. Some embodiments disclosed herein employ wireless re-transmitters and/or repeaters, to circumvent the signal blocking by electrochromic windows. In some embodiments, such re-transmitters are disposed on or proximate to at least one Integrated Glass Unit (IGU). The IGU may comprise an electrochromic device (e.g., comprising a layers structure).

In certain embodiments, a window and/or wall contains a layer or structure that substantially (e.g., fully) blocks wireless transmission, e.g., over a spectral range. The layer structure may be of an IGU. In one example, a blocking layer completely covers one surface of a lite (e.g., glass). Examples of blocking structures for windows are described in U.S. patent application Ser. No. 15/709,339, filed Sep. 19, 2017, which is incorporated herein by reference in its entirety. Security systems may employ a facility structure that attenuates (e.g., depress) transmission of one or more electromagnetic signals, for example, in certain regions of the spectrum (e.g., in at least the 5G region). The facility structure may comprise a window, door, or wall. Security systems (e.g., employing repeaters) may employ a wall and/or window that substantially (e.g., effectively) block transmission of one or more electromagnetic signals, for example, in certain regions of the spectrum (e.g., in at least the 5G region).

In some embodiments, a signal repeater and/or re-transmitter need not retransmit the wireless signal (e.g., directly) across the facility structure (e.g., a wall or window). In some cases, it selectively transmits wireless signal through the facility to one or more locations remote from where the signal was received. It may carry the received signal using a wired network, e.g., by running a communication protocol such as Ethernet. For example, an externally generated wireless signal can be received on sensor disposed on a roof of a building (or on any other exterior wall) and, from there, transmitted over wires to one or more distant locations within the facility (such as ten floors below the roof, e.g., to the basement).

In some cases, a re-transmitting system transmits cellular signals (or other appropriate wireless signals) to selected building locations at one or more selected times, which may be delayed from the time at which a wireless signal was initially received. The communications may be stored or have its transmission delayed. The re-transmission may be done independently of where and when communications embodied in the cellular signals are received.

Given the large number of 5G antennas expected to be required for adequate coverage and capacity in building-dense regions such as centers of certain large cities, deploying 5G antennas on exterior portions of buildings may supplement the data carrying and antenna infrastructure of a cellular network of a carrier. In some cases, such antennas are connected to high bandwidth network infrastructures such as the Ethernet network infrastructure within the buildings. An example fully or partially wired network infrastructure for supporting such 5G applications is described in U.S. Provisional Patent Application Ser. No. 62/803,324, filed Feb. 8, 2019, which is incorporated herein by reference in its entirety.

Various arrangements of antennas may be deployed to support 5G cellular and/or other communications services. Both coverage and capacity can be considered when designing the wireless communication infrastructure. Coverage can be addressed by providing various antennas strategically located (e.g., attached to, or as part of, a facility) to provide cellular service to a defined area. Capacity may be addressed by having high-bandwidth data carrying lines and/or switches. Some examples of high capacity infrastructure are provided in U.S. Provisional Patent Application Ser. No. 62/803,324, filed Feb. 8, 2019, which is incorporated herein by reference in its entirety. Capacity may also be addressed by providing a plurality of antennas, e.g., within a defined region.

In certain embodiments, individual antennas are dedicated to particular protocols. At least one of the antennas (e.g., each of the antennas) may have its own base band radio. For example, one or more antennas may be designed for use with low power citizens broadband radio (CBRS), e.g., including a CBRS base band radio. In the United States, CBRS is about 150 MHz wide broadcast band of the about 3.5 GHz band (e.g., from about 3550 MHz to about 3700 MHz), that may be used to provide wireless services unlicensed by the United States Federal Communications Commission. Other antennas and associated base band radios may be provided for cellular communications, e.g., according with a particular protocol and/or jurisdictional restrictions (e.g., rules and/or regulations). The required base band radios may be installed at one or more locations of a facility, including, e.g., in digital architectural elements. Digital architecture may refer to aspects of architecture that feature one or more digital technologies.

Various embodiments support multiple frequency bands and/or multiple protocols. Examples include cellular (3G, 4G, and/or 5G, etc.). Examples include local area networking of devices and/or Internet access. Examples include wireless networks including WLANs (e.g., WiFi) and/or associated applications such as voice over WLAN. Examples include Citizens Broadband Radio Service (CBRS). A given antenna (or combination of antennas) can be is protocol independent. The associated transmitters and/or receivers can be protocol independent. For example, carrier A and carrier B may use different radios (e.g., different channels utilizing Multimedia over Coaxial Alliance standard (MoCA) for networking over coaxial cable). Similar antenna structures may be used to send and/or receive signals for a plurality of protocols.

5G network may have an Enhanced Mobile Broadband (eMBB), Ultra Reliable Low Latency Communications (URLLC), and/or Massive Machine Type Communications (mMTC). Enhanced Mobile Broadband (eMBB) may use 5G as a progression from 4G LTE mobile broadband services. 5G network may exhibit faster connections, higher throughput, and/or more capacity as compared to 4G network. Ultra-Reliable Low-Latency Communications (URLLC) may refer to using the network for applications requiring uninterrupted and/or robust data exchange. Massive Machine-Type Communications (mMTC) can be used to connect to a large number of low electrical power (e.g., electrical current), low cost devices, which have high scalability and/or increased battery lifetime, e.g., in a wide area.

In some embodiments, a 5G network will transmit at least about 1 Gbit of data per second (Gbit/s), 2 Gbit/s, 3 Gbit/s, or 5 Gbit/s. In some embodiments, the 5G air latency target is at least about 1 millisecond (ms), 2 ms, 3 ms, 4 ms, 5 ms, 8 ms, 10 ms, 11 ms, 15 ms, or 30 ms. The 5G air latency target can be at most about 2 ms, 3 ms, 4 ms, 5 ms, 8 ms, 10 ms, 12 ms, 15 ms, 30 ms, or 40 ms. The 5G air latency target can be of any value between the aforementioned values (e.g., from about 1 to about 4 ms, from about 3 ms to about 10 ms, from about 8 ms to about 12 ms, or from about 12 ms to about 40 ms).

In some embodiments, certain infrastructures contain devices for interior (e.g., within a building) communications via a 5G protocol, e.g., without supporting Wi-Fi. Several 5G antennas may be deployed throughout a building (e.g., when 5G may be limited to a line of sight). The antennas may be disposed at one or more locations where Wi-Fi antennas normally reside. In some installations, 5G will have sufficient bandwidth and/or coverage to serve one or more of (e.g., all) the functions that Wi-Fi currently serves.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure about 30%, 20%, 10%, 5%, or 1% of the walls(s). The wall(s) may comprise a floor, a ceiling or a side wall. The closable opening may be closed by at least one window or door. The enclosure may be at least a portion of a facility. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, a plane, a ship, a vehicle, or a rocket). The facility may include one or more enclosures. The facility may be stationary or mobile. For example, the facility may comprise a transitory vehicle such as a car, RV, buss, train, airplane, helicopter, ship, or boat. For example, the facility may include one or more buildings.

In some embodiments, the enclosure encloses an atmosphere. The atmosphere may comprise one or more gases. The gases may include inert gases (e.g., argon or nitrogen) and/or non-inert gases (e.g., oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or electrical power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network.

In various embodiments, a network infrastructure supports a control system for one or more windows such as electrochromic (e.g., tintable) windows. The control system may comprise one or more controllers operatively coupled (e.g., directly or indirectly) to one or more windows. While the disclosed embodiments describe electrochromic windows (also referred to herein as “optically switchable windows,” “tintable windows”, or “smart windows”), the concepts disclosed herein may apply to other types of switchable optical devices including, for example, a liquid crystal device, or a suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). For example, a liquid crystal device and/or a suspended particle device may be implemented instead of, or in addition to, an electrochromic device. The tintable window may be disposed in a (non-transitory) facility such as a building, and/or in any other enclosure such as in a transitory vehicle such as a car, RV, buss, train, airplane, helicopter, ship, or boat.

In some embodiments, a tintable window exhibits a (e.g., controllable and/or reversible) change in at least one optical property of the window, e.g., when a stimulus is applied. The stimulus can include an optical, electrical and/or magnetic stimulus. For example, the stimulus can include an applied voltage. One or more tintable windows can be used to control lighting and/or glare conditions, e.g., by regulating the transmission of solar energy propagating through them. One or more tintable windows can be used to control a temperature within an enclosure (e.g., building), e.g., by regulating the transmission of solar energy propagating through them. Control of the solar energy may control heat load imposed on the interior of the enclosure (e.g., a facility such as a building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of an enclosure structure (e.g., facility such as a building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. patent application Ser. No. 14/443,353 filed May 15, 2015, titled “MULTI-PANE WINDOWS INCLUDING ELECTROCHROMIC DEVICES AND ELECTROMECHANICAL SYSTEMS DEVICES,” that is incorporated herein by reference in its entirety. In some cases, one or more tintable windows can be located within the interior of an enclosure (e.g., building), e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g. noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g. cations) into the oxide may induce a visible change in a tint (e.g., color) of the oxide. For example, the oxide may transition from a colorless to a colored state. For example, intercalation of lithium ions into tungsten oxide (WO3−y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

In some embodiments, an enclosure includes one or more sensors. The sensor may facilitate controlling the environment of the enclosure such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. Sensor may provide on/off indications of the occurrence and/or presence of a particular environmental event (e.g., one pixel sensors). In some embodiments, the accuracy and/or resolution of a sensor may be improved via artificial intelligence analysis of its measurements. Examples of artificial intelligence techniques that may be used include: reactive, limited memory, theory of mind, and/or self-aware techniques know to those skilled in the art). Sensors may be configured to process, measure, analyze, detect and/or react to one or more of: data, temperature, humidity, sound, force, pressure, electromagnetic waves, position, distance, movement, flow, acceleration, speed, vibration, dust, light, glare, color, gas(es), and/or other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting. A sensor may be optimized to be capable of performing accurate measurements of one or more environmental characteristics present in the factory setting. In some instances, a factory calibrated sensor may be less optimized for operation in a target environment. For example, a factory setting may comprise a different environment than a target environment. The target environment can be an environment in which the sensor is deployed. The target environment can be an environment in which the sensor is expected and/or destined to operate. The target environment may differ from a factory environment. A factory environment corresponds to a location at which the sensor was assembled and/or built. The target environment may comprise a factory in which the sensor was not assembled and/or built. In some instances, the factory setting may differ from the target environment to the extent that sensor readings captured in the target environment are erroneous (e.g., to a measurable extent). In this context, “erroneous” may refer to sensor readings that deviate from a specified accuracy (e.g., specified by a manufacture of the sensor). In some situations, a factory-calibrated sensor may provide readings that do not meet accuracy specifications (e.g., by a manufacturer) when operated in the target environments.

In some embodiments, the sensor(s) are operatively coupled to at least one controller and/or processor. Sensor readings may be obtained by one or more processors and/or controllers. A controller may comprise a processing unit (e.g., CPU or GPU). A controller may receive an input (e.g., from at least one sensor). The controller may comprise circuitry, electrical wiring, optical wiring, socket, and/or outlet. A controller may deliver an output. A controller may comprise multiple (e.g., sub-) controllers. The controller may be a part of a control system. A control system may comprise a master controller, network controller (e.g., floor controller), or a local controller. The local controller may control one or more targets (e.g., devices). For example, the local controller may be a window controller (e.g., controlling an optically switchable window), enclosure controller, or target (e.g., component) controller. For example, a controller may be a part of a hierarchal control system (e.g., comprising a main controller that directs one or more controllers, e.g., directs network controllers, local controllers (e.g., window controllers), enclosure controllers, and/or target (e.g., component) controllers). A physical location of the controller type in the hierarchal control system may be changing. For example: At a first time: a first processor may assume a role of a main controller, a second processor may assume a role of a network controller, and a third processor may assume the role of a local controller. At a second time: the second processor may assume a role of a main controller, the first processor may assume a role of a network controller, and the third processor may remain with the role of a local controller. At a third time: the third processor may assume a role of a main controller, the second processor may assume a role of a network controller, and the first processor may assume the role of a local controller. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). In one embodiment, a network controller may direct one or more local controllers, one or more enclosure controllers, one or more target (e.g., component) controllers, or any combination thereof. The network controller may comprise a floor controller. For example, the network (e.g., comprising floor) controller may control a plurality of local (e.g., comprising window) controllers. A plurality of local controllers may be disposed in a portion of a facility (e.g., in a portion of a building). The portion of the facility may be a floor of a facility. For example, a network controller may be assigned to a floor. In some embodiments, a floor may comprise a plurality of network controllers, e.g., depending on the floor size and/or the number of local controllers coupled to the network controller. For example, a network controller may be assigned to a portion of a floor. For example, a network controller may be assigned to a portion of the local controllers disposed in the facility. For example, a network controller may be assigned to a portion of the floors of a facility. A master controller may be coupled to one or more network controllers. The network controller may be disposed in the facility. The master controller may be disposed in the facility, or external to the facility. The master controller may be disposed in the cloud. A controller may be a part of, or be operatively coupled to, a building management system (abbreviated herein as “BMS”). A controller may receive one or more inputs. A controller may generate one or more outputs. The controller may be a single input single output controller (SISO) or a multiple input multiple output controller (MIMO). A controller may interpret an input signal received. A controller may acquire data from the one or more targets (e.g., components such as sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer. The controller may perform real-time calculation (e.g., using communicated data such as sensor data and/or analytics of the cabling network). The network analytics may relate to the communication rate, (e.g., electrical) power consumption, and/or communication density on the network (e.g., at a given time, and/or at a given time frame). The controller (e.g., control system) may utilize historical and/or third party data for its control. The historical data may be of the facility, of similar facilities, or of different facilities.

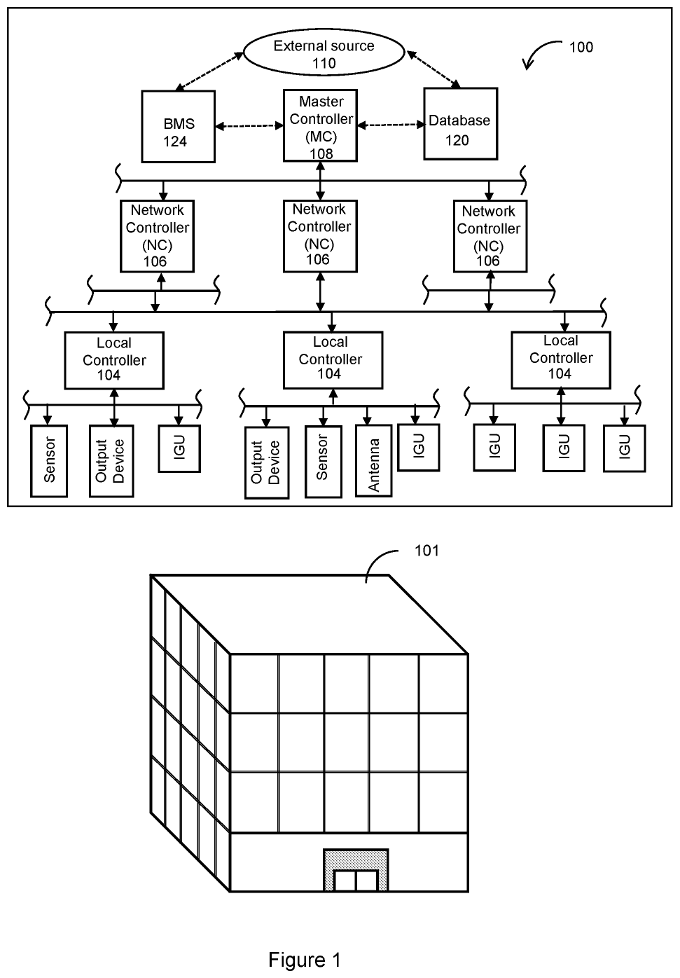

FIG. 1 shows an example of a control system architecture 100 comprising a master controller 108 that controls network controllers 106, that in turn control local controllers 104. In some embodiments, a local controller controls one or more IGUs, one or more sensors, one or more output devices (e.g., one or more emitters), or any combination thereof. FIG. 1 shows an example of a configuration in which the master controller is operatively coupled (e.g., wirelessly and/or wired) to a building management system (BMS) 124 and to a database 120. Arrows in FIG. 1 represents communication pathways. A controller may be operatively coupled (e.g., directly/indirectly and/or wired and/wirelessly) to an external source 110. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 1, all communication arrows are meant to be bidirectional.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g. temperature, power, voltage, and/or profile). The control can comprise real time or off-line control. A calculation utilized by the controller can be done in real time, and/or offline. The controller may be a manual or a non-manual controller. The controller may be an automatic controller. The controller may operate upon request. The controller may be a programmable controller. The controller may be programmed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, network controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer.

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more targets (e.g., components) of a building management system (e.g., lightening, security, and/or air conditioning system). The controller may regulate at least one (e.g., environmental) characteristic of the enclosure. The control system may regulate the enclosure environment using any target (e.g., component) of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one target (e.g., component) of the forming systems and/or apparatuses disclosed herein.

In some embodiments, a plurality of targets (e.g., devices) may be operatively (e.g., communicatively) coupled to the control system. The control system may comprise the hierarchy of controllers. The targets may comprise an emitter, a sensor, or a window (e.g., IGU). The emitter may comprise light, buzzer, heater, HVAC actuators, or alarm. The target may be any target as disclosed herein. At least two of the plurality of targets may be of the same type. For example, two or more IGUs may be coupled to the control system. At least two of the plurality of targets may be of different types. For example, a sensor and an emitter may be coupled to the control system. At times the plurality of targets may comprise at least 20, 50, 100, 500, 1000, 2500, 5000, 7500, 10000, 50000, 100000, or 500000 targets. The plurality of targets may be of any number between the aforementioned numbers (e.g., from 20 targets to 500000 targets, from 20 targets to 50 targets, from 50 targets to 500 targets, from 500 targets to 2500 targets, from 1000 targets to 5000 targets, from 5000 targets to 10000 targets, from 10000 targets to 100000 targets, or from 100000 targets to 500000 targets). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the targets may be in a multi-story building. At least a portion of the floors of the multi-story building may have targets controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., targets therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m², from about 250 m² to about 1000 m², or from about 1000 m² to about 2000 m²). The total length of cabling in the cabling network system can be at least about 500 feet (′), 1000′, 10000′, or 100000′, depending on the size of the facility, number and types of targets to which the cabling system is coupled, and coverage of the facility by the cabling system.

In certain embodiments, portions of a communications network of the enclosure (e.g., building) may be logically and/or physically divided into one or more vertical data planes and one or more horizontal data planes. A function of a vertical data plane may be to provide data communication and, optionally, electrical power vertically with respect to Earth (e.g., between floors of a multi-floor building). A function of a horizontal data plane may be to provide data communications and/or electrical power to network nodes on one or more floors of a facility (e.g., building). In some embodiments, a communications network of an enclosure (e.g., building) employs a vertical plane linked to a plurality of horizontal data planes by control panels. At least one control panel may be provided for each horizontal data plane.

In certain embodiments, infrastructure described herein provides a communication network and electrical power resources around the perimeter of the enclosure (e.g., building), optionally with a separate communications and electrical power distribution system on each of multiple floors or on all floors of a facility (e.g., building). The infrastructure may be installed when the enclosure (e.g., building) is constructed or as part of a renovation. The infrastructure may provide high speed communications (e.g., at Gbit and faster data rates) and electrical power taps at specified locations throughout a building, for example around perimeter walls of a floor, room, along a ceiling, along a floor, or other region of a facility such as a building.

In certain embodiments, direct connections to an infrastructure of a facility (e.g., building) are provided via electrical power and/or communication docks in devices such as network adaptors described herein. Wires that connect to network adaptors may be strung in various locations such as in the walls of an enclosure (e.g., a building). In certain embodiments, one or more wires are disposed in a horizontal mullion above and/or below a window. In certain embodiments, one or more wires are disposed underneath a floor surface, e.g., within a floor plate.

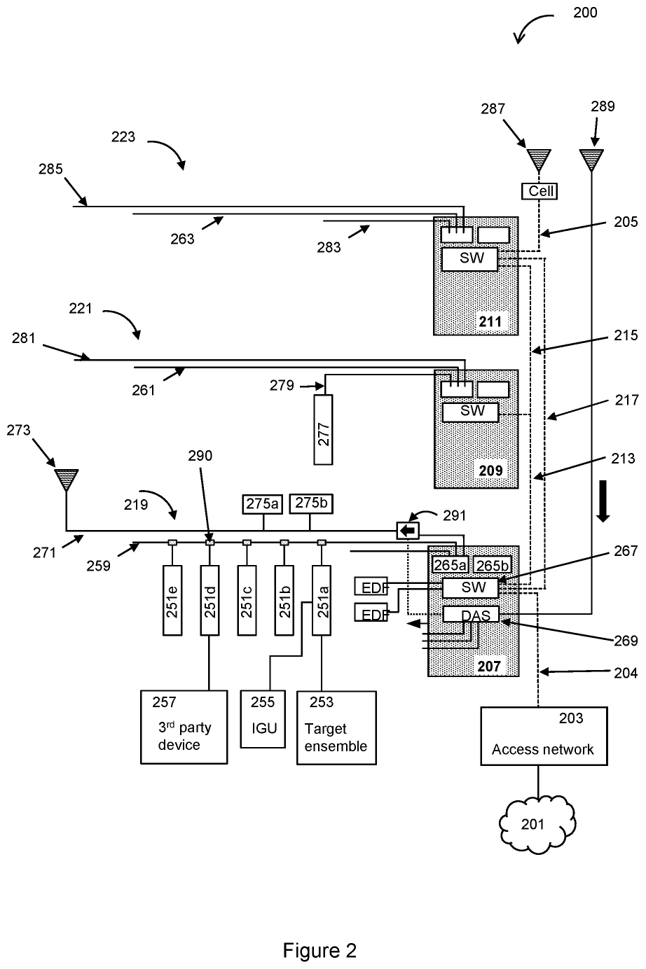

In various embodiments, the links in the vertical data plane are links between network devices (e.g., devices that are communicatively coupled to a network). The one or more network devices may be disposed on the same floor and/or on different floors of a facility (e.g., building). In certain embodiments, (e.g., each of) one or more floors in a facility (e.g., building) has a network device (such as a network switch and/or a network router). The network device may be connected to two or more links in a vertical data plane. The network device may be provided in a control panel. In certain embodiments, the link medium (in the vertical plane) comprises and/or is comprised of, one or more optical fibers. In certain embodiments, electrical current carrying wire(s) are used in place of, and/or in conjunction with, optical fibers, e.g., as link media (e.g., in the vertical data plane). The optical fiber(s) may be disposed in a horizontal and/or vertical data plane. Current carrying wire(s), such as copper wire(s), may be provided as twisted pair and/or coaxial cable. In some embodiments, the (e.g., vertical) data plane includes bundles of fibers running between network devices (disposed, for example, on different floors of a facility (e.g., building)). As an example, the links of the (e.g., vertical) data plane depicted in FIG. 2, 213, 215, or 217 may (e.g., each) comprise a bundle of fibers. In certain embodiments, at least one (e.g., each) bundle of fibers may include at least 12, 24, 48, 96, or 114 optical fibers.

In some embodiments, at least a portion of the optical fiber(s) may be utilized for communication in an enclosure. At least a portion of the optical fibers may not be utilized (e.g., non-utilized fiber(s) may be referred to herein as “dark fiber(s)”). In some implementations, during or after installation, some fibers are used for an information technology (IT) and/or other services infrastructure of an enclosure (e.g., building), while some other fibers are “dark.” Dark fibers may not be utilized, at least temporarily, for IT and/or services (e.g., sensors, windows, HVAC, lighting, security) of an enclosure. The heating, ventilation, and air-conditioning system may be abbreviated herein as “HVAC.” The services may comprise controlling operations of one or more devices. The devices may comprise a sensor, tintable window, heater, cooler (e.g., air-conditioner), ventilator, lighting, security, emitters, antenna, or actuators. In some embodiments, at least about 1/10, ⅕, ¼, ⅓, or ½ (half) of the installed fibers are initially, upon installation, dark. In some embodiments, at least about 1/10, ⅕, ¼, ⅓, or ½ (half) of the installed fibers are initially, upon installation, not dark. The dark fiber may be used for leasing as a service to tenants and/or other enclosure occupants. Examples of leased services may include Wi-Fi, cellular communications, streaming internet, and any other IT related services utilized by occupants and/or tenants.

In certain embodiments, a data plane has a topology (e.g., the wires and/or devices operatively coupled to the wires are configured in a topology). The topology may be linear or star topology. For example, a (e.g., horizontal) data plane may have a linear network topology. In a linear topology, the network topology may include a control panel at one terminus of a data transmission medium and multiple nodes connected along the length of the data transmission medium (downstream from the control panel). In some implementations, the transmission medium (e.g., a network cable such as a coaxial and/or a twisted pair cable) is located around some or all the perimeter of a floor of a facility. In some implementations, at one or more locations along the network cable, there is/are electrical coupling(s) for connecting to one or more nodes (such as end nodes), optionally via a network adaptor. The end nodes may comprise any of the devices disclosed herein (e.g., sensor, emitter, tintable window, HVAC system, or lighting). In some implementations, the electrical couplings are caps, which are passive devices. The cap can provide an electrical coupling between the network cable and an associated nodes (e.g., any one of the devices served by the horizontal data plane). In some embodiments, the electrical couplings are provided at regular intervals such as at (e.g., vertical) mullions (e.g., at about every five feet). The nodes may be infrastructure nodes. The infrastructure nodes may include floor controller, ethernet switch, and/or head-end.

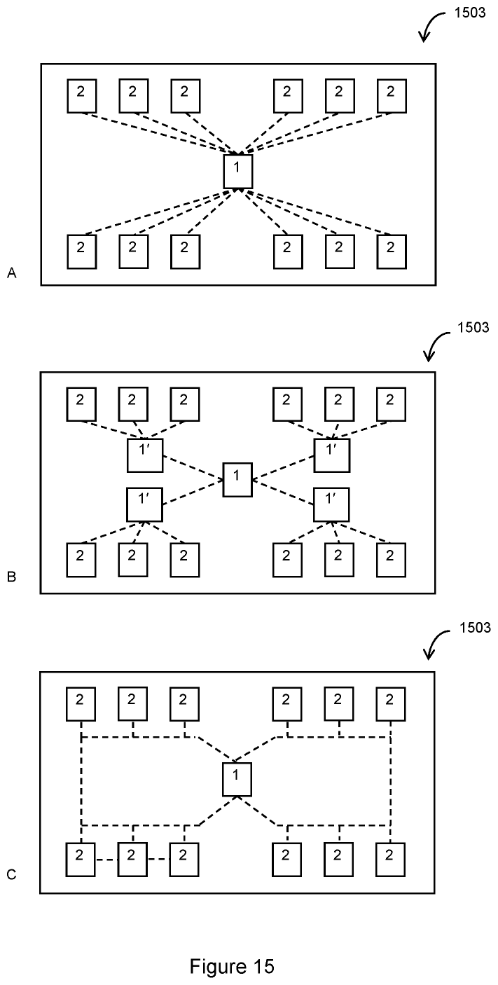

FIGS. 15 through 18, described herein, depict embodiments of a horizontal data plane employing a ring and/or star topology.

FIG. 2 presents an embodiment of a communications network 200 for an enclosure such as a building. The example shown in FIG. 2 depicts links that may comprise one or more cables (e.g., coaxial cables or twisted cables). The link may be a communication and/or electrical power line. The cables may be a cable bundle. The cable bundle can transmit electrical power and/or communication. The cable (e.g., coaxial cable) can transmit electrical power and/or communication. In the depicted embodiment, network 200 includes a vertically oriented network portion (including a vertical communication line 205) that connects network targets (e.g., components) on multiple floors of the enclosure (e.g., of the facility). In the example shown in FIG. 2, a vertical data plane comprises a first control panel 207 on a first floor, a second control panel 209 on a second floor, and a third control panel 211 on third floor. Physical communications and/or electrical power link 213 connects control panels 207 and 209. Physical communications and/or electrical power link 215 connects control panels 209 and 211. Physical communications and/or electrical power link 217 connects control panels 207 and 211. As illustrated, control panels 207, 209, and 211 along with physical communications and/or power links 213, 215, and 217 form a loop. The loop may provide redundancy in the network. As an example, physical communications and/or electrical power link 217 provides redundancy on the vertical plane if one of the other physical communications and/or electrical power links (e.g., link 213 or 215) should fail. Communications links 213, 215, and 217 may comprise electrical wires and/or optical fibers. Communications and/or links 213, 215, and 217 may comprise a coaxial wire.

In the example shown in FIG. 2, control panel 207 is communicatively coupled (e.g., connected) to an external network 201 (e.g., external to the building and/or in the cloud) via an access network 203. Control panel 207 is communicatively coupled (e.g., connected) to access network 203 by a physical communications and/or electrical power link 204, which may comprise an optical fiber and/or an electrical wire. Control panel 207 is connected to an antenna 289 that is external to the building. The antennal 289 may be a receiving antenna (e.g., a donor antenna).

FIG. 2 shows an example of control panel 207 that is operatively coupled (e.g., connected) to a first horizontal network portion that is horizontal data plane 219. Control panel 209 is operatively coupled (e.g., connected) to a second horizontal network portion that is horizontal data plane 221. Control panel 211 is operatively coupled (e.g., connected) to a third horizontal network portion that is horizontal data plane 223. The horizontal data planes 219, 221, and 223 include multiple network targets (e.g., components and/or devices). The network targets (e.g., components) can include client nodes. The client nodes can be located on respective floors of the building.

In the example shown in FIG. 2, horizontal data plane 219 includes network adaptors 251a-251e. The network adapter (e.g., 251a) is coupled to communication and/or electrical power line (e.g., trunk line) 259 via a distribution junction (e.g., 290). Network adaptor 251a is connected to a collection of targets (e.g., sensors and/or emitters) 253 and connected to an IGU 255 that may be an optically switchable window. Network adaptor 251a is configured to provide electrical power and data to the collection of targets 253 (also referred to herein as “target ensemble”), e.g., using a Power over Ethernet protocol (PoE). Network adaptor 251d is connected to at least one third-party device 257 such as a computation device. Network adaptor 251d is configured to provide network connectivity to third party device 257. Providing the network connectivity may comprise logic implementing a link layer discovery protocol (LLDP) that supports, e.g., PoE.

In the example shown in FIG. 2, control panel 207 is connected to network adaptors 251a-251e by a link (e.g., coaxial cable) 259. The connection can be by a coaxial or other type of (e.g., electrical and/or optical) cable. Control panel 209 is connected to client nodes on horizontal data plane 221 by a link (e.g., coaxial cable) 261. Control panel 211 is connected to client nodes on horizontal data plane 223 by a link (e.g., coaxial cable) 263. In the example shown in FIG. 2, control panel 207 comprises two head ends 265a and 265b, a switch 267 (abbreviated herein as “SW”) and a distributed antenna system (abbreviated herein as “DAS”) 269. The Switch is operatively coupled (e.g., connected to two edge distribution frame devices (abbreviated herein as “EDFs”). Head end 265a is connected to multiple links (e.g., coaxial cables), including link (e.g., coaxial cable) 259. While not shown, head end 265b is connected to at least one link (e.g., coaxial cable). Switch 267 is connected to (e.g., communication and/or electrical power) links 204, 213, and 217. The connection may be via optical and/or electrical cable(s). DAS 269 is configured to control and/or communicate with one or more antennas, including antenna 273, on horizontal data plane 219. The antenna may be an internal building antenna (e.g., 273) and/or or an external (e.g., donor) antenna (e.g., 289). In the example shown in FIG. 2, an electrical power and/or communications link (e.g., cable) 271 connects antenna 273 to control panel 207. Link 271 is also connected to a directional coupler (e.g., configured for directional data communication protocol such as MoCA or d.hn). Other client nodes 275a and 275b are connected to control panel 207 via electrical power and/or communications link (e.g., cable) 271. Head ends 265a and 265b are configured to send and/or receive data encoded in accordance with one or more protocols which comprise (i) a next generation home networking protocol (abbreviated herein as “G.hn” protocol), (ii) communications technology that transmits digital information over electrical power lines that traditionally used to (e.g., only) deliver electrical power, or (iii) hardware devices designed for communication and transfer of data (e.g., Ethernet, USB and Wi-Fi) through electrical wiring of a building. The data transfer protocols may facilitate data transmission rates of at least 1 Gigabits per second (Gbit/s), 2 Gbit/s, 3 Gbit/s, 4 Gbit/s, or 5 Gbit/s. The data transfer protocol may operate over telephone wiring, coaxial cables, electrical power lines, and/or (e.g., plastic) optical fiber. The data transfer protocol may be facilitated using a chip (e.g., comprising a semiconductor device). In the example shown in FIG. 2, Horizontal data plane 221 includes a network adaptor 277 connected to control panel 209 by a link (e.g., coaxial cable) 279. Horizontal data plane 221 includes a physical power (e.g., 48V DC) and/or (electrical power and/or communications) line 281 for connecting one or more antennas (not shown) to control panel 209. Horizontal data plane 223 includes, in addition to link (e.g., coaxial cable) 263, a second link (e.g., coaxial cable) 283 for connecting to one or more network adaptors or other client nodes (not shown) to control panel 211. Horizontal data plane 223 includes a physical (e.g., electrical power and/or communications) line 285 for connecting one or more antennas (not shown) to control panel 211. Control panel 211 is also connected to a (e.g., cellular) antenna 287.

In certain embodiments, control panels include one or more head ends configured to communicate via protocol such as G.hn, Ethernet (including via a MoCA (Multimedia over Coax Alliance) protocol), and/or any one or more of various cellular protocols such as fourth generation (4G) and/or fifth generation (5G) cellular communication. The 4G communication may comply with Long-Term Evolution (LTE) standard. Control panels may comprise one or more network switches, gateways, and/or routers.

In some embodiments, a cabling network includes at least one distribution junction (referred to herein as “splitter” and “junction”). The distribution junction may include at least one connector. The distribution junction may distribute one or more time-varying signals and/or electrical (e.g., DC) power within a network infrastructure. The distribution junction may couple together two or more circuits. As an example, the distribution junction may couple together at least two of an upstream circuit, a downstream circuit, and a branch circuit. The upstream and downstream circuits may be part of a network bus (also referred to herein as a trunk line). In some embodiments, a bus is a subsystem that is used to connect targets (e.g., components) transfer data (e.g., signal) and/or electrical (e.g., DC) power between those targets (e.g., components). The distribution junction can be passive, or active. The distribution junction may comprise active and passive targets (e.g., components). The distribution junction may include one or more paths in the upstream, downstream, and branch circuits that are electrically coupled together. The distribution junction can include, or be operatively coupled to, a microprocessor. The cabling network may include a passive distribution junction and/or an active distribution junction. An active distribution junction has at least one active component. A passive distribution junction has passive component(s) and no active components.

In some embodiments, the active distribution junction includes circuitry (e.g., electrical circuitry). The circuitry in the active distribution junction may include a signal repeater, range extender, signal transponder, an amplifier, a pre-amplifier, power management circuitry, and/or a microprocessor. The power management circuitry may control (e.g., monitor and/or manage) electrical (e.g., DC) power flows through the distribution junction. The active distribution junction may facilitate formation of a longer network bus (e.g., signal repeaters and/or amplifiers can extend the practical length of the network bus). The active distribution junction may provide an option to resize (e.g., lengthen) the network (e.g., by adding signal repeaters and/or amplifiers) dynamically. Resizing the network may comprise resizing the network bus. The dynamic network resizing option may provide dynamic extension and/or contraction of the network. The dynamic network resizing option may facilitate formation of a labile network, e.g., in terms of its size and/or connectivity of targets to the distribution junction. The active distribution junction may facilitate power management in the network infrastructure. For example, (i) by monitoring voltage and/or current along the network (e.g., along the network bus), and/or (ii) by negotiating power consumption for targets (e.g., components) coupled to the branch circuit.

In some embodiments, the distribution junction is passive. The passive distribution junction can include one or more capacitors, inductors, and/or transformers. The passive distribution junction may include (i) a first inductor coupling electrical (e.g., DC) power, e.g., from the upstream circuit to the branch circuit (or vice-versa) and/or (ii) a second inductor coupling electrical (e.g., DC) power, e.g., from the upstream circuit to the downstream circuit (or vice-versa). The passive distribution junction can include at least one transformer. The at least one transformer may couple one or more time-varying signals between two or more circuits (e.g., between three circuits). The passive distribution junction can include one or more filters.

In some embodiments, the distribution junction provides impedance matching. In some embodiments, the distribution junction may comprise a transformer. For example, implementations of a distribution junction that utilizes a transformer can provide impedance matching. The impedance matching may serve to reduce (e.g., eliminate) unwanted signal reflections off of distribution junctions within the network infrastructure. The transformer can comprise a plurality of windings. At least two (e.g., all) of the plurality of windings may be formed from the same number of turns around a common core (e.g., to provide a balanced transformer). At least two (e.g., all) of the plurality of windings may be formed from different number of turns around a common core (e.g., to provide an unbalanced transformer). The diameters of at least two (e.g., all) of the windings may be the same. The diameter of at least two (e.g., all) of the windings may be different. The transformer (in the distribution junction) may be configured to divide time-varying signals in a balanced or in an unbalanced manner. The balanced transformer may receive a time-varying signal on a first circuit and divide the signal equally onto a plurality of circuits. The equal division of the signal into the plurality of circuits may be such that the signal in each of the plurality of circuits is approximately (e.g., measurably) equal. For example, the balanced transformer may receive a time-varying signal on first circuit and equally divides the signal onto the second and third circuits (e.g., at approximately one-half the original power). The unbalanced transformer may receive a time-varying signal on a first circuit and divide the signal unequally onto a plurality of circuits. The unequal division of the signal into the plurality of circuits may be such that the signal in at least two of the plurality of circuits is different. For example, the unbalanced transformer may divide the signal from the first circuit onto a second circuit at a first fraction (e.g., 85%) of the original (e.g., electrical) power and onto the third circuit at a second fraction (e.g., 15%) of the original power. The first and second fractions are unequal and sum to approximately 100% (e.g., 100% less losses). In a division of a first circuit signal (100%) into a second circuit and a third circuit unevenly, the second circuit may receive at most about 1%, 5%, 10%, 15%, 20%, 25%, 30%, or 40% of the signal from the first circuit, and the third circuit may receive the remainder of the signal from the first circuit. In a division of a first circuit signal (100%) into a second circuit and a third circuit unevenly, the second circuit may receive any signal percentage value between the aforementioned percentage values from the first circuitry (e.g., from about 1% to about 40%, from about 1% to about 20%, or from about 20% to about 40%), and the third circuit may receive the remainder of the signal from the first circuit. The second circuit (e.g., the circuit receiving the lower signal strength) may be the branch circuit and the third circuit may be the downstream circuit, e.g., such that the majority of the signal continues along the network bus. In other embodiments, the first circuit (e.g., the circuit receiving the higher signal strength) is the branch circuit, e.g., such that the majority of the signal passes to the branch circuit.

In some embodiments, the distribution junction includes at least one filter. The distribution junction may include one or more low-pass filters, high-pass filters, and/or band-pass filters. The filters may serve to minimize (e.g., block) certain frequencies from a branch circuit (e.g., when such frequencies are not utilized by that branch circuit) and/or from a downstream circuit (e.g., when no downstream circuits utilize such frequencies). By minimizing (e.g., blocking) such frequencies (e.g., signal portions), the filters may reduce noise in the network, e.g., as the signal propagates through the network (e.g., through the bus).

In some embodiments, the distribution junction includes frequency shifting capabilities. For example, the control panel and distribution junctions may frequency-shift one or more of the time-varying signals to reduce interference as the signals travel through the network. Signals may be shifted into regions of the spectrum available on the medium (e.g., coaxial cable) that are not being used. The distribution junction may include passive or active targets (e.g., components) that remove this frequency shift when conveying signals from a network bus to a branch circuit and that insert this frequency shift when conveying signals from the branch circuit to the network bus. The control panel may include a G.hn head-end (or other target (e.g., component) that adds and removes frequency shifts to the time-varying signals as they are transmitted by and received at the control panel.

In some embodiments one or more antennas are coupled to the network. The antennas can be external and/or internal to the enclosure (e.g., building). The antenna can be passive or active. At least two of the antennas can be of the same type. At least two of the antennas can be of different type. The external antenna can be referred to herein as “donor antenna.” The external antenna may be a directional antenna (e.g., Yagi antenna). The antenna can be directly coupled to the control panel. The antenna can be indirectly coupled to the control panel. Indirect coupling of the antenna to the control panel may comprise its coupling through one or more distribution junctions. The signal from the antenna may travel a distance through the cable, e.g., resulting in a reduction in the signal to noise ratio, e.g., reduction of the signal strength as compared to the noise. The signal from the antenna may travel through one or more distribution junctions, e.g., resulting in a reduction in the signal to noise ratio, e.g., reduction of the signal strength as compared to the noise. The network may include a pre-amplifier and/or amplifier (e.g., to increase the signal to noise ratio, e.g., to increase the signal strength as compared to the noise). The amplifier and/or preamplifier can be (i) disposed adjacent to the antenna, (ii) as part of the antenna circuitry, (iii) as part of the controller (e.g., in the control panel), (iv) operatively coupled to the controller, (v) adjacent to a distribution junction, and/or (vi) operatively coupled to a distribution junction. The antenna may be active. The antenna may include an amplifier and/or pre-amplifier. In the example shown in FIG. 2, antenna 273 is connected to control panel 207 through head 265a. However, the antenna may be communicatively coupled to the cable (e.g., coax and/or trunk line 265a). The antenna can be connected to the trunk line before any distribution junction (e.g., 290) and/or other target (e.g., device such as 253). Without wishing to be bound to theory, connection of the antenna to the trunk line before any distribution junction and/or device, may reduce signal loss (as compared to the noise). The amplifier and/or pre-amplifier can be included in the control panel, e.g., of the floor controller. In some embodiments, the network bus has a head-end. One or more devices (e.g., antennas) may be coupled to the network bus. The antennas may be high frequency antennas. The antennas may operate at a frequency range of from about 700 MHz to about 2100 MHz. The antennas may be coupled closer to the head-end than (e.g., upstream of) other devices. As an example, the first device on the network bus (e.g., the branch circuit nearest the head-end) may be an antenna. The antenna may operate at least about 3.56 GHz, the second device may be another antenna operating at least about 700 MHz, and other (e.g., downstream) devices coupled to the network bus may utilize signals at frequencies of at most about 400 MHz. The highest frequency (e.g., 3.56 GHz) antenna may be connected to the network bus with a first distribution junction having a first low-pass filter, e.g., disposed on the downstream circuit. The first low-pass filter may attenuate (e.g., block) signals on the downstream circuit having frequencies above the frequency of the antenna (e.g., of about 3.20 GHz). The lower frequency (e.g., 700 MHz) antenna may be connected to the network bus with a second distribution junction having a second low-pass filter, e.g., on the downstream circuit. The second low-pass filter may attenuate (e.g., block) signals on the downstream circuit having frequencies above the frequency of that antenna (e.g., of about 400 MHz). With such an arrangement, the signals of both (e.g., 3.56 GHz and 700 MHz) antennas need not pass through more than a limited number (e.g., one, two, etc.) of distribution junctions. The number of distribution junctions through high higher frequency signals pass may be a single digit integer (e.g., at most 1, 2, 3, 4, 5, 6, 7, 8, or 9 distribution junctions). As a result, the antennas may receive a higher signal strength (e.g., higher signal to noise ratio). Additionally, high-frequency noise from downstream reflections and/or other sources can be reduced (e.g., eliminated).

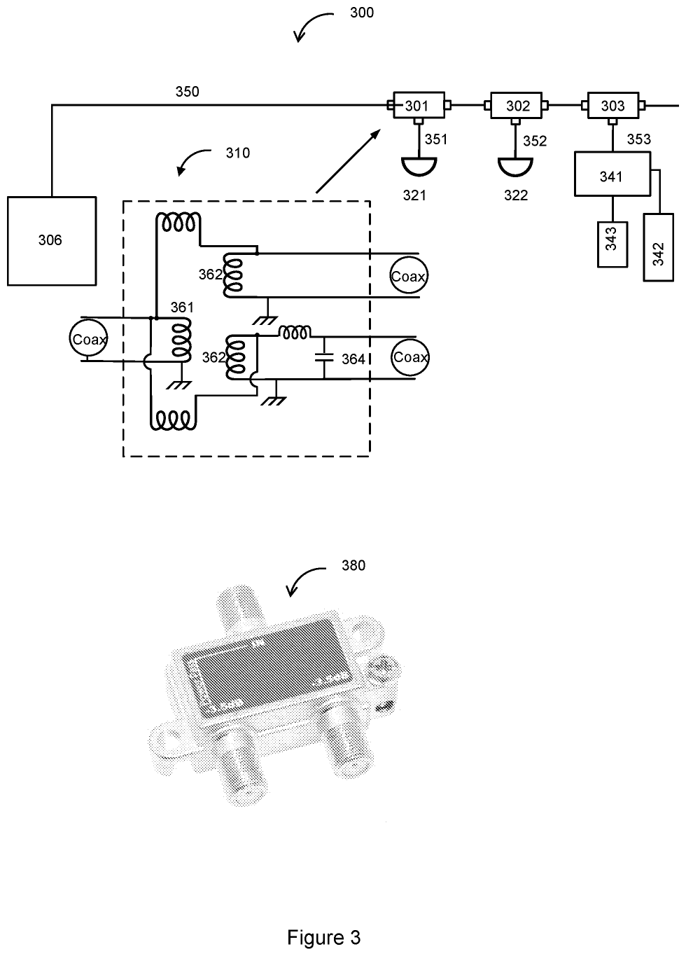

FIG. 3 shows an example of a cabling network 300. The cabling network includes a bus cable 350 that is connected to a controller 306. The controller can comprise a network (e.g., comprising floor) controller. The controller can include a network controller. The controller can be a main controller. FIG. 3 shows an example of a plurality of distribution junctions 301, 302, and 303. Distribution junction 301 is connected via branch cable 351 to antenna 321. Antenna 321 can be the highest frequency antenna (e.g., 3.56 GHz) coupled to bus cable 350. Distribution junction 302 is connected via branch cable 352 to antenna 322. Antenna 322 can be the lower frequency antenna (e.g., 700 MHz). In the example shown in FIG. 3, the antennas 321 and 322 are dome antennas. FIG. 3 shows an example of a third disturbing junction 303 connected via branch cable 353 to a local (e.g., comprising window) controller 341, that is in turn connected to IGU 342 and sensor 343. The local controller may be a microprocessor.

FIG. 3 shows a detailed electronic schematic of distribution junction 301 as 310. The detailed electronic schematic 310 includes a transformer that divides the power of time-varying signals between the upstream, downstream, and branch circuits. In the example shown in FIG. 3, distribution junction 310 includes first and second inductors that couple electrical (e.g., DC) power between the upstream, downstream, and branch circuits. The branch circuit of distribution junction 310 is coupled to a highest frequency antenna and the distribution junction 310 includes a low pass filter. In the example shown in FIG. 3, the low pass filter is formed from an inductor and a capacitor coupled to the downstream circuit. The low-pass filter may attenuate (e.g., block) signals utilized by the highest frequency (e.g., 3.56 GHz) antenna from the downstream circuit. The downstream devices (e.g., 322, 342, and 343) may utilize frequencies lower than those attenuated by the low-pass filter. The transformer in distribution junction 310 includes a first winding 361, a second winding 362, and a third winding 363. The windings 361, 362, and 363 are wound around a common core. FIG. 3 shows an example of a distribution junction 380 that connects three coaxial cables.

In some embodiments, a cabling network includes a network bus (also referred to herein as a trunk line) and branch cables. The network bus and branch cables may distribute one or more time-varying signals and/or electrical (e.g., DC) power within a network infrastructure. The network bus and branch cables may include one or more signal conductors and one or more ground conductors. The network bus may be formed of multiple circuits coupled together. A first circuit of the network bus may couple together a controller (e.g., controller 306 of FIG. 3) and a distribution junction (e.g., distribution junction 301 of FIG. 3). Second and subsequent circuits of the network bus may couple together respective pairs of distribution junctions (e.g., pairs of distribution junctions 301, 302, and 303). A branch cable (e.g., branch cables 351, 352, and 352) may couple a branch circuit to a respective distribution junction.

The network bus and branch cables may (e.g., simultaneously) distribute multiple time-varying signals and/or electrical (e.g., DC) power.

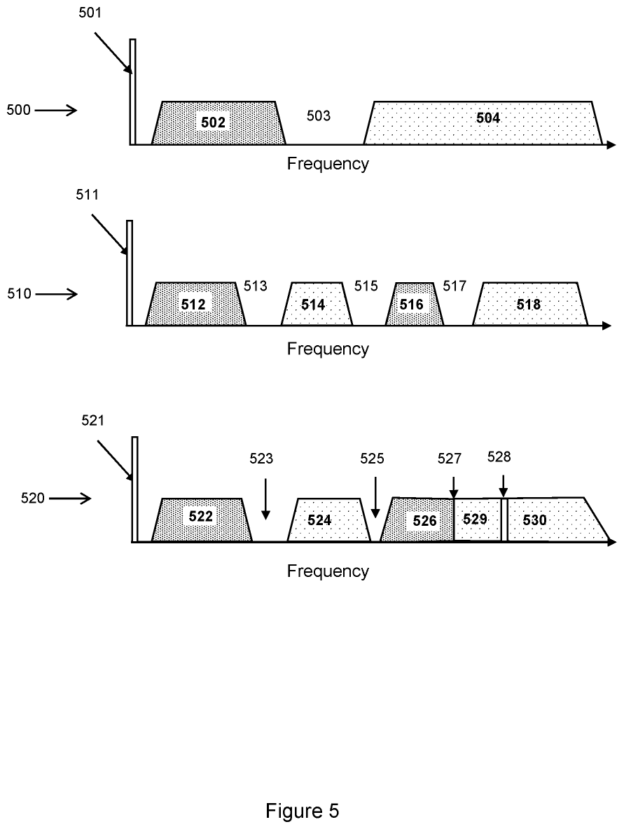

The network bus and branch cables may convey electrical (e.g., DC) power at any desired nominal voltage. As an example, the network bus and branch cables may convey electrical (e.g., DC) power at 12V, at 23V, or at 48 volts (V). The network bus and branch cables may follow any International Electrotechnical Commission (IEC) class such as class 0, I, II, or III. As an example, the network bus and branch cables may abide by class II of IEC and may thus carry a maximum of 100 VA or 100 Watts. The network bus and branch cables may have a wire thickness (e.g., 12, 14, 16 or 18 gauge) sufficient to carry the requested current. The network bus and branch cables may include shielding (e.g., foil shielding, braided shielding, or quad shielding), e.g., to reduce crosstalk and/or interference. The network bus and branch cables may comprise (e.g., be formed from) LMR-200, LMR-240, LMR-400, RG-6, RG-8, RG-11, RG-59, RG-60, RG-174, RG-210, RG-213, 8233, or 8267 coaxial cable, or another type of cable. The network bus and/or branch cables may distribute any requested number (e.g., 1, 2, 3, 4, 5, or more) of distinguishable time-varying signal frequency sets. The time-varying signal frequency sets may be distributed over non-overlapping frequencies windows. As an example, the network bus and/or branch cables may distribute a first frequency set of time-varying signals over one or more first frequency windows and a second set of time-varying signal frequency over one or more second frequency windows. Frequency windows (in both the first and second sets) may be separated in the frequency-domain (e.g., there may be guard bands between the frequency windows). In some embodiments, some frequency windows (from the first and/or second sets) are not separated by a guard band and/or are partially overlapping in the frequency-domain (e.g., one frequency window end contact another frequency window beginning, e.g., FIGS. 5, 526 and 529). In general, separating frequency-adjacent frequency windows with guard bands reduces noise and/or interference, and can also reduce the cost and complexity of network components (e.g., cables, filters, distribution junctions, etc.).

The first set of time-varying signals distributed by the cabling network may include network data signals (e.g., control related signals). The first set of time-varying signals may be referred to as digital communications or digital data. The first set of time-varying signals may include signals configured to be transmitted by communications technology that transmits digital information over electrical power lines that used to (e.g., only) deliver electrical power. The first set of time-varying signals may include signals configured to be transmitted by hardware devices designed for communication and transfer of data (e.g., Ethernet, USB and Wi-Fi) through electrical wiring of a building. The first set of time-varying signals may include signals configured to be transmitted by a data transfer protocol that facilitates data transmission rates of at least 1 Megahertz (MHz), 5 MHz, 10 MHz, 50 MHz, 10 MHz 0, 500 MHz, 1 Gigabits per second (Gbit/s), 2 Gbit/s, 3 Gbit/s, 4 Gbit/s, or 5 Gbit/s. The data transfer protocol may operate over telephone wiring, coaxial cables, electrical power lines, and/or (e.g., plastic) optical fiber. The data transfer protocol may be facilitated using a chip (e.g., comprising a semiconductor device). The first set of time-varying signals may include power line communications signals, such as G.hn, HomePlug®, or HD-PLC compatible signals. The first set of time-varying signals may include signals compatible with the multimedia over coax alliance (MoCA) protocol. The first set of time-varying signals may include signals compatible with other protocols including Ethernet protocols such as 802.3bw, 802.3 bp, 802.3ch, and/or 802.3cq. The first frequency window may extend from approximately 2 Megahertz (MHz) to approximately 200 MHz (e.g., such as used in the G.hn protocol). As an example, the first frequency window may extend from approximately 500 MHz to approximately 600 MHz, from approximately 875 MHz to approximately 1 Ghz, or from approximately 1.15 to approximately 1.5 GHz.

The second set of time-varying signals distributed by the cabling network may include radio-frequency signals. The second-time varying signals may include signals received by or for transmission through an antenna. The second frequency windows may extend from approximately 600 MHz to approximately 1 GHz, from approximately 1.4 GHz to approximately 6 GHz, from approximately 1.7 GHz to approximately 6 GHz. The radio-frequency signals may include cellular network signals such as fourth-generation (4G) and/or fifth-generation (5G) cellular network signals. In some embodiments, the 4G and 5G cellular network signals include signals at or below approximately 6 GHz. The ranges of the first and second set of time varying signals may overlap. The ranges of the first and second set of time varying signals may be separate. The separation may by a signal domain that is not occupied by the first or by the second time varying signals.

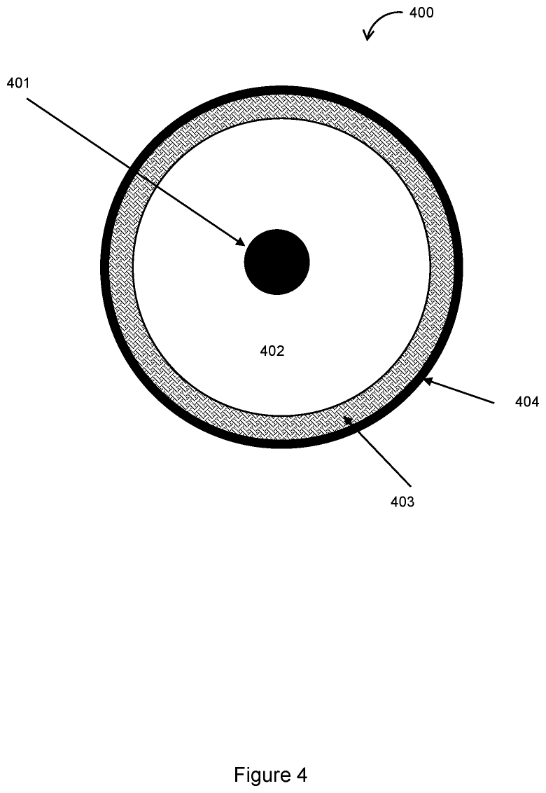

FIG. 4 depicts a network cable 400. The network buss(es) and branch cables in the cabling network disclosed herein may be formed from network cable 400. Network cable 400 includes an inner conductor 401, insulator 402 (also referred to as dielectric), outer conductor 403, and insulator 404 (also referred to as a jacket or shell). Outer conductor 403 can serve as a grounding path. Inner conductor 401 can carry direct current (DC). The electromagnetic field carrying the signal is transmitted (e.g., mainly or only) in the space between the inner conductor 401 and the outer conductors 403. The coaxial cable can provides protection of the signal from external electromagnetic interference (e.g., may reduce external electromagnetic interference on the signal transmitted in the coaxial cable). For example, network cable 400 may be an LMR-200, LMR-240, LMR-400, RG-6, RG-8, RG-11, RG-59, RG-60, RG-174, RG-210, RG-213, 8233, or 8267 coaxial cable, or another type of cable.

FIG. 5 depicts various frequency ranges 500, 510, and 520 of distinguishable signal range divisions along a frequency range that may be conveyed by the network cable 400. Frequency range 500 includes DC signal 501, first set of time-varying signal frequencies 502 (e.g., of control related communication), and second set of time-varying signal frequencies 504 (e.g., related to media (e.g., cellular) communication). The first and second time-varying signal frequency sets 502 and 503 are separated by frequency guard band 503 (e.g., devoid of time-varying signals). Frequency range 510 includes DC signal 511, first time-varying signal frequency set 512 (e.g., of control related communication), second time-varying signal frequency set 514 (e.g., related to media (e.g., cellular) communication), third time-varying signal frequency set 516 (e.g., of control related communication), and fourth time-varying signal frequency set 518 (e.g., related to media (e.g., cellular) communication). Guard bands 513, 515, and 517 separate respective pairs of the time-varying signals. Guard bands 513, 515, and 517 may be devoid of time-varying signal. At least two of the time-varying signal frequency set may transmit signals of the same type (e.g., signal frequency sets 512 and 516 may be reserved for transmission of control related communication). At least two of the time-varying signal frequency set may transmit signals of a different type (e.g., signal frequency set 512 may be reserved for transmission of control related communication and frequency set 514 may be reserved for transmission of media related communication). As an example, time-varying signal frequency set 512 may be reserved for data signals from about 2 to about 200 MHz (e.g., that complies with the G.hn protocol). As a further example, time-varying signal frequency set 516 may be reserved for data signals from about 1.2 to about 1.5 GHz that comply with the MoCA (Multimedia over Coax Alliance) protocol. As another example, time-varying signal frequency sets 514 and 516 may be reserved for analog radio-frequency signals with signal frequency set 514 including frequencies from about 0.6 to about 1.0 GHz and signal frequency set 518 may be reserved for signal frequencies from about 1.7 to about 6.0 Ghz.

Signal frequency range 520 of distinguishable signal frequencies includes DC signal 521, first time-varying signal frequency set 522, second time-varying signal frequency set 524, third time-varying signal frequency set 526, and fourth time-varying signal frequency set 529. Guard band 523 represents the relatively wide spectrum guard band between signals 522 and 524 (e.g., that is devoid of signals). Guard band 525 represents a relatively narrow spectrum guard band between signals 524 and 526 (e.g., that is devoid of signals). A sharp guard band 527 separates signal sets 526 and 529. Guard band 527 may have a width of a single frequency, less than 10 signal frequencies, or have a zero frequency range (and thus signal sets 526 and 529 may contact each other). Time-varying signal 529 may be separated from time varying signal frequency set 530 by a notch guard band 528 (e.g., that is devoid of signals). Signals in a signal frequency set may have the same amplitude throughout the signal frequency set (e.g., 529). Signals in the signal frequency set may have a varying amplitude (e.g., comprising an amplitude ramp up, amplitude plateau, and amplitude ramp down such as in 502). The slope of the ramp up and ramp down may have the same absolute value. The slop of the ramp up and ramp down have a different absolute value. The signal frequency set may be a frequency window in which a set of signal frequencies are permitted to be transmitted along the transmission line (e.g., coaxial cable). Frequencies for transmission (e.g., of media related communication) may follow jurisdictionally allowed standards of communications. Maintenance and/or facilitation of division into frequency domains (e.g., frequency windows, or signal frequency sets) may comprise utilization of one or more signal filters. For example, facilitation of the wide guard bands (e.g., 503) may require filters that are less precise (e.g., and cheaper) that filters facilitating sharp (e.g., 527 and 528) and/or short (e.g., 525) band gaps, or sharp frequency domain division

In certain embodiments, the network infrastructure may include one or more network adapters. The network adapters may be configured to tap off electrical power and data (e.g., G.hn and/or MoCA formatted data) at various locations on the horizontal data plane portion of a network. In some embodiments, the network adapters are coupled to respective branch cables (also referred to as branch lines) and/or to network bus (also reference to as a trunk line) in a cabling network. As noted herein, the cabling network can include one or more network buses.

In some embodiments, the network adaptors are configured to provide signal and/or electrical power to downstream targets such as devices (e.g., end nodes associated with a respective branch line). The signal may comprise digital data such as Ethernet data. In such embodiments, the network adapters serve as 100 Mega Bit (Mbit) and/or 1000 Mbit Ethernet adaptors. The network adaptors may alternatively or additionally be configured to provide downstream targets (e.g., devices) with electrical power (e.g., DC power). The electrical power may be at a voltage of at least about 24 volts (V), 48V, or 96V. The electrical power may be at a voltage of at most about 24V, 48V, or 96V. An end node coupled to a network adaptor may receive electrical power from, and/or receive and transmit data through, the connected network adaptor. For example, a digital architectural element (e.g., comprising a tintable window) may be (i) connected to the network adaptor and (ii) configured to receive data and electrical power from the connected network adaptor. The digital architectural element may include one or more sensors. The sensor(s) may be coupled to the network infrastructure, e.g., through the connected network adapter. A node that can use electrical power and/or data network communications (including high data rate communications) may be coupled to the network infrastructure, e.g., via a network adapter. The cabling system and at least a portion of its components may support electrical power of at least about 50 Watt (W), 100 W, 200 W, 400 W, 600 W, 1000 W, or 5000 W.

In some embodiments, the cabling network may comprise, or be operatively coupled to, a network adapter. The network adapter may include one or more network components for distributing electrical power internally and/or externally. As an example, the network adapter may comprise one or more network components for handling (e.g., DC) electrical power. The electrical power can be AC or DC power. The power handling network components may include one or more (e.g., DC-to-DC) converters. The network comprises a DC-to-AC, AC-to-DC, AC-to-AC, or DC-to-DC converter. The converter may be operatively coupled to, or be a part of, the network adapter. The DC-to-DC converter may be configured to convert a DC voltage received from the network bus into a different voltage (e.g., higher voltage and/or lower voltage). The DC-to-DC converters may include one or more electronic converters such as a step-down (e.g., buck) converter and/or a step-up (e.g., boost) converter. The outputs of DC-to-DC converters in the network adapter may be used internally by the network adapter (e.g., to power internal network components such as processors, interfaces, and controllers) and/or externally (e.g., to provide power to end nodes). The network adapter may provide electrical power to one or more end nodes, e.g., through an adapter or connector. As examples, the network adapter may provide DC power to a Power over Ethernet (PoE) switch, coupler, and/or injector. The Power over Ethernet (PoE) switch, coupler, and/or injector, may provide the DC power to end nodes, e.g., over twisted pair Ethernet cabling. The DC handling network components may include one or more filters and/or power conditioning devices. As an example, the DC handling network components can include one or more inductors configured to block time-varying signals between the end nodes, network bus, and/or DC-to-DC converters.

The network adapter may include network components for handling data communications. As examples, the network adapter may include a processor, an interface for coupling to the network bus, and/or one or more interfaces for coupling to end nodes. These network components may receive (e.g., and be powered by) one or more (e.g., DC) signals received from the network bus and/or generated internally by one or more (e.g., DC-to-DC) converters. The interface for coupling to the network bus may encode and decode data conveyed on the network bus. When the network bus utilizes the data protocol (e.g., G.Hn protocol, or MoCA protocol), the interface for coupling to the network bus may be a data interface (also referred to as a data controller). For example, when the network bus utilizes the G.Hn protocol (as an example), the interface for coupling to the network bus may be a G.Hn interface (also referred to as a G.Hn controller). The interfaces for coupling to one or more end nodes may include, as examples, (i) a data and/or electrical power interface and (ii) an architectural element interface. The general-purpose data and/or electrical power interface may be an Ethernet interface or a Power over Ethernet interface, as examples. Ethernet interfaces and Power over Ethernet interfaces may be referred to as Ethernet and Power over Ethernet controllers, respectively. The architectural element interface may include, as an example, a window controller (which is a type of a local controller). The window controller may provide one or more signals, e.g., responsive to tint commands, to a tintable window effect to adjust the tint of the tintable window. The tint commands may be generated internally by the window controller (e.g., in response to logic programmed into the window controller) or may be received over the network bus from a higher-level window controller in the hierarchy of controllers. The window controller may receive signals, e.g., from the tintable window and/or from any connected sensors. The connected sensors may be associated with sensed environmental conditions (e.g., weather conditions such as sunlight and/or cloudiness) and/or a tint status of the tintable window. The window controller may use such signals internally (e.g., in generating tint commands) or may convey such signals to other network components, e.g., over the network bus.

The network adaptor may have a relatively small chassis or footprint. A fundamental length scale may be a width, length, height, diameter of a circle, or diameter of a bounding circle, and may be abbreviated herein as “FLS.” The fundamental length scale of the network adaptor may be at most about 1 cm, 2 cm, 5 cm, 10 cm, 20 cm, or 50 cm. The FLS of the network adaptor may be of any value between the aforementioned values (e.g., from about 1 cm to about 50 cm, from about 1 cm to about 10 cm, or from about 10 cm to about 50 cm). In some embodiments, no dimension is greater than about 12 inches or greater than about 10 inches. As an example, the network adaptor may have dimensions of about 1.5 inches×about 0.75 inch×about 6 inches. In certain embodiments, the network adaptor fits in at least a portion of a window framing (e.g., mullions and/or transoms), wall, floor and/or other building structure. It may directly connect to one or more cables (e.g., wires) providing electrical power and data and/or cellular communications, e.g., from a headend or control panel. It may connect to windows or any other target. The target may comprise an Internet of Things (loT) device such as a digital architectural element. The control panel can comprise a circuitry disposed on one or more electronic boards. The control panel may comprise connection to electrical and/or optical wiring. The control panel, device ensemble, edge distribution frame, and/or switch may each be housed in a housing. The housing may comprise a transparent or non-transparent portion. The housing may comprise a hardened material (e.g., elemental mental, metal alloy, polymer, resin, glass, or an allotrope of elemental carbon). The housing may comprise a composite material. The housing may have one or more perforations. The housing may have a window and/or door. The housing may have a cover. The cover can be (e.g., reversibly) snapped to the body of the housing.

In some embodiments, the network adapter includes frequency shifting capabilities. As an example, the network adapter may transmit and/or receive signals over a (e.g., coaxial) cable, which signals have been frequency shifted. An interface, controller, or other element (i) may shift signals being transmitted out of the network adapter and/or (ii) may reverse the shift for signals coming into the network adapter over the network bus (e.g., branch circuit). With arrangements of this type (e.g., with the use of a frequency shifting component), signaling protocols that have overlapping frequencies windows can be utilized without interference. As an example, control related signals and/or media related signals (e.g., under the MoCA protocol and 4G and/or 5G signals) may be overlapping when unshifted, and may be non-overlapping when shifted by network components such as the network adapter, distribution junction, and/or control panel (e.g., headend) that have frequency shifting capability.

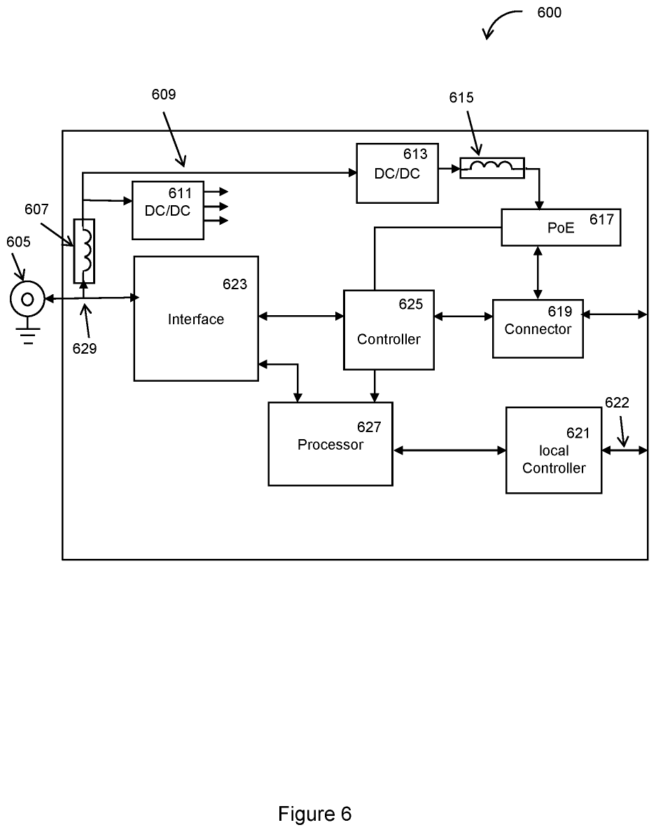

FIG. 6 shows an example of a network adapter 600. On an upstream side of the network adaptor 600 (e.g., side facing the control panel), a connector (not shown) taps to a (e.g., coaxial) cable 605 (e.g., network bus) having a grounded sheath and an internal conductor. Electrical power and data may be carried by the (e.g., coaxial) cable. An example of a connector to a (e.g., coaxial) cable is described herein (see, e.g., the discussion of distribution junction 310 of FIG. 3).

On a downstream side of network adaptor (e.g., side facing away from the control panel), connectors (or other interfaces) are provided for delivering electrical power and data to (i) a connector 619 and (ii) a local controller 621. The connector 619 provides power and data transmission capabilities. The connector 619 can be an Ethernet connector, with Power over Ethernet capabilities. The connector 619 can provide 100Base Ethernet and/or 1000Base Ethernet connectivity. The connector 619 may be an RJ45 connector. The connector 621 can be configured to couple to a target such as an optically switchable window (e.g., an IGU with one or more electrochromic devices disposed on one or more of the lites of the IGU). The connector 619 can be a (e.g., coaxial) cable connector (e.g., RG-designated connect or a BNC-designated connector).

Electrical (e.g., DC) power from the (e.g., coaxial) cable is split at point 629. The electrical power then passes through an inductor choke 607 and onto line (e.g., cable(s)) 609. The inductor choke 607 allows DC electrical current to pass while attenuating (e.g., blocking) time-varying communication signal components (e.g., control related data, media related data, and/or antenna signals). Some of the DC current on line 609 is provided to DC/DC converter 611 (also referred to as a DC-to-DC converter). DC/DC converter 611 is configured to provide DC power at a configured voltage for internal operation of the network adapter. The DC power may be used by one or more processors and other targets (e.g., elements) within, or coupled to, the network adaptor, including PoE power injection circuit 617, local (e.g., window) controller 621, interface 623, (e.g., ethernet) controller 625, and processor 627.

Some of the DC current on line 609 is provided to DC/DC converter 613. DC/DC converter 613 may be a (e.g., 48V) restore circuit. DC/DC converter 613 is configured to alter (e.g., boost or reduce (as appropriate)) the DC voltage received from line (e.g., cable) 605 to a designated voltage (e.g., 48 volts). Inductor 615 is coupled between DC/DC converter 613 and Power over the Ethernet circuit. Inductor 615 smooths out DC voltages provided by DC/DC converter 613 and attenuates (e.g., blocks) time-varying signals from flowing towards DC/DC converter 613. The network adaptor 600 is configured such that electrical current on the leg containing the designated voltage (e.g., 48 volts) restore circuit—DC/DC converter 613—and inductor 615 is delivered to a Power over Ethernet circuit 617 configured to make electrical power available for transmission on physical lines (e.g., that can carry Ethernet formatted data). Power over Ethernet circuit 617 is electrically connected to connector 619 in a manner allowing delivery of electrical current at a designated voltage (e.g., 48 volts) to one or more end devices that connect to connector 619.

Downstream from point 629 is an interface 623 bidirectionally coupled to line (e.g., coaxial cable) 605. Interface 623 is configured to encode and decode data according to the communication (e.g., G.hn or MoCA) protocol. Interface 623 is configured to (i) decode or otherwise interpret communication (e.g., G.hn) data received from line (e.g., coaxial cable) 605, and (ii) encode or otherwise format data. The data (A) is provided via controller 625 and/or 621, and/or (B) is generated internally (e.g., by processor 627 and/or by a local (e.g., window) controller 621), using the communication protocol signal (e.g., G.hn) for upstream transmission via the line (e.g., coaxial cable) 605.

An (e.g., ethernet) controller 625 is bidirectionally coupled to the communication (e.g., G.hn) interface 623. (e.g., Ethernet) controller 625 is bidirectionally coupled to connector 619. (e.g., Ethernet) controller 625 is configured to provide data in an appropriate physical layer format for subsequent transmission such as Ethernet transmission. For example, (e.g., ethernet) controller 625 may be configured to decode Ethernet data from connector 619 (e.g., from end nodes) and/or provide the unencoded data to communication (e.g., G.hn) interface 623 for subsequent upstream transmission. (e.g., Ethernet) controller 625 may be configured to (i) receive data from interface 623, (ii) encode the data in an Ethernet physical layer format, and (iii) provide the encoded data to connector 619. Ethernet controller 625 may provide data in a physical layer format suitable for transmission to end nodes (e.g. Ethernet nodes).

A processor 627 (e.g., comprising a microprocessor) is bidirectionally coupled to the communication (e.g., G.hn) interface 623 and to PoE circuit 617. Processor 627 may be configured to provide any one or more of various functions for nodes connected to connector 619 and/or local (e.g., window) controller 621. Examples of such functions include sensor data interpretation, tint commands for electrochromic windows, negotiation of power delivery (e.g., over connector 619), and any combination thereof. In some implementations, microprocessor 627 is configured to provide computing capabilities for a device such as sensor, emitter, or any other device disclosed herein (e.g., IoT (Internet of Things) functionality such as that of a digital architectural element). Examples of architectural elements, their computing capabilities, usage as part of a (e.g., control) network, as well as the (e.g., control) network, can be found in U.S. patent application Ser. No. 16/447,169, filed Jun. 20, 2019, entitled, “SENSING AND COMMUNICATIONS UNIT FOR OPTICALLY SWITCHABLE WINDOW SYSTEMS,”, which is incorporated herein by reference in its entirety. As an example, processor 627 (or any other element in network adapter 600) can be configured to limit electrical power consumption by an end device through connector 619, e.g., to a predetermined electrical power limit (the power limit may be of at most about 1 watt, 5 watt, or 10 watts). Limiting to a predetermined power limit may be at least until a higher level of power consumption is negotiated with (e.g., and approved by) processor 627 and/or by a control panel. Following negotiation of power consumption, the processor 627 may permit the end device to exceed the predetermined limit and/or to consume the negotiated amount of power.

As indicated herein, power over Ethernet circuit 617 is bidirectionally coupled to connector 619 for sending and/or receiving data. Power over Ethernet circuit 617 is coupled to processor 627, thereby allowing direct and/or indirect bidirectional communication between end nodes (e.g., targets) coupled to 619 and processor 627. Network adaptor 600 is configured to make processing resources (of processor 627) available to downstream nodes.

An optional local (e.g., window) controller 621 is bidirectionally coupled to microprocessor 627 and cable 622 (e.g., window cable). In some implementations, local (e.g., window) controller 621 is configured to perform some or all functions of a window controller (also referred to herein as a local controller). As examples, local controller 621 is a window controller that is configured to receive tint transition instructions from the control panel, generate and provide (i) tint transition voltage and/or current profiles to electrochromic devices, (ii) receive and/or process sensor readings, and/or (iii) receive current and/or voltage readings from electrochromic devices. Examples of functions of a local (e.g., window) controller are provided in US Published patent applications (1) Ser. No. 13/449,248, filed Apr. 17, 2012 titled “CONTROLLER FOR OPTICALLY-SWITCHABLE WINDOWS;” (2) Ser. No. 13/449,251, filed Apr. 17, 2012 titled “CONTROLLER FOR OPTICALLY-SWITCHABLE WINDOWS;” (3) Ser. No. 15/334,835, filed Oct. 26, 2016 titled “CONTROLLERS FOR OPTICALLY-SWITCHABLE DEVICES;” and (4) Ser. No. 15/334,832, filed Oct. 26, 2016 titled “CONTROLLERS FOR OPTICALLY-SWITCHABLE DEVICES;” each of which is incorporated herein by reference in its entirety.

In at least some embodiments, control one or more panels are provided that serve as distribution hubs. A control panel may provide one or more links to other control panel(s) in a building's (e.g., vertical and/or horizontal) data plane. A control panel may include a network switch, such an Ethernet switch, configured to communicate between control panels. The control panels can be disposed in the same floor on in different floors. For example, a network switch may be configured to communicate between control panels on different floors of a building. As an example, control panels may comprise network switches configured to provide network communications (e.g., Ethernet communications) at data rates of at least about 100 Megabits/second (Mbit/s), 500 Mbit/s, 1 Gigabit/second (Gbit/s), or 10 Gbit/s, between control panels (e.g., disposed within a floor and/or between floors). Control panels, as installed, may be connected to optical fiber(s) for inter-floor and/or intra-floor communications.

In some implementations, there is at least one control panel on each of at least two different floors of a building. In some cases, there is at least one control panel on every floor of a building. In some cases, there are at least two control panels on at least one floor of a building. In certain embodiments, there are fewer than one control panel per floor of a building (e.g., at least one floor of a building is devoid of a control panel). In certain embodiments, a control panel is located in an elevator pier area or another area (e.g., pier) having a dedicated mechanical and/or electrical controls and/or other infrastructure (e.g., an electrical closet with circuit breakers). In certain embodiments, the control panel(s) on the floor(s) are connected to a main controller. The main controller can be disposed in the building. For example, the main controller can be disposed in a basement of the building, or in some dedicated region of a building (e.g., a ground floor or uppermost floor). The main controller can be a primary control panel. The primary control panel may have more computing resources (e.g., processing capability and memory and storage capabilities) than the other control panels in the control system (e.g., than any other control panel in the control system). In some embodiments, the primary control panel is networked with the remainder of the control panels in a redundant fashion (e.g., with two or more optical fibers) such that failure of a single link does not result in the disconnection of any control panels from the network. In some embodiments, the primary control panel has a wired and/or wireless connection to a cellular network, a backhaul network, an internet, an extranet, and/or a network that is in communication with the Internet. In some embodiments, the main controller is located externally to the building. In some embodiments, the main controller is located in the cloud.

A control panel may include a gateway to a horizontal data plane. In certain embodiments, a control panel is configured to communicate with nodes on horizontal data plane a via (e.g., coaxial) cable. In certain embodiments, a control panel is configured to communicate with nodes on horizontal data plane a via (e.g., twisted pair copper) cable. The control panel may be configured to implement a linear, star, or circular network topology. The control panel may be configured to implement point to multipoint communications. The control panel may be configured to communicate with one or more targets (e.g., nodes) on a horizontal and/or vertical data plane using a particular physical and/or link layer protocol (such as G.hn protocol and/or MoCA). The G.hn protocol may allow the transmission of data over any wire medium. Data rates within the G.hn protocol may be in the range of from about 100 megabit/sec up to about 1.7 Gb/sec. The G.hn protocol may utilize signals from about 2 MHz to about 200 MHz. The G.hn protocol, as implemented herein, may be tolerate of cables with imperfections (e.g., such as those created by tapping bus lines to branch lines, such as via a distribution junction).

In some embodiments, the control panel comprises at least one communication headend. For example, the control panel may include MoCA and/or G.hn headends. The headend may be configured to determine physical topology of the horizontal and/or vertical data plane based at least in part upon the profile of the (e.g., electrical) power spectrum provided at the headend. Notches in the power spectrum may be produced by nodes on the network. The size and location of the notches on the power spectrum may correspond to the physical topology of the network served by the headend. A communication (e.g., G.hn) headend may be configured to identify the portion of its allocated frequency spectrum to use for communications, e.g., so as not to accidentally use low power portions of the spectrum. In certain embodiments, communication (e.g., G.hn) data is transmitted in point to multipoint fashion on a horizontal and/or vertical data plane. In some embodiments, a master (the G.hn headend) sends data to multiple slave nodes (end nodes on the horizontal and/or vertical data plane). In certain embodiments, slave nodes do not communicate directly to each other. In certain embodiments, slave nodes do communicate directly among themselves.

In certain embodiments, the (e.g., horizontal) data plane infrastructure, including, e.g., a control panel, cabling such as coaxial cables, and network adaptors is used to provide electrical power to nodes on the network. In certain embodiments, electrical power (e.g., provided at about 48 volts DC) is injected into a cable used for the (e.g., horizontal) data plane (e.g., the coaxial cable). In certain embodiments, the control panel includes a power manager. The power manager may be configured to control distribution of power to individual network adaptors and/or end nodes on a network. The individual network adaptors or other nodes may be provided power according to a protocol implemented in the power manager. In some protocols, the end nodes will not be permitted to draw power whenever they want to. Various criteria may be employed to decide when and/or how much electrical power to deliver to individual nodes or network adaptors on a network. Such criteria may include, for example, ensuring that the total delivered power on the system does not exceed some threshold, such as a threshold set for a particular electrical standard in the jurisdiction (e.g., 100 W for class 2 networks in the United States). In some embodiments, one or more end nodes connected to the network are not permitted to draw power (or permitted to draw only a limited amount of power) until they have negotiated with the power manager for power. The power manager, or another network component, may form a virtual network with the end nodes for the purposes of power negotiation and/or network authentication.

In certain embodiments, a power management protocol employs a defined set of communications between the power manager and one or more network adaptors or nodes. For examples, requests for power may be issued by network adaptors and requests for information may be issued by a power manager. Data containing the timing and/or conditions of power delivery, may be issued from the power manager before power is actually delivered. In certain embodiments, such communications are provided using the (e.g., G.hn) communications protocol. Power over Ethernet may be implemented with its own protocol. In certain embodiments, a link layer discovery protocol (LLDP) is employed to provide the relevant communications for power management, whether or not using a Power over Ethernet protocol.

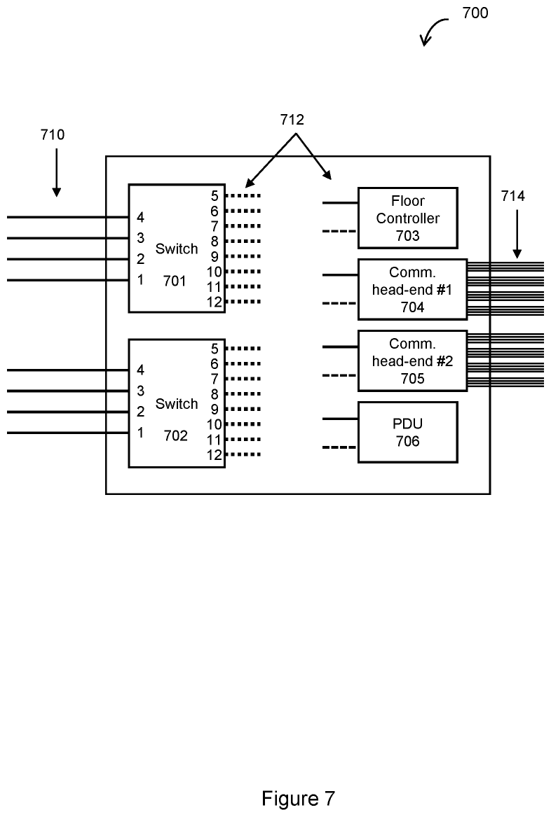

FIG. 7 depicts an example of a control panel 700. Control panel 700 includes a pair of switches 701 and 702. The switches 701 and 702 are coupled to optical fibers 710. The optical fibers 710 can connect to other control panels in the network (which are on the same or on other floors of the building). The optical fibers 710 can include fibers such as 204, 213, 215, and 217 of FIG. 2, as examples. The switches 701 and 702 are also coupled to ethernet cables 712. Ethernet cables 712 are coupled to devices (e.g., disposed on the floor of control panel 700) and control components within the control panel 700. Control panel 700 further includes a floor controller 703. The floor controller 703 can control a plurality of local (e.g., window and/or sensor) controllers (see, e.g., the discussion of network controllers 106 of FIG. 1). Control panel 700 further includes first and second communication (abbreviated in FIG. 7 as “comm.” e.g., G.hn) head-ends 704 and 705. Communication head ends 704 and 705 are coupled to a plurality of network bus cables 714, which may be coaxial cables. The communication head ends 704 and 705 may provide electrical (e.g., DC) power and multiple distinguishable time-varying signals (e.g., simultaneously) over the network bus cables 714. The network bus cables include (e.g., coaxial) power and/or communication cables 259, 261, and 263 of FIG. 2, as examples. The communication head ends 704 and 705 may include, as examples, a pre-amplifier and/or an amplifier. Control panel 700 further includes electrical power distribution unit (PDU) 706. PDU 706 may serve as a network-connected power strip. Control components within control panel 700 including switches 701 and 702, floor controller 703, and/or communication headends 704 and 705, may receive power through PDU 706. PDU 706 may provide remote network-based monitoring of power usage by connected targets (e.g., devices). PDU 706 may provide remote network-based control of (e.g., electronic) power distribution to individual powered targets (e.g., components). Thus, PDU 706 can be used to remotely turn on and turn off, individually or in any combination, the various targets (e.g., components) receiving power through 706.

In certain embodiments, an enclosure (e.g., a building) may include edge distribution frames spread through the enclosure. An edge distribution frame may include one or more antennas, modems, and/or one or more radios configured to provide wireless communications connectivity to at least a portion of the enclosure. An edge distribution frame (abbreviated herein as “EDF”) may be coupled to a control panel (e.g., a control panel on a respective floor). The edge distribution frame may be in electrical and/or data communication with the control panel. As an example, one or more (e.g., combined) cables may be provided that include current conductor(s) communication cable(s) and/or one or more optical fibers. The current conductor may convey electrical power (e.g., from the control panel to the edge distribution frames). The current conductors communication cable(s) and/or the optical fiber(s) may convey analog signals and/or digital data between the control panels and the edge distribution frame(s). The edge distribution frame(s) may provide wireless communications capabilities (e.g., comprising cellular communications and/or Wi-Fi®) in their adjacent vicinities. The edge distribution frames may form a network (e.g., on some or all of the floors of a building) that may overlap with other cabling networks (e.g., coaxial-cable containing wiring networks that provide wired and/or wireless connectivity).

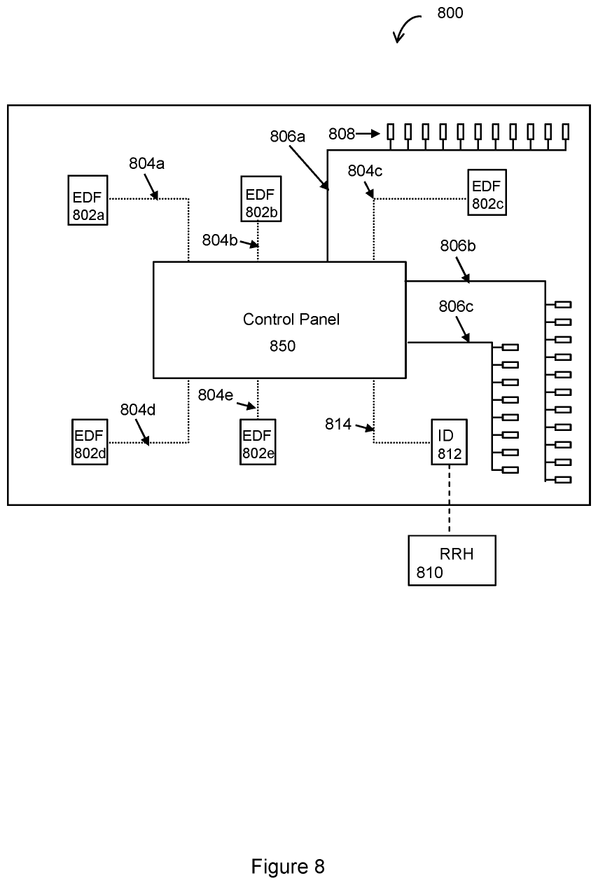

FIG. 8 depicts an example of an enclosure 800 (e.g., a floor of a building) that includes a network of edge distribution frames (EDFs). As shown in the example of FIG. 8, a network of EDFs 802a-e may be distributed across an enclosure (e.g., a floor of a building). The EDFs 802a-e may include antennas, modem, and/or radios and may provide wireless connectivity (e.g., cellular and/or Wi-Fi® connectivity) to detect signal from most (e.g., all) of the floor of the building. The EDFs 802a-e may be in electrical and/or data communication with control panel 800. EDFs 802a-e are coupled to the control panel 850 via respective cables 802a-e. The links (e.g., cables) 804a-e can be combination cables that include current carrying conductors and data communication (e.g., a coaxial cable or a combination of cables with one or more optical fibers), thus providing electrical power and data connectivity to the EDFs 802a-e. As depicted in FIG. 8, the enclosure includes other cabling networks, that may include coaxial-cable-based networks. In particular, the enclosure includes (e.g., coaxial) cables 806a-c, which provide connectivity to end targets (e.g., devices 808). The (e.g., coaxial) cables 806a-c are dispersed throughout at least some (e.g., all) of the enclosure and their reception zone overlaps in space with a portion of service areas of the EDFs 802a-e. FIG. 8 depicts a remote radio head (RRH) 810. The remote radio head may, as an example, be a cellular antenna or radio mounted to an exterior of the enclosure. The remote radio head can thereby provide connectivity to networks external to the enclosure. The RRH 810 can be connected to the control panel 850 via ID 812 and link (e.g., cable) 814. Link (e.g., cable) 814 may be a combined cable including current carrying conductors and/or communication transmitting cables such as coaxial cables or optical fibers. ID 812 may include radios, amplifiers, pre-amplifiers, switches, and/or other network devices supporting RRH 810.

A communications network for a building may include a vertically-oriented network portion (e.g., vertical data planes) that connects network components on multiple floors. As an example, the network components may include control panels disposed on separate floors, and a vertical data plane may connect the control panels together with redundancy.

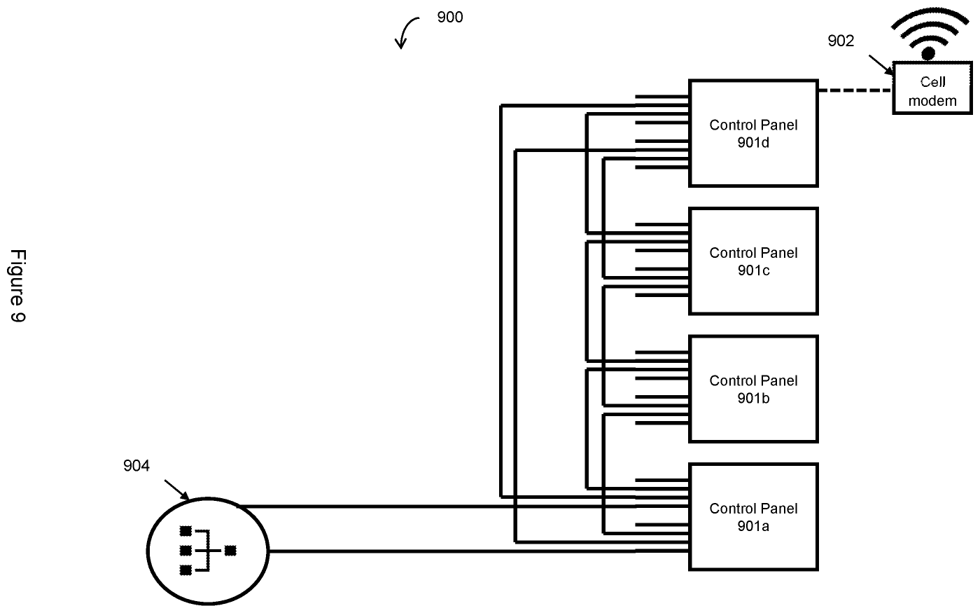

An example of a vertically-oriented network 900 having redundancy is shown in FIG. 9. In the FIG. 9 example, control panels 901a-901d are each located on a different floor of a building, which control panels are redundantly interconnected. In particular, control panel 901a is connected to control panels 901b and 901d, control panel 901b is connected to control panels 901a and 901c, control panel 901c is connected to control panels 901d and 901b, and control panel 901d is connected to control panels 901a and 901c. Some or all of the connections between control panels are themselves redundant (e.g., are formed from a pair of optical fibers (or other cabling medium)). The network 900 also includes a cell modem 902, which connects the network to an external cellular network. The network 900 includes redundant connections to infrastructure 904 (e.g., another network, whether internal or external to the enclosure in which network 900 is disposed).

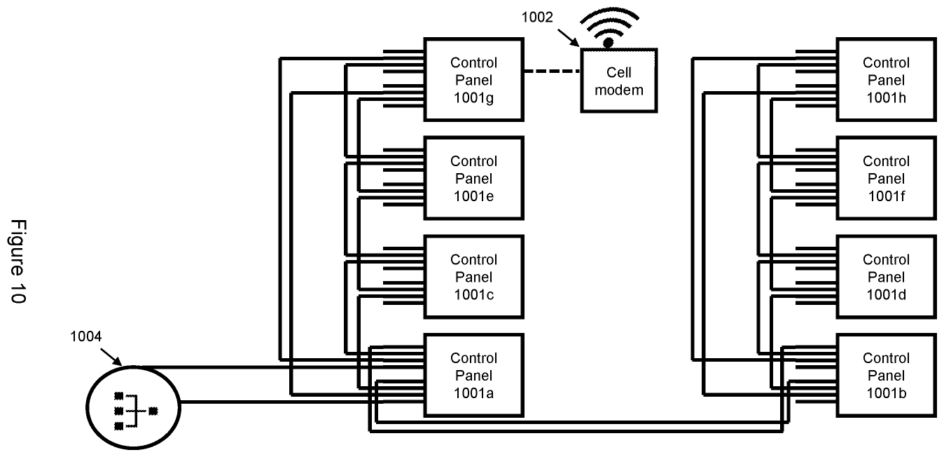

In some embodiments, a network may have multiple control panels on a plurality of building floors. Thus, a single floor may have horizontal data planes (e.g., networks of coaxial bus lines and edge data frames) served by two or more control panels. An example of such an arrangement is shown in FIG. 10. As shown in FIG. 10, a first floor of a building includes control panels 1001a and 1001b, which are coupled together with a pair of lines (e.g., optical fibers), to provide redundancy. A second floor of a building includes control panels 1001c and 1001d, a third floor of a building includes control panels 1001e and 1001f, and a fourth floor of a building includes control panels 1001g and 1001h. The control panels 1001a-h are coupled to infrastructure 1004 (e.g., another network, whether internal or external to the enclosure in which network 1000 is disposed). In FIG. 10, a first set of control panels (e.g., comprising control panels 1001a, 1001c, 1001e, and 1001g) form a first vertically-oriented network having redundant connections (as illustrated). A second set of control panels (e.g., comprising control panels 1001b, 1001d, 1001f, and 1001h) form a second vertically-oriented network having redundant connections (as illustrated). One benefit of having the vertical connections arranged in the manner of FIG. 10 is that the connections of the two sets of control panels can be run in separate risers within the building.

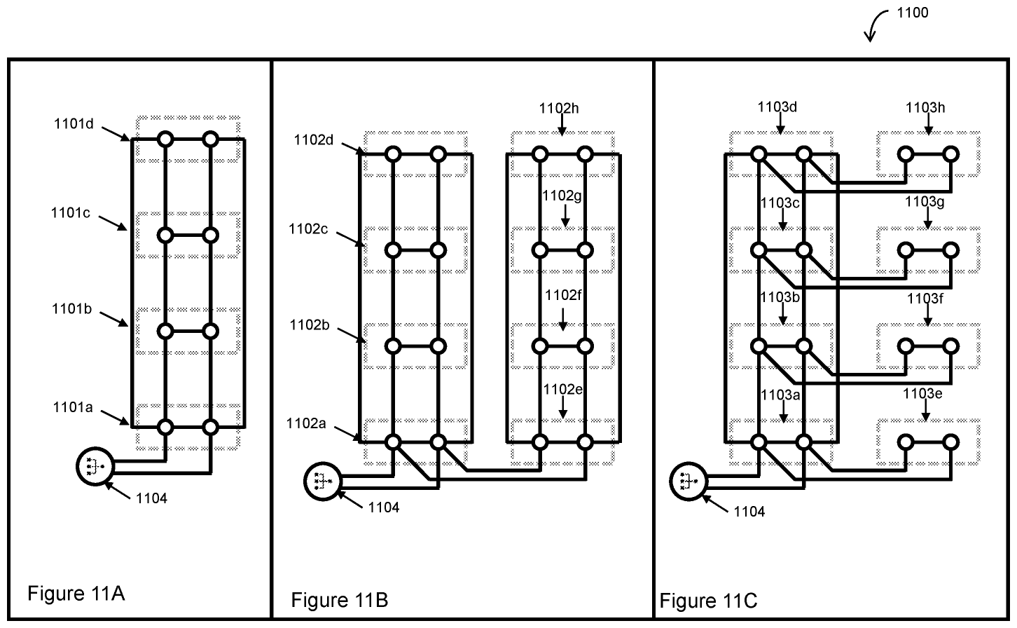

Additional arrangements of building network infrastructures are shown in the example of FIGS. 11A, 11B, and 110. FIG. 11A shows an example in which control panel panels 1101a-d are connected together using redundant loops. In particular, there are two vertical links between control panels on adjacent floors as well as two vertical links between the control panels on the top and bottom floors. Additionally, control panel 1101a is redundantly connected to infrastructure 1104 (e.g., another network, whether internal or external to the enclosure in which network 900 is disposed). A first floor of a building includes control panels 1101a, a second floor of a building includes control panels 1101b, a third floor of a building includes control panels 1101c, and a fourth floor of a building includes control panels 1101d. FIG. 11B shows an example in which each floor of the building includes two control panels and there are two redundant loops in the vertical data plane. In particular, control panel panels 1102a-d are connected together in a first redundant loop while control panel panels 1102e-h are connected together in a second redundant loop. A first floor of a building includes control panels 1102a and 1102e, a second floor of a building includes control panels 1102b and 1102f, a third floor of a building includes control panels 1102c and 1102g, and a fourth floor of a building includes control panels 1102d and 1102h. Control panels 1102a-d are redundantly connected to infrastructure 1104. Control panels 1102e-h are redundantly connected to infrastructure 1104. Control panels 1102e-h are redundantly connected to control panels 1102a-d. FIG. 11C shows an example in which each floor of the building includes two control panels, there is one redundant loop in the vertical data lane, and there is a redundant loop in some (e.g., all) of the floors of the building. In particularly, control panels 1103a-d are connected together in redundant loop in the vertical data plane. Additionally, control panel pairs 1103a and 1103e, 1103b and 1103f, 1103c and 1103g, and 1103d and 1103h are connected together in respective redundant loops in the horizontal data plane. A first floor of a building includes control panels 1103a and 1103e, a second floor of a building includes control panels 1103b and 1103f, a third floor of a building includes control panels 1103c and 1103g, and a fourth floor of a building includes control panels 1103d and 1103h. Control panel 1102a is redundantly connected to both control panel 1103e and infrastructure 1104; control panel 1103b is redundantly connected to both control panel 1103f and infrastructure 1104; control panel 1103c is redundantly connected to both control panel 1103g and infrastructure 1104; and control panel 1103d is redundantly connected to both control panel 1103h and infrastructure 1104. In various embodiments, a network infrastructure supports a control system for one or more windows such as electrochromic (e.g., tintable) windows. The control system may comprise one or more controllers operatively coupled (e.g., directly or indirectly) to one or more windows. While the disclosed embodiments describe electrochromic windows (also referred to herein as “optically switchable windows,” “tintable windows”, or “smart windows”), the concepts disclosed herein may apply to other types of switchable optical devices including, for example, a liquid crystal device, or a suspended particle device. For example, a liquid crystal device and/or a suspended particle device may be implemented instead of, or in addition to, an electrochromic device.

In some embodiments, a tintable exhibits a (e.g., controllable and/or reversible) change in at least one optical property of the window, e.g., when a stimulus is applied. The stimulus can include an optical, electrical and/or magnetic stimulus. For example, the stimulus can include an applied voltage. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through them. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC). In some cases, tintable windows may be responsive to one or more environmental sensors and/or user control. Tintable windows may comprise (e.g, may be) electrochromic windows. The windows may be located in the range from the interior to the exterior of a structure (e.g., facility, e.g, building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows with MEMS devices for tinting are described in U.S. patent application Ser. No. 14/443,353 that was filed May 15, 2015, and titled “MULTI-PANE WINDOWS INCLUDING ELECTROCHROMIC DEVICES AND ELECTROMECHANICAL SYSTEMS DEVICES,” which is herein incorporated by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g. noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g. cations) into the oxide may induce a visible change in a tint (e.g., color) of the oxide. For example, the oxide may transition from a colorless to a colored state. For example, intercalation of lithium ions into tungsten oxide (WO_{3-y} (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

Examples of electrochromic devices fabricated without depositing a distinct ion conductor material can be found in U.S. patent application Ser. No. 13/462,725 filed May 2, 2012, and titled “ELECTROCHROMIC DEVICES,” which is herein incorporated by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack (e.g, 1220). Various layers, including transparent conducting layers, can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack such that available ions in the stack that can cause the electrochromic material to be in the tinted state reside primarily in the counter electrode when the window is in a first tint state (e.g., clear). When the potential applied to the electrochromic stack is reversed, the ions can be transported across the ion conducting layer to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., untinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to untinted state).

In certain embodiments, at least a portion (e.g., all of) the materials making up electrochromic stack are inorganic, solid (e.g., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

In some embodiments, an IGU includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electricl leads may operatively couple (e.g. connect) one or more electrochromic devices to a voltage source, switches and the like, and may include a frame that supports the IGU or laminate. A window assembly may include a window controller, and/or components of a window controller (e.g., a dock).

In some embodiments, the first pane, the second panes, and/or the IGU, is a rectangular solid. In some implementations, other (e.g., geometric) shapes are possible. The shape of the first pane, the second panes, and/or the IGU, can include circular, elliptical, triangular, curvilinear, convex and/or concave. The first pane, the second panes, and/or the IGU may include a curvature. The first pane, the second panes, and/or the IGU may be devoid of a curvature. The first pane, the second panes, and/or the IGU may include one or more straight edge portions. A fundamental length scale of a pane may be at least 1 feet (ft), 2 ft, 3 ft, 5 ft, 10 ft, 20 ft, 30 ft, 40 ft, 50 ft, 60 ft, 80 ft, or 100 ft. A FLS of a pane may be of any value between the aforementioned values (e.g., from about 1 ft to about 100 ft, from about 1 ft to about 60 ft, or from about 50 ft to about 100 ft). A fundamental length scale (abbreviated herein as “FLS”) may comprise a length, a width, or a diameter of a bounding circle. For example, a length “L” of the first and/or the second panes can be in the range of at least about 20 inches (in.) to at most about 10 feet (ft.). For example, a width “W” of the first and/or the second panes can be in the range of from about 20 in. to about 10 ft. A thickness of a pane may be at least about 0.1 millimeter (mm), 0.2 mm, 0.3 mm, 0.4 mm, 0.5 mm, 1 mm, 5 mm, 10 mm, 20 mm, or 50 mm. A thickness of a pane may be of any value between the aforementioned values (e.g., from about 0.1 mm to about 50 mm, from about 0.1 mm to about 1 mm, from about 0.5 mm to about 20 mm, or from about 10 mm to about 50 mm). For example, a thickness “T” of the first and/or the second panes can be in the range of from about 0.3 millimeters (mm) to about 10 mm. Other FLS (e.g., lengths, or widths) or thicknesses, both smaller and larger, may be possible (e.g., requested) based at least in part on the needs of a particular user, manager, administrator, builder, architect, and/or owner. In examples where thickness T of substrate is less than about 3 mm (e.g., it is a thin substrate), the substrate may be laminated, e.g., to an additional substrate. The additional substrate may be thicker. The additional substrate may protect the thin substrate. Additionally, while the IGU can include two panes, in some implementations, an IGU can include three or more panes. In some implementations, one or more of the panes can be a laminate structure of two, three, or more layers (or sub-panes).

In some embodiments, first and second panes are spaced apart from one another by at least one spacer, e.g., to form an interior volume. The spacer(s) can comprise a frame structure. In some implementations, the interior volume is filled with a gas (e.g., Argon (Ar)). In some implementations, the interior volume can be filled with another gas, such as another noble gas (e.g., krypton (Kr), xenon (Xn)), another (non-noble) gas), a non-reactive gas (e.g., nitrogen), or mixture of gases (e.g., air). Filling the interior volume with the gas(es) can reduce conductive heat transfer through the IGU. The gas(es) may have a low thermal conductivity. The gas(es) may improve acoustic insulation. The gas(es) may have an increased atomic weights with respect to gas(es) in the ambient environment (e.g., air). In some other implementations, the interior volume can be evacuated of gas(es). The interior volume may comprise a reduced pressure as compared to an ambient pressure. The interior volume may have a gas composition and/or pressure different than the one in the ambient environment (e.g., external to the IGU). The one or more spacers may determine (at least in part) the height of the interior volume (e.g., 1308); that is, the extent of spacing between the first and the second panes. The FLS of the spacer may be at least about 4 mm, 5 mm, 6 mm, 10 mm, 20 mm, 25 mm, 30 mm, 35 mm, or 40 mm. The FLS of the spacer may have any value between the aforementioned values (e.g., from about 4 mm to about 25 mm, from about 20 mm to about 40 mm, or from about 4 mm to about 40 mm). In some implementations, the spacing between the first and the second panes is in the range of from about 6 mm to about 30 mm. The width (e.g., “D” in FIG. 2A) of spacer can be in the range of from about 5 mm to about 25 mm (although other widths are possible and may be desirable).

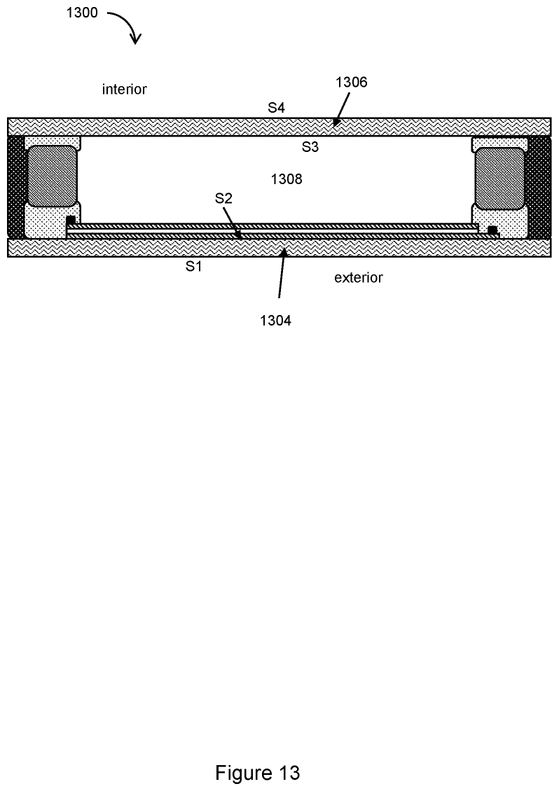

The at least one spacer can be a frame structure formed around a plurality of (e.g., all) sides of the IGU (for example, top, bottom, left and right sides of the IGU). The spacer can be formed of a foam and/or plastic material. The spacer may comprise a polymer. The spacer can comprise an elemental metal or a metal alloy. The spacer may comprise a tube or a channel structure. The spacer may have at least 3 sides. The spacer may have at least two sides (e.g., configured for sealing to each of the lites). The spacer may have one at least side configured to support and/or separate the lites. The spacer may have at least one side configured to supports a surface on which to apply a sealant (e.g., between the spacer and the lite). A first primary seal may adhere to the spacer. The first primary seal may hermetically seals the spacer and the second surface (e.g., S2 of FIG. 13) of the first pane (e.g., 1304). A second primary seal) may adhere to and/or hermetically seal the spacer and the first surface (e.g., S3 of FIG. 13) of the second pane (e.g., 1306). In some implementations, the primary seals can comprise an adhesive sealant such as, for example, polyisobutylene (PIB). In some implementations, the IGU includes a secondary seal that (e.g., hermetically) seals a border around the IGU. The secondary seal may be disposed outside of spacer. The spacer can be inset from edges of the first and second panes, e.g., by a distance that can be in the range of from about 4 mm to about 8 mm (although other distances are possible and may be desirable). In some implementations, secondary seal can comprise an adhesive sealant such as, for example, a polymeric material. The spacer material may resist water. The spacer material may add structural support to the assembly. The spacer material may comprise silicone, polyurethane, Teflon, or structural sealants that form a watertight seal.

In some embodiments, one or more controllers are operatively coupled to the window. One or more controllers can be associated with (e.g., operatively coupled to) one or more tintable windows. The one or more controllers can be configured to control an optical state of the window, e.g., by applying a stimulus to the window. The stimulus may comprise a voltage and/or a current, e.g., to an EC device coating. The one or more controllers may have various sizes, formats, and locations with respect to the optically switchable windows they control. The at least one controller may be attached to a lite of an IGU or laminate thereof. The at least one controller may be disposed in a frame, e.g., that houses the IGU or laminate. The at least one controller may be disposed in a location separate from the IGU (or laminate thereof). A tintable window may include one, two, three or more electrochromic panes (e.g., an electrochromic device on a transparent substrate). An individual pane of an electrochromic window may include an electrochromic coating, e.g., that has independently tintable zones. The at least one controller can control at least two of (e.g., all of) the electrochromic coatings associated with the window(s), whether the electrochromic coating is monolithic or zoned.

In some embodiments, the window controller is located in proximity to the tintable window (e.g., when not directly, attached to a tintable window, IGU, or frame). For example, a window controller may be adjacent to the window, on the surface of one of the lites of the window, within a wall next to a window (e.g., a wall bordering and/or contacting the window), or within a frame of a window assembly. In some embodiments, the window controller is an in situ controller. In some embodiments, an in situ controller is part of a window assembly (e.g., comprising an IGU or a laminate). The in situ controller may not have to be matched with the electrochromic window. The in situ controller may be installed, in the field (e.g., target location). The in situ controller may travel with the window (e.g., as part of the assembly) from the factory. The in situ controller may be installed in the window frame of a window assembly, and/or be part of an IGU (and/or laminate) assembly. For example, the controller can be mounted on to, or between, panes of the IGU. For example, the controller can be disposed on a pane of a laminate. The controller may be controller located on the visible portion of an IGU. At least a portion of the controller may be (e.g., substantially) transparent to an average human eye. Further examples of controllers are provided in U.S. patent application Ser. No. 14/951,410 filed Nov. 14, 2015, titled “SELF CONTAINED EC IGU,” which is herein incorporated by reference in its entirety. A localized controller may be provided (i) as more than one part (e.g., portion), (ii) with at least one part (e.g., including a memory component storing information about the associated electrochromic window), (iii) as a part of the window assembly, and/or (iv) with at least one portion thereof being separate. The controller may be configured to mate with the at least one portion of the window assembly, IGU, and/or laminate. A controller may be an assembly of interconnected parts. The interconnected parts may not be disposed in a single housing. The interconnected parts of the controller may be disposed as spaced apart, (e.g., in the secondary seal of an IGU). The controller can constitute a compact unit. The compact unit may be in a single housing. The compact unit may reside in two or more separate components that combine (e.g., a dock and housing assembly). The controller may be disposed in an area that is viewable or not viewable by an occupant of an enclosure in which the controller resides.

In one embodiment, the window controller is incorporated into or onto (i) the IGU and/or (ii) the window frame. The incorporation of the controller may be prior to, during, and/or after installation of the tintable window in its target location. The controller (e.g., of the window) may be disposed in the same facility (e.g., building) as the window. For example, the controller can be incorporated into or onto the IGU and/or the window frame, prior to leaving the manufacturing facility of the window and/or of the controller. In one embodiment, the controller is incorporated into the IGU (e.g., substantially within the secondary seal). In another embodiment, the controller is incorporated into or onto the IGU, partially, substantially, or wholly within a perimeter defined by the primary seal. The perimeter may be between the sealing separator and the substrate (e.g., lite).

The controller may be part of an IGU and/or a window assembly. For example, the controller may travel with the IGU or window unit. When a controller is part of the IGU assembly, the IGU can possess logic and features of the controller.

In some embodiments, one or more characteristics of the electrochromic device(s) change over time (e.g., through degradation). A characterization function can be used at least in part, e.g., to update one or more control parameters utilized in directing alteration of a tint state of the IGU. If already installed in an electrochromic window unit, the logic and features of the controller can be used (at least in part) to calibrate the one or more control parameters to match an intended installation. If already installed, the control parameters can be recalibrated to match one or more performance characteristics of the electrochromic device(s).

In other embodiments, a controller is not pre-associated with a window. A dock component, e.g., having parts generic to any electrochromic window, may be associated with at least one (e.g., each) window at the factory (e.g., where the controller and/or window construct is produced). After and/or during window installation (or otherwise in the target location (e.g., in the field), a second component of the controller may be combined with the dock component, e.g., to complete the electrochromic window controller assembly. The dock component may include a circuitry. The dock component may include a chip. The chip may be programmed at the factory. The programing of the chip may consider (e.g., take into account) one or more physical characteristics and/or parameters of the particular window to which the dock is attached. For example, on the surface which will face the building's interior after installation, sometimes referred to as surface 4 or “S4.” The second component (referred to as a “carrier,” “casing,” or “housing”) can be mated with the dock. Once the second component is mated with the dock, it can be powered. The second component can be configured to read the chip. The second component may configure itself to electrically power the window, e.g., according to the particular one or more characteristics and/or parameters stored on the chip. The shipped window may require (e.g., only) its associated one or more characteristics and/or parameters stored on the chip. The chip may be integral with the window. The more sophisticated circuitry (e.g., as compared to the chip) and/or components can be combined later with the controller-window assembly. For example, the more sophisticated circuitry and/or components may be (i) shipped separately from the window, dock, and/or second component, and/or (ii) installed by the window manufacturer after (a) the glazier has installed the windows and/or (b) followed by commissioning by the window manufacturer. In some embodiments, the chip is included in a wire or wire connector (referred to herein as “pigtails”). The wire or wire connector may be attached to the window controller.

The term “outboard” is understood herein to refer to a location closer to the outside environment, while the term “inboard” is understood herein to refer to a location closer to the interior of a building. For example, in the case of an IGU having two panes, the pane located closer to the outside environment is referred to as the outboard pane or outer pane, while the pane located closer to the inside of the building is referred to as the inboard pane or inner pane. As illustrated with respect to the examples shown in FIG. 13, the different surfaces of the IGU may be referred to as S1, S2, S3, and S4 (assuming a two-pane IGU). S1 refers to the exterior-facing surface of the outboard lite (e.g., the surface that can be physically touched by someone standing outside). S2 refers to the interior-facing surface of the outboard lite. S3 refers to the exterior-facing surface of the inboard lite. S4 refers to the interior-facing surface of the inboard lite (e.g., the surface that can be physically touched by someone standing inside the building). In other words, the surfaces are labeled S1-S4, starting from the outermost surface of the IGU and counting inwards. In cases where an IGU includes three panes, this trend holds. In certain embodiments employing two panes, the electrochromic device (or other optically switchable device) is disposed on S3. In certain embodiments, one or more of the surfaces has a structure for blocking transmission of electromagnetic radiation. The IGU may comprise a shielding stack of multiple conductive layers, e.g., on an internal surface such as S3 of FIG. 13. Additional aspects of shielding stack structures are presented in U.S. patent application Ser. No. 15/709,339 filed Sep. 19, 2017, which is incorporated herein by reference in its entirety.

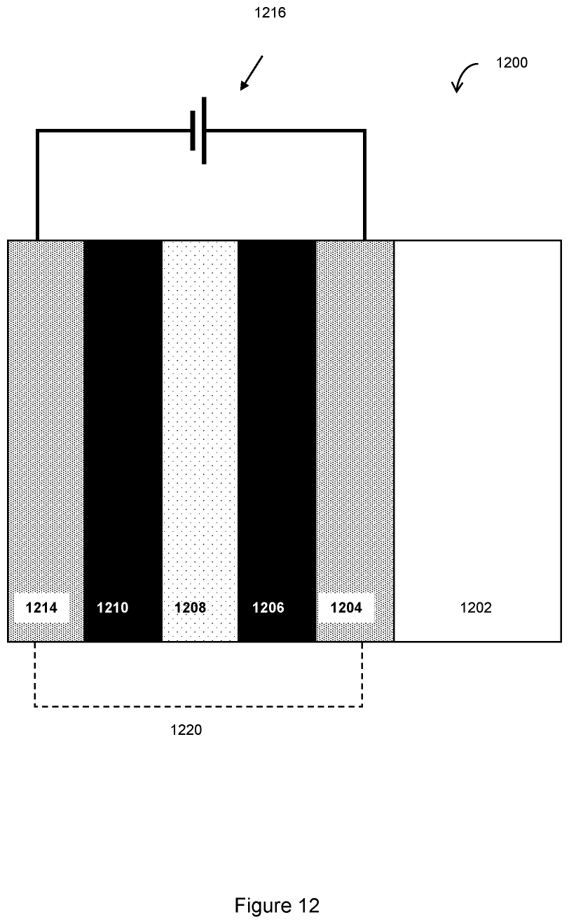

Examples of window controllers and their features are presented in U.S. patent application Ser. No. 13/449,248 filed Apr. 17, 2012, and titled “CONTROLLER FOR OPTICALLY-SWITCHABLE WINDOWS”; U.S. patent application Ser. No. 13/449,251 filed Apr. 17, 2012, and titled “CONTROLLER FOR OPTICALLY-SWITCHABLE WINDOWS”; U.S. patent application Ser. No. 15/334,835 filed Oct. 26, 2016, and titled “CONTROLLERS FOR OPTICALLY-SWITCHABLE DEVICES”; and International Patent Application Serial Number PCT/US17/20805 filed Mar. 3, 2017, and titled “METHOD OF COMMISSIONING ELECTROCHROMIC WINDOWS,” each of which is incorporated herein by reference in its entirety. FIG. 12 shows an example of a schematic cross-section of an electrochromic device 1200 in accordance with some embodiments is shown in FIG. 12. The EC device coating is attached to a substrate 1202, a transparent conductive layer (TCL) 1204, an electrochromic layer (EC) 1206 (sometimes also referred to as a cathodically coloring layer or a cathodically tinting layer), an ion conducting layer or region (IC) 1208, a counter electrode layer (CE) 1210 (sometimes also referred to as an anodically coloring layer or anodically tinting layer), and a second TCL 1214. Elements 1204, 1206, 1208, 1210, and 1214 are collectively referred to as an electrochromic stack 1220. A voltage source 1216 operable to apply an electric potential across the electrochromic stack 1220 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL. In various embodiments, the ion conductor region (e.g., 1208) may form from a portion of the EC layer (e.g., 1206) and/or from a portion of the CE layer (e.g., 1210). In such embodiments, the electrochromic stack (e.g., 1220) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725 filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 1220. Various layers, including transparent conducting layers (such as 1204 and 1214), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack (e.g., 1220) such that available ions in the stack that can cause the electrochromic material (e.g., 1206) to be in the tinted state reside primarily in the counter electrode (e.g., 1210) when the window is in a first tint state (e.g., clear). When the potential applied to the electrochromic stack is reversed, the ions can be transported across the ion conducting layer (e.g., 1208) to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., untinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to untinted state).

In certain embodiments, at least a portion (e.g., all of) the materials making up electrochromic stack are inorganic, solid (e.g., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

FIG. 13 show an example of a cross-sectional view of a tintable window embodied in an insulated glass unit (“IGU”) 1300, in accordance with some implementations. The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume (e.g., 1308) of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g. connect) one or more electrochromic devices to a voltage source, switches and the like, and may include a frame that supports the IGU or laminate. A window assembly may include a local controller (e.g., window controller), and/or control components of a local controller (e.g., a dock).

FIG. 13 shows an example implementation of an IGU 1300 that includes a first pane 1304 having a first surface S1 and a second surface S2. In some implementations, the first surface S1 of the first pane 1304 faces an exterior environment, such as an outdoors or outside environment. The IGU 1300 also includes a second pane 1306 having a first surface S3 and a second surface S4. In some implementations, the second surface (e.g., S4) of the second pane (e.g., 1306) faces an interior environment, such as an inside environment of a home, building, vehicle, or compartment thereof (e.g., an enclosure therein such as a room). In some implementations, the first and the second panes (e.g., 1304 and 1306) are transparent or translucent, e.g., at least to light in the visible spectrum. For example, each of the panes (e.g., 1304 and 1306) can be formed of a glass material. The glass material may include architectural glass, and/or shatter-resistant glass. The glass may comprise a silicon oxide (SOₓ). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

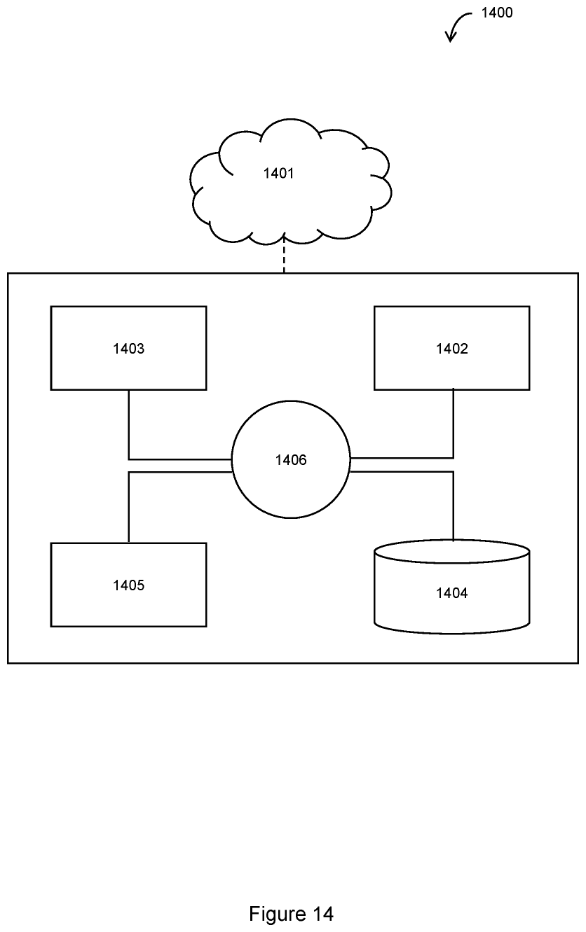

FIG. 14 shows a schematic example of a computer system 1400 that is programmed or otherwise configured to one or more operations of any of the methods provided herein. The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 1406) (also “processor,” “computer” and “computer processor” used herein). The computer system may include memory or memory location (e.g., 1402) (e.g., random-access memory, read-only memory, flash memory), electronic storage unit (e.g., 1404) (e.g., hard disk), communication interface (e.g., 1403) (e.g., network adapter) for communicating with one or more other systems, and peripheral devices (e.g., 1405), such as cache, other memory, data storage and/or electronic display adapters. In the example shown in FIG. 14, the memory 1402, storage unit 1404, interface 1403, and peripheral devices 1405 are in communication with the processing unit 1406 through a communication bus (solid lines), such as a motherboard. The storage unit can be a data storage unit (or data repository) for storing data. The computer system can be operatively coupled to a computer network (“network”) (e.g., 1401) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1402. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other electronic components of the system 1400 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 1402 or electronic storage unit 1404. The machine executable or machine-readable code can be provided in the form of software. During use, the processor 1406 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, visible light camera, CCD camera). The sensor may comprise a sensor array (e.g., an IR sensor array). The camera and/or sensor array may comprise at least 2000, 3000, or 4000 pixels at its fundamental length scale. The sensor may be configured to detect radio frequency. The device may comprise a geo-location device (e.g., a device including Bluetooth, GPS, and/or UWV gelo-location technology). The sensor may comprise an acoustic sensor. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

In some embodiments, the target device and/or the (local) network is configured for radio communication. The target device may comprise a transceiver. In some embodiments, a transceiver and/or the local network may be configured transmit and receive one or more signals using a personal area network (PAN) standard, for example such as IEEE 802.15.4. In some embodiments, signals may comprise Bluetooth, Wi-Fi, or EnOcean signals (e.g., wide bandwidth). The one or more signals may comprise ultra-wide bandwidth (UWB) signals (e.g., having a frequency in the range from about 2.4 to about 10.6 Giga Hertz (GHz), or from about 7.5 GHz to about 10.6 GHz). An Ultra-wideband signal can be one having a fractional bandwidth greater than about 20%. An ultra-wideband signal can have a bandwidth greater than about 500 Mega Hertz (MHz). The one or more signals may use a very low energy level for short-range. Signals (e.g., having radio frequency) may employ a spectrum capable of penetrating solid structures (e.g., wall, door, and/or window). Low power may be of at most 25 milli Watts (mW), 50 mW, 75 mW, or 100 mW. Low power may be any value between the aforementioned values (e.g., from 25 mW to 100 mW, from 25 mW to 50 mW, or from 75 mW to 100 mW). In some embodiments the local network (e.g., comprising one or more stationary sensors and/or stationary transceivers) is configured to (I) located a transitory transceiver in real time, (II) locate the transitory transceiver to an accuracy of about 20, 10, or 5 centimeters or to a higher accuracy, (Ill) transmit and sense ultrawide radio waves, and/or (IV) operatively couple to a control system configured to control a facility in which the local network of one or more stationary sensors and/or stationary transceivers are disposed.

In some embodiments, the local network incorporates and/or facilitates geo-location technology (e.g., global positioning system (GPS), Bluetooth (BLE), ultrawide band (UWB) and/or dead-reckoning), e.g., using a micro-location chip. The geo-location technology may facilitate determination of a position of signal source (e.g., location of a transitory tag comprising a transceiver facilitating the geo-location technology) to an accuracy of at least 100 centimeters (cm), 75 cm, 50 cm, 25 cm, 20 cm, 10 cm, or 5 cm. In some embodiments, the electromagnetic radiation of the signal comprises ultra-wideband (UWB) radio waves, ultra-high frequency (UHF) radio waves, or radio waves utilized in global positioning system (GPS). In some embodiments, the electromagnetic radiation comprises electromagnetic waves of a frequency of at least about 300 MHz, 500 MHz, or 1200 MHz. In some embodiments, the signal comprises location and/or time data. In some embodiments, the tag utilizes Bluetooth, UWB, UHF, and/or global positioning system (GPS) technology. In some embodiments, the signal has a spatial capacity of at least about 1013 bits per second per meter squared (bit/s/m²).

In some embodiments, pulse-based ultra-wideband (UWB) technology (e.g., ECMA-368, or ECMA-369) is a wireless technology for transmitting large amounts of data at low power (e.g., less than about 1 millivolt (mW), 0.75 mW, 0.5 mW, or 0.25 mW) over short distances (e.g., of at most about 300 feet 0, 250′, 230′, 200′, or 150′). A UWB signal can occupy at least about 750 MHz, 500 MHz, or 250 MHz of bandwidth spectrum, and/or at least about 30%, 20%, or 10% of its center frequency. The UWB signal can be transmitted by one or more pulses. A component broadcasts digital signal pulses may be timed (e.g., precisely) on a carrier signal across a number of frequency channels at the same time. Information may be transmitted, e.g., by modulating the timing and/or positioning of the signal (e.g., the pulses). Signal information may be transmitted by encoding the polarity of the signal (e.g., pulse), its amplitude and/or by using orthogonal signals (e.g., pulses). The UWB signal may be a low power information transfer protocol. The UWB technology may be utilized for (e.g., indoor) location applications. The broad range of the UWB spectrum comprises low frequencies having long wavelengths, which allows UWB signals to penetrate a variety of materials, including various building fixtures (e.g., walls). The wide range of frequencies, e.g., including the low penetrating frequencies, may decrease the chance of multipath propagation errors (without wishing to be bound to theory, as some wavelengths may have a line-of-sight trajectory). UWB communication signals (e.g., pulses) may be short (e.g., of at most about 70 cm, 60 cm, or 50 cm for a pulse that is about 600 MHz, 500 MHz, or 400 MHz wide; or of at most about 20 cm, 23 cm, 25 cm, or 30 cm for a pulse that is has a bandwidth of about 1 GHz, 1.2 GHz, 1.3 GHz, or 1.5 GHz). The short communication signals (e.g., pulses) may reduce the chance that reflecting signals (e.g., pulses) will overlap with the original signal (e.g., pulse).

In certain embodiments, a building network infrastructure has a vertical data plane (between building floors) and a horizontal data plane (within a single floor or multiple contiguous floors). The horizontal and vertical data planes may have at least one data carrying capability that is (e.g., substantially) similar. The horizontal and vertical data plane may have at least one type of network components that is (e.g., substantially) similar. In other cases, these two data planes have different data carrying capabilities. In some cases, the horizontal and vertical data planes have (e.g., substantially) the same (or similar) data carrying capabilities and/or type of network components. In other cases, the vertical and horizontal data planes have at least one (e.g., all) data carrying capability and/or network component that is different from each other. For example, the vertical data plane may contain network components for fast communication (e.g., data transmission) rates and/or bandwidths. The faster communication rates may be at least about 1 Gigabits per second (Gbit/s), 10 Gbit/s, 50 Gbit/s, 100 Gbit/s, 250 Gbit/s, 500 Gbit/s, 750 Gbit/s, 1 terabits per second (Tbit/s), or 1.125 Tbit/s. The faster communication rates can be any communication rate between the aforementioned rates (e.g., from about 1 Gbit/s to about 1.125 Tbit/s, from about 1 Gbit/s to about 500 Gbit/s, or from about 250 Gbit/s to about 1.125 Tbit/s).

The description of FIGS. 15-18 presents network topologies that may be substituted for topologies presented for some other embodiments disclosed herein, e.g., network topologies of FIGS. 15-18, may be substituted for linear bus topologies in some cases. The network topologies described with respect to FIGS. 15-18 may employ control components such control panels that may have functions and/or design elements that are similar to and/or overlap with components described in other embodiments presented herein. The data carried on and/or the data protocols employed in the topologies of FIGS. 15-18 may be substituted by or supplemented with data and/or data protocols described in other embodiments presented herein. The data carried on and/or the data protocols employed in the topologies of FIGS. 15-18 may be carried within frequency ranges described in other embodiments presented herein. To the extent that electrically conductive data carrying lines (e.g., coaxial or twisted (e.g., pair) cables) are used in the network topologies presented in FIGS. 15-18, the vertical and/or horizontal data may be configured such that the electrically conductive data carrying lines may carry electrical power to end devices, in certain embodiments.

Different physical network topologies may be employed for supplying electrical power and/or communication data to building devices in a horizontal data plane (such as on a given floor, or multiple (e.g., contiguous) floors, of a building). For example, FIG. 15 shows three possible physical network topologies A, B and C for providing data communications between a control panel 1 and building devices 2 arranged around the perimeter of a building floor 1503. Dashed lines indicated (e.g., high-speed) data communication paths provided by fiber optic cabling.

Network topology A has a star configuration in which each building device 2 is connected directly to the control panel 1 by a dedicated (e.g., fiber optic cable) link. Network topology A can be easy to design and implement (e.g., requires minimal labor hours and/or cost). Network A can facilitates addition of new building devices to the network. However, the central single control panel may present a single point of failure in the network. Should a fault develop at the control panel 1, data communications to all building devices 2 on the floor could be affected. In addition, the amount of wiring (e.g., fiber optic or other cabling) required for the network scales linearly with the number of building devices 2.

Network topology B has a distributed star (or tree) configuration in which the building devices 2 are connected to the central control panel 1 by way of intermediate control panels 1′, each intermediate control panel 1′ being associated with multiple building devices 2. Network topology B can reduce the amount of wiring (e.g., fiber optic or other cabling), compared to topology A, which wiring is required to provide data communications for each building device 2 in the network. Although the amount of wiring (e.g., fiber optic or other cabling) required for the network B scales linearly as more devices are added to the network, the length of wiring required for each additional device in topology B is smaller than in topology A. Despite network topology B incorporating more control panels than network topology A, such that the level of physical redundancy is increased to an extent, the central control panel 1 represents a single point of failure in the network.

Network topology C has a linear configuration in which device 2 is connected to the central control panel 1 via a linear (e.g., fiber optic or other cable) bus. Network topology C reduces the amount of wiring required to connect each device 2 to the control panel 1 relative to network topology A.

In various embodiments, a ring topology is employed for the data communications and/or electrical power distribution lines of a building floor. In some cases, the wiring, control panels, radios, antennas, and other network components associated with the ring are located in and/or on the building's outer structures (or skin). Similarly, at least some (e.g., all) network components of other network topologies described herein may be disposed in the enclosure (e.g., building) skin. A building's skin may include various structures that serve as the building's outer construction. The building skin may comprise fixtures (e.g., walls). Examples include a building's exterior walls, exterior windows, optionally including optically switchable windows, façade, window framing structure, and the like. In various embodiments, the building's skin includes mullions, transoms, and/or other structures that may provide interior passages for network wiring and/or may provide support surfaces on which to mount control panels or other network devices.

The network and/or power distribution components disposed on the building skin may provide data communications and/or electrical power distribution functions such as telecommunications, a computing platform, wired or wireless power for the building, and/or other attributes described herein.

In certain embodiments, at least a portion (e.g., all) communication and/or electrical power distribution components are installed during (e.g., early in) the building construction process (e.g., before constructing interior rooms, before installing exterior windows, or before installing IT infrastructure, etc.). In certain embodiments, at least a portion (e.g., all) communication and/or electrical power distribution components are installed after the building construction process has ended. In certain embodiments, at least a portion (e.g., all) communication and/or electrical power distribution components are installed during occupation of the building. In some cases, at least a portion of the communication and/or electrical power distribution components are available to construction personnel to facilitate construction and installation operations.

In some cases, the communication and/or electrical power distribution system (e.g., network system) initially installed in the building skin is not configured to control some or all building devices such as sensors, emitters, and/or tintable (e.g., optically switchable) windows The network system (e.g., controllers operatively coupled thereto) can be, at a later phase, configured to control such devices. As an example, one vendor provides some or all of the communications and electrical power distribution infrastructure on the building skin, and a second vendor provides sensing units and/or optically switchable windows that attach to the infrastructure and are ultimately controlled by it.

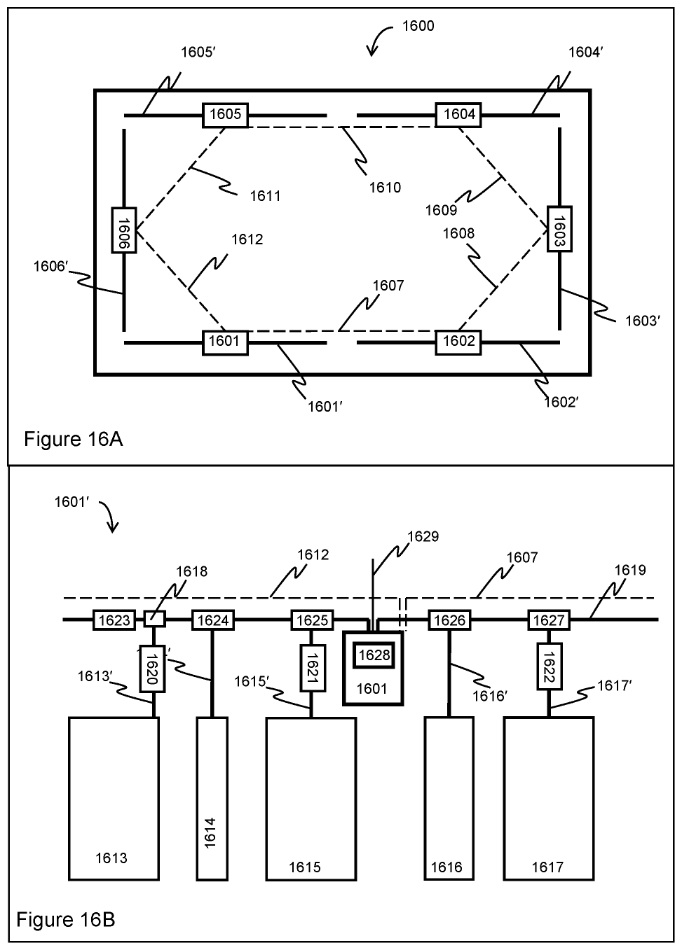

FIG. 16A shows a schematic plan view of a physical network topology for a floor 1600 of a building in accordance with some embodiments of the present disclosure. The floor network includes distributed control panels 1601, 1602, 1603, 1604, 1605 and 1606 connected to one another in series by segments of first wiring (e.g., fiber optic or other cable) 1607, 1608, 1609, 1610, 1611 and 1612 to form a primary first wiring (e.g., fiber optic or other cable) ring. Each distributed control panel 1601, 1602, 1603, 1604, 1605 and 1606 forms a node in the primary ring. The primary ring may extend around the floor adjacent the perimeter of the floor. Each distributed control panel 1601, 1602, 1603, 1604, 1605 and 1606 is also connected to a corresponding second wiring (e.g., coaxial or other cable) network branch 1601′, 1602′, 1603′, 1604′, 1605′ and 1606′. Each second (e.g., coaxial or other cable) network branch extends along a respective portion of the perimeter of the building floor. As depicted, a given control panel may include two or more second wiring (e.g., coaxial or other cable) branches, although each of them is not numbered in the figures. The first wiring and the second wiring may be of a different wiring type. The first wiring and the second wiring may be of (e.g., substantially) the same wiring type.

An example second wiring (e.g., coaxial or other cable) network branch 1601′ is shown in more detail in FIG. 16B. The network branch 1601′ includes branch devices 1613, 1614, 1615, 1616 and 1617 coupled to linear second wiring (e.g., coaxial or other cable) branch lines 1618 and 1619 by corresponding second wiring (e.g., coaxial or other cable) drop lines 1613′, 1614′, 1615′, 1616′ and 1617′. The drop lines 1613′, 1614′, 1615′, 1616′ and 1617′ may be connected to the linear second wiring branch lines 1618 and 1619 by way of taps 1623, 1624, 1625, 1626 and 1627. Device controllers (e.g., local controllers) 1620, 1621 and 1622 are installed in the drop lines 1613′, 1615′ and 1617′. The branch targets (e.g., devices) 1613, 1614, 1615, 1616 and 1617 may be any type of building devices which require an electrical power and/or data supply. For example, the branch devices may include one or more electrochromic devices (such as electrochromic windows or insulated glass units (IGUs)), external sensing devices (such as light or weather sensors), internal sensing devices (such as internal air quality monitoring devices or asset tracking devices), communications devices (such as antennas, receivers, transceivers or radios), digital architectural elements, or building security devices (such as burglar alarms), lighting, or HVAC components. The distributed control panel 1601 includes a headend unit 1628 and is connected to a (e.g., dedicated) electrical power supply 1629, e.g., an AC power supply. In some embodiments, the dedicated AC power supply is provided by a power supply line, such as a coaxial or other cable line. The dedicated power line can extend around the perimeter of the building, e.g., in parallel to other (e.g., fiber optic) cabling of the primary ring. In other embodiments, the distributed control panel is connected to a DC power supply, for example by way of a DC power supply line. The DC power supply line may extend around the perimeter of the building, e.g., in parallel to the (e.g., fiber optic) cabling of the primary ring. The headend unit 1628 in the distributed control panel 1601 can function as a gateway for data communication between the first wiring (e.g., fiber optic) primary ring and the second wiring (e.g., coaxial cable) network branch 1601′. Each of the second wiring network branches 1602′, 1603′, 1604′, 1605′ and 1606′ can be similar in format to branch 1601′, although the number and types of branch devices and device controllers present in each branch may differ, e.g., dependent on the requirements of the building.

In the embodiment shown in FIG. 16A, the fiber optic primary ring connects the distributed control panels 1601, 1602, 1603, 1604, 1605 and 1606 around the ring to a building (e.g., Ethernet) network configured for communication of data, such as control data for controlling the various branch devices. The first wiring (e.g., fiber optic) primary ring can support high-speed data transmission, at speeds, e.g., greater than about 1 Gbit/s per channel (e.g., at least about 10 Gbit/s per channel), optionally with low transmission loss and diminished (e.g., little or no) interference. In some embodiments, the fiber optic primary ring 1612 does not provide electrical power transmission to the distributed control panels.

The second wiring (e.g., coaxial cable) network branches 1601′, 1602′, 1603′, 1604′, 1605′ and 1606′, connect the distributed control panels 1601, 1602, 1603, 1604, 1605 and 1606 around the ring to the branch devices in each second wiring (e.g., coaxial cable) network branch. The second wiring may supply both electrical power and data. Electrical power can be supplied to the distributed control panels by one or more dedicated power supplies. In embodiments in which AC power is supplied to the distributed control panels, power can be rectified to DC, and may be transformed to a low voltage, e.g., of about 24 V DC, (for example, by an AC to DC converter) within the distributed control panels. The lower voltage power can be transmitted to the branch devices, e.g., via the second wiring (e.g., coaxial cable) branch lines. In alternative embodiments in which DC power is supplied to the distributed control panels, power can be transformed to a low voltage (for example, by a DC to DC converter) within the distributed control panels. The lower voltage power can be transmitted to the branch devices via the second wiring (e.g., coaxial cable) branch lines. Data from the firs wiring (e.g., fiber optic) primary ring can be received by the headend unit in the distributed control panels and transmitted to the branch devices via the second wiring (e.g., coaxial cable) branch lines, e.g., using a protocol such as MoCA, G.hn, and/or any of various cellular communications protocols. In certain embodiments, electrical power is transmitted on the second wiring (e.g., coaxial) line using, e.g., a DC power-line communication (PLC) protocol and/or a power over ethernet protocol. The PLC methods can enable both electrical power and data to be transmitted to the branch devices along a single branch line.

Each distributed control panel node in the primary ring shown in FIG. 16A can be accessible by two different first wiring (e.g., fiber optic) paths, e.g., due to the network ring topology. Through the use of network protocols (such as Spanning Tree Protocol (STP), which is oftentimes used in networks with ring topologies), it may be possible to build redundancy into the floor network. For example, if a given node develops a fault that hinders (e.g., prevents) communication of signals through that node, communication with neighboring nodes on the ring may not be prevented (as each node can be reached via an alternative path). Fault-tolerance redundancy can thus be built into the network. The redundancy can be advantageous when one or more network branches include branch device(s) used for applications which require high reliability (e.g., diminished number of failure incidents), such as burglar alarms or communications devices. In some embodiments, the distributed control panels also contain devices for connecting to a Wireless Local Area Network (e.g. via Wi-Fi), providing an additional layer of fault-tolerance redundancy.

The ring topology of the network shown in FIG. 16A can be simple to install (e.g., requires less labor, labor force that is less trained, and/or cheaper to install). Moreover, the use of linear second wiring (e.g., coaxial cable) network branches around the primary ring can provide a significant cost reduction, e.g., by reducing the length of first wiring (e.g., fiber optic or other cabling) required to provide all devices in the network with (e.g., high-speed) data communications. The topology illustrated in FIG. 16A may strike a balance between fault-tolerance across the floor, supply of (e.g., high-speed) data communications, ease of installation, and low cost of installation.

In certain embodiments, a building network infrastructure has a vertical data plane (between building floors) and one or more horizontal data planes (within a floor or in multiple (e.g., contiguous) floors). In some cases, the horizontal and vertical data planes have (e.g., substantially) the same or similar data carrying capabilities and/or data communication carrying components. In other cases, these two data planes have at least one different data carrying capability. In one example, the vertical data plane contains data carrying communication components that support at least about 10 Gigabit/second or faster Ethernet transmissions (e.g., using UTP wires and/or fiber optic cables), and the horizontal data plane contains data carrying components that also support at least about 10 Gigabit/second or faster gigabit Ethernet transmissions, e.g., via optical fiber. In some cases, the horizontal data plane supports data transmission via a communication protocol (e.g., G.hn protocol and/or a MoCA protocol such as the MoCA 2.5 standard or the MoCA 3.0 standard). In certain embodiments, connections between at least two floors on the vertical data plane employ control panels with (e.g., high speed) Ethernet switches. These same control panels may communicate with node(s) on a given floor via a (e.g., high-speed) a switch (e.g., optical fiber switch) and/or a communication protocol (e.g., MoCA) interface and associated (e.g., coaxial) cables disposed on the horizontal data plane.

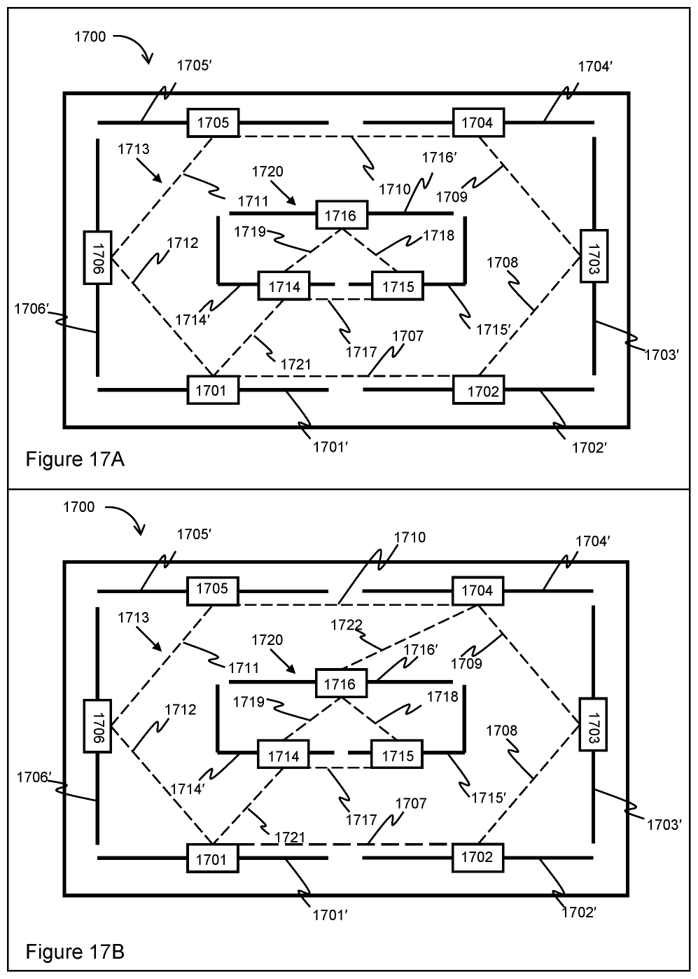

FIG. 17A shows an example of a physical network topology for a floor 1700 of a building includes distributed control panels 1701, 1702, 1703, 1704, 1705 and 1706 connected to one another in series by segments of firs wiring (e.g., fiber optic or other cable) 1707, 1708, 1709, 1710, 1711 and 1712 to form a primary first wiring ring 1713. The network also includes distributed control panels 1714, 1715 and 1716 connected to one another in series by segments of first wiring 1717, 1718 and 1719 to form a secondary first wiring ring 1720 within the primary ring 1713. The first wiring designates a first wiring type. The secondary ring 1720 is connected to the primary ring 1713 by a segment of first wiring 1721. Each distributed control panel 1701, 1702, 1703, 1704, 1705 and 1706 forms a node in the primary ring 1713, while each distributed control panel 1714, 1715 and 1716 forms a node in the secondary ring 1720. Each distributed control panel 1701, 1702, 1703, 1704, 1705, 1706, 1714, 1715 and 1716 is also connected to a corresponding second wiring (e.g., coaxial cable) network branch 1701′, 1702′, 1703′, 1704′, 1705′, 1706′, 1714′, 1715′ and 1716′. The second wiring designates a second wiring type. The primary ring 1713 extends around the floor adjacent the perimeter of the floor, while each of the primary ring second wiring network branches 1701′, 1702′, 1703′, 1704′, 1705′ and 1706′ extend along a respective portion of the perimeter of the building floor. The secondary ring 1720 extends around the center of the floor, within the primary ring 1713, as do each of the secondary ring second wiring network branches 1714′, 1715′ and 1716′. The control panels and second wiring lines of the secondary ring are located in the interior regions of a building's floor, e.g., interior to the floor's physical perimeter where the primary ring 1713 is located. The secondary ring may be located on and/or within the interior walls, fixtures, or other structures of a floor. Such structures are typically constructed after the building's perimeter or skin is constructed. Thus, in some cases, a floor's primary ring is constructed before its secondary ring. The first and second wiring may be of the same wiring type. The first and second wiring may be of a different wiring type.

As in the embodiment shown in the example shown in FIG. 16A, each second wiring network branch 1701′, 1702′, 1703′, 1704′, 1705′, 1706′, 1714′, 1715′ and 1716′ includes one or more branch devices coupled to linear second wiring branch lines by corresponding second wiring drop lines (and device controllers as required). Each distributed control panel 1701, 1702, 1703, 1704, 1705, 1706, 1714, 1715 and 1716 includes a corresponding headend unit and has a corresponding AC power supply. The headend unit in each distributed control panel functions as a gateway for data communication between the first wiring primary ring 1713 or the first wiring (e.g., fiber optic) secondary ring 1720 and the respective second wiring (e.g., coaxial cable) network branch. Similar to the embodiment shown in FIG. 16, the first wiring primary ring 1713 and the first wiring secondary ring 1720 connect the distributed control panels on the rings to the building Ethernet network for (e.g., high-speed) data communication purposes. In addition, the second wiring network branches placed around the rings connect the various distributed control panels to the branch devices for the supply of both electrical power and data. Electrical power is supplied to the distributed control panels by the dedicated AC power supplies, which is rectified to DC within the distributed control panels and transmitted to the branch devices via the second wiring branch lines. Data from the first wiring primary and secondary rings 1713 and 1720 is received by the headend units in the distributed control panels and transmitted to the branch devices via the second wring branch lines using, e.g., a communication protocol (e.g., a G.hn, MoCA, and/or a cellular protocol). Instead of AC power, DC power may be transmitted using a power-line communication (PLC) and/or electrical power over ethernet method.

In the example shown in FIG. 17A, each distributed control panel node in the primary ring 1713 is accessible by two different first wiring (e.g., fiber optic) paths due to the network ring topology. In addition, each distributed control panel node in the secondary ring 1720 is also accessible by at least two different first wiring paths. Through the use of network protocols such as Spanning Tree Protocol (STP), it is possible to build fault-tolerance redundancy into the floor network in a similar way as in the embodiment shown in FIG. 16A. For example, if a given node in the primary ring 1713 develops a fault which hinders (e.g., prevents) communication of signals through that node, communication with neighboring nodes on the primary ring is not prevented as each node can be reached via an alternative path. Similarly, if distributed control panels 1715 or 1716 in the secondary ring 1720 develop a fault which hinders (e.g., prevents) communication of signals through that node, communication with neighboring nodes on the secondary ring is not hindered (e.g., prevented) as they can be reached via an alternative path.

The inclusion of a secondary ring in the floor network can enable data and electrical power to be supplied to one or more branch devices located within the interior of the building. For example, such a network topology can be suited to floor designs which incorporate internal rooms, other closed spaces, or internal open spaces, such as atria. Interior open spaces may be surrounded by branch targets (e.g., devices) such as electrochromic windows, antennas, or sensor units. Accordingly, the secondary ring may be arranged around an interior perimeter of the building, e.g., around a perimeter of an internal open space in the building. A secondary ring topology may be suited to floor designs which do not incorporate internal open spaces. In such embodiments, the secondary ring may supply electrical power and data to branch devices located within the interior of the building, for example to electrochromic windows incorporated into room dividers, to internal sensors, or to burglar alarms.

The primary ring 1713 and secondary ring 1720 of the floor network may be installed at the same time, or at different times. The times may be during and/or after construction of the building. For example, the secondary ring 1720 may be installed after the primary ring 1713 is installed. In some embodiments, the primary ring 1713 may be installed when the building is constructed and the secondary ring 1720 may be added to the floor network later, when the interior arrangement of the floor is determined or reconfigured.

FIG. 17B shows an example of a physical network topology for a floor 1700 of a building includes distributed control panels 1701, 1702, 1703, 1704, 1705 and 1706 connected to one another in series by segments of the first wiring (e.g., fiber optic or other cable) 1707, 1708, 1709, 1710, 1711 and 1712 to form a primary first wiring ring 1713. The network also includes distributed control panels 1714, 1715 and 1716 connected to one another in series by segments of first wiring 1717, 1718 and 1719 to form a secondary first wiring ring 1720 within the primary ring 1713. The secondary ring 1720 is connected to the primary ring 1713 at two different locations by segments of first wiring 1721 and 1722. Each distributed control panel 1701, 1702, 1703, 1704, 1705 and 1706 forms a node in the primary ring 1713, while each distributed control panel 1714, 1715 and 1716 forms a node in the secondary ring 1720. Each distributed control panel 1701, 1702, 1703, 1704, 1705, 1706, 1714, 1715 and 1716 is also connected to a corresponding second wiring (e.g., coaxial cable) network branch 1701′, 1702′, 1703′, 1704′, 1705′, 1706′, 1714′, 1715′ and 1716′. The primary ring 1713 extends around the floor adjacent the perimeter of the floor, while each of the primary ring second wiring network branches 1701′, 1702′, 1703′, 1704′, 1705′ and 1706′ extend along a respective portion of the perimeter of the building floor. The secondary ring 1720 extends around the center of the floor, within the primary ring 1713, as do each of the secondary ring second wiring network branches 1714′, 1715′ and 1716′.

The design of the network topology in FIG. 17B is similar to that of the embodiment shown in FIG. 17A. In particular, the first wiring primary ring 1713 and the first wiring secondary ring 1720 connect the distributed control panels on the rings to the building Ethernet network for (e.g., high-speed) data communication purposes, while the second wiring network branches placed around the rings can connect the various distributed control panels to the branch devices for the supply of both electrical power and data.

As in the embodiment shown in FIG. 17A, each distributed control panel node in the primary ring 1713 shown in FIG. 17B is accessible by at least two different first wiring (e.g., fiber optics) paths due to the network ring topology. Each distributed control panel node in the secondary ring 1720 is also accessible by at least two different first wiring paths. Accordingly, through the use of network protocols such as Spanning Tree Protocol (STP), it is possible to build fault-tolerance redundancy into the floor network. For example, if a given node in the primary ring 1713 develops a fault which hinders (e.g., prevents) communication of signals through that node, communication with neighboring nodes on the primary ring is not prevented as each node can be reached via an alternative path. Similarly, if a given node in the secondary ring 1720 develops a fault which hinders (e.g., prevents) communication of signals through that node, communication with neighboring nodes on the secondary ring is not hindered (e.g., prevented) as each node can be reached via an alternative path. The inclusion of two first wiring links 1721 and 1722 between the primary and secondary rings ensures that nodes in the secondary ring remain reachable no matter where a fault occurs in the primary ring (even if it occurs at node forming a network connection to the secondary ring), and vice versa. The first wiring links 1721 and 1722 also ensure that each node in the secondary ring is reachable no matter where a fault occurs in the secondary ring, even if it is at a distributed control panel which is connected directly to the primary ring. Accordingly, the embodiment shown in FIG. 17B has increased fault tolerance redundancy and therefore increased reliability. Among other advantages, this multi-access topology can provide more reliable antenna coverage over entire floor. Thus, wireless communications such as cellular, Wi-Fi, and Bluetooth are less likely to be disrupted if a head end or link malfunctions (e.g., goes down).

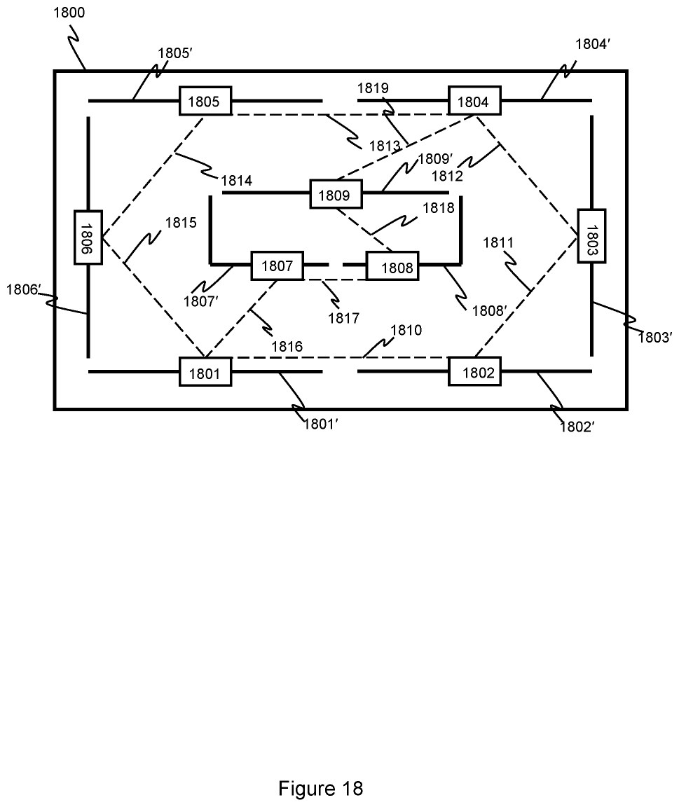

In the embodiment shown in FIG. 18, a physical network topology for a floor 1800 of a building includes distributed control panels 1801, 1802, 1803, 1804, 1805, 1806, 1807, 1808 and 1809 connected to one another in series by segments of first wiring (e.g., fiber optic or other cable) 1810, 1811, 1812, 1813, 1814, 1815, 1816, 1817, 1818 and 1819. Distributed control panels 1801, 1802, 1803, 1804, 1805 and 1806 form nodes of an exterior first wiring ring 1820 which extends around the floor adjacent the perimeter of the floor. Distributed control panels 1801, 1804, 1807, 1808 and 1809 form nodes in a first wiring network chord which links opposing sides of the exterior ring 1820. Accordingly, it is possible to define two sub-rings within the floor network: a first sub-ring connecting distributed control panels 1801, 1802, 1803, 1804, 1807, 1808 and 1809; and a second sub-ring connecting distributed control panels 1801, 1804, 1805, 1806, 1807, 1808 and 1809. Each distributed control panel 1801, 1802, 1803, 1804, 1805, 1806, 1807, 1808 and 1809 is connected to a corresponding second wiring (e.g., coaxial cable) network branch 1801′, 1802′, 1803′, 1804′, 1805′, 1806′, 1807′, 1808′ and 1809′. The design of the network topology in FIG. 18 is similar to that of the preceding embodiments in that the first wiring connect the distributed control panels to the building Ethernet network for (e.g., high-speed) data communication purposes, while the second wiring network branches connect the distributed control panels to the branch devices for the supply of both electrical power and communication signal (e.g., data). Each distributed control panel node in the network shown in FIG. 18 is accessible by at least two different first wiring (e.g., fiber optic) paths due to the interconnected network ring topology. Accordingly, through the use of network protocols such as Spanning Tree Protocol (STP), it is possible to build fault-tolerance redundancy into the floor network. The embodiment shown in FIG. 18 can achieve greater overall fault-tolerance redundancy, and therefore higher reliability, than the embodiment of FIG. 17A, and it achieves similar levels of reliability in comparison to the embodiment of FIG. 17B, although with a reduction in the total length of first wiring required.

In some embodiments, each node in the network (such as each distributed control panel node in the networks shown in FIG. 16A, 17A, 17B, or 10) includes two or more distributed control panels, each containing headends connecting the respective first wiring (e.g., fiber optic) rings to the second wiring (e.g., coaxial cable) branch lines. In such embodiments, a connection between each branch line and the first wiring network would be maintained even if a distributed control panel (e.g. a headend) were to develop a fault. Such further additional fault-tolerance redundancy may be desirable, for example, where branch devices provide communications connectivity (such as connections to external cellular networks).

The embodiments of FIGS. 16A-18, as well as related embodiments employing a ring topology, may provide redundancy and availability. If one control panel, headend, or data link malfunctions (e.g., goes down), most of the devices on the network remain available. The embodiments of FIGS. 16A-18 and related embodiments may be relatively simple to install. In some cases, the network components of an outer ring is first installed and then the network components of an inner ring is installed, or vice versa. In certain embodiments, some or all of the second wiring (e.g., coaxial cable) such as those provided in the examples shown in FIGS. 16A-18) is RG-11 coaxial cable.

The control panels employed in ring topology embodiments (such as shown in the examples of FIGS. 16A-18 comprise network components in various combination options such as (a) electrical power supplies integrated with communications node having communications components such as network switches (same enclosure) or (b) separate electrical power supply and communications node (different enclosures) (e.g., installed at the same location). In various implements control panels provide DC Power and communications to downstream devices such as window controllers and digital architectural elements. As examples, the DC power may be provided with at least about 2 Watts (W), 4 W, or 20 W.

The types of fiber optic cable that can be used, e.g., in the network rings and/or connecting segments, can be selected based at least in part on the data communications needs of the branch devices. Fiber optic cabling can enable data transmission at rates of, e.g., at least about 100 Gbit/s, per channel, over large distances (e.g. over at least about 10 km). Each fiber optic ring may contain multiple individual optical fibers, e.g., to provide necessary bandwidth and/or further fault-tolerance redundancy. Armored fiber optic cabling, such as fiber optic cabling wrapped in aluminum armor, may be used to provide physical protection and/or crush resistance.

The types of coaxial cable used in the coaxial cable network branches may be selected based at least in part on the electrical power supply and/or communication rate needs of the branch devices. In some embodiments, the branch lines of each coaxial network branch are formed using RG-11 coaxial cables. RG-11 coaxial cables are able to support at least about 24V, Class 2, DC power supplies. The conductive lines of RG-11 coaxial cables can be sufficiently thick that the branch lines exhibit low losses and can carry high electrical powers. For example, the loss-per-foot of RG-11 coaxial cable can be at most about one tenth the loss-per-foot of thinner RG-6 coaxial cable. However, different types of coaxial cable can be used to form the branch lines in other embodiments.

In certain embodiments, the coaxial cable drop lines may be formed using RG-6 coaxial cables. RG-6 coaxial cables are thinner and more flexible than RG-11 coaxial cables and may be more suited to supplying electrical power to individual branch devices. The types of coaxial cable used to form the drop lines may be varied. For example, in some embodiments, RG-6 coaxial cable drop lines connect the device controllers to RG-11 coaxial cable branch lines, while M8 cables connect the device controllers to the branch devices.

Smaller diameter coaxial cables serving as drop lines may be connected to larger diameter coaxial cables serving as branch lines by taps. For example, RG-6 coaxial cable drop lines can be connected to RG-11 coaxial cable branch lines, e.g., by distribution junctions (e.g., taps). The taps may be inductive taps which transfer electrical power between the branch lines and the drop lines, e.g., without achieving a direct conductive path between the branch and drop lines. A distribution junction (e.g., tap) may be configured to inject a small fraction of the electrical power transmitted by the branch line into the corresponding drop line.

Distribution junctions (e.g., Taps or splitters) may be employed on trunk line to deliver (e.g., electrical and/or communication signal) power to the drop lines. Unlike a splitter, which divides power or signal in half, a distribution junction (e.g., tap) may draw off a small amount (e.g., a fraction less than a half) of power or signal. e.g., 0.5 W per tap. For example, if a trunk line delivers 15 W to a tap, and 14.5 W of that power is available downstream on the trunk line, 0.5 W shunted to the device via the drop line. A small amount may be less than about 0.1, 0.2, 0.25, 0.3, 0.4, or 0.5 times the electrical power and/or communication signal power. The cabling system (e.g., distribution junction) may couple to the power, e.g., to replenish diminishing power in the cabling system, for example, to facilitate additional power injection downstream of a floor controller.

In some embodiments, the distribution junction is passive. In some embodiments, the distribution junction is dynamic. The distribution junction may comprise a dynamic element such as a control circuitry (e.g., micro-controller). The dynamic element may signal (e.g., the control system) when there is a foreseeable (e.g., imminent) power depletion (e.g., that may necessitate replenishing electrical power to continue activating a target). The dynamic element may facilitate power negotiation. For example, the dynamic element may identify a coupling target (e.g., device) prior to its full coupling to the network (e.g., by probing the target device on connection). The dynamic element may incorporate power negotiation algorithm (e.g., will consider present and/or forecasted power distribution in the cabling system). The power negotiation may comprise a PoE standard that may specify automatic negotiation between client (e.g., target through local controller) and master (e.g., upper hierarchy controller, e.g., in the control panel of the floor). The target device (e.g., client) can provide its (e.g., electrical) power need value, and the master (e.g., controller) can accept or reject depending the demand based at least in part on the total power capacity that the master can allocate (e.g., total capacity that runs on the cabling network that is tied to that controller). The cabling system may comprise device(s) that (i) measure (e.g., DC) voltage along the length of the trunk line, (ii) provide feedback to the control panel and/or other devices, and/or (iii) monitor and/or compensate for excessive voltage drops from loads at greater distances from electrical (e.g., DC) power injection. The maximum power transmitted by the cabling system may follow any International Electrotechnical Commission (IEC) class. The IEC class can be a 0, I, II, or III IEC class. For example, the cabling system may abide by class II of IEC, having maximum 100 VA. The distribution voltage of the DC power can be at least about 12V, 24V, or 48V DC.

In some embodiments, the distribution junction may facilitate transmission of communication signals. The cabling system (e.g., comprising the distribution junction as part of the cabling system) can include one or more signal filters (e.g., low pass filter), e.g., to reduce (e.g., prevent) intermodulation distortion of the signal. The signal filter(s) can be disposed downstream of the targets (e.g., devices), such as (e.g., 4G or 5G) antennas, such as those that utilize higher frequencies. The filter(s) may or may not be integral to the distribution junction. For example, the filter(s) may be integrated on the downstream bus leg of a distribution junction. For example, the filter(s) may be external to (e.g., and operatively coupled to) a distribution junction. The network may utilize Power over Ethernet (PoE) and/or VLAN signaling, e.g., between the (e.g., micro) controller and the target device, e.g., to Authenticate the (e.g., 3^{rd} party) device and/or its power consumption. For example, Link Layer Discovery Protocol (LLDP) protocol may be utilized for the discovery of the target(s). The distribution junction may comprise a system facilitating a repeater, range extender, and/or signal transponder functions, such as a radio frequency (RF) power distributor. The distribution junction may be passive (e.g., including capacitor(s), inductor(s), and/or transformer(s)). The distribution junction may be active (e.g., include a controller, an amplifier and/or pre-amplifier).

In some embodiments, a plurality of devices is operatively coupled (e.g., communicatively and/or physically coupled) to the network. The network may be a local network of a facility. At times, at least one of the devices may require electrical power that exceeds the capacity of the network (or of a branch of the network). When such request is satisfied, the network (or a branch of the network) may be disabled. In order to prevent collapse of the network (or a portion thereof), the network may comprise one or more shutters, switches, or power managers. The power manager may comprise a controller. The switch may comprise a manual or an automatic switch. The shutter may comprise an automatic or manual shutter. The switch may be an on/off switch. The on/off switch may (e.g., temporarily) disconnect a device requesting an excessive amount of electrical power (e.g., above a threshold) from the network, e.g., to prevent a collapse of the network or of a portion of the network. The power manager may manage electrical power request of various devices to (i) prevent power drainage from the network, (ii) allow a maximum number of devices to operate at their intended mode. The maximum number of devices may or may not consider any hierarchy of device operation. For example, devices crucial to safe operation of the facility, health of the facility occupants, and/or operating core functions of the facility, may receive priority over other devices.

In some embodiments, the network may transmit direct current (DC) electrical current. The electrical current may be of class 2 (e.g., having about 100 Watts, about 2 Amp, and about 48 Volts) DC current transmission. The commercially available device(s) may be configured for transmission of DC current in a milliamp range (e.g., a current of at most about 0.1 mA, 1 mA, 10 mA, or 100 mA).

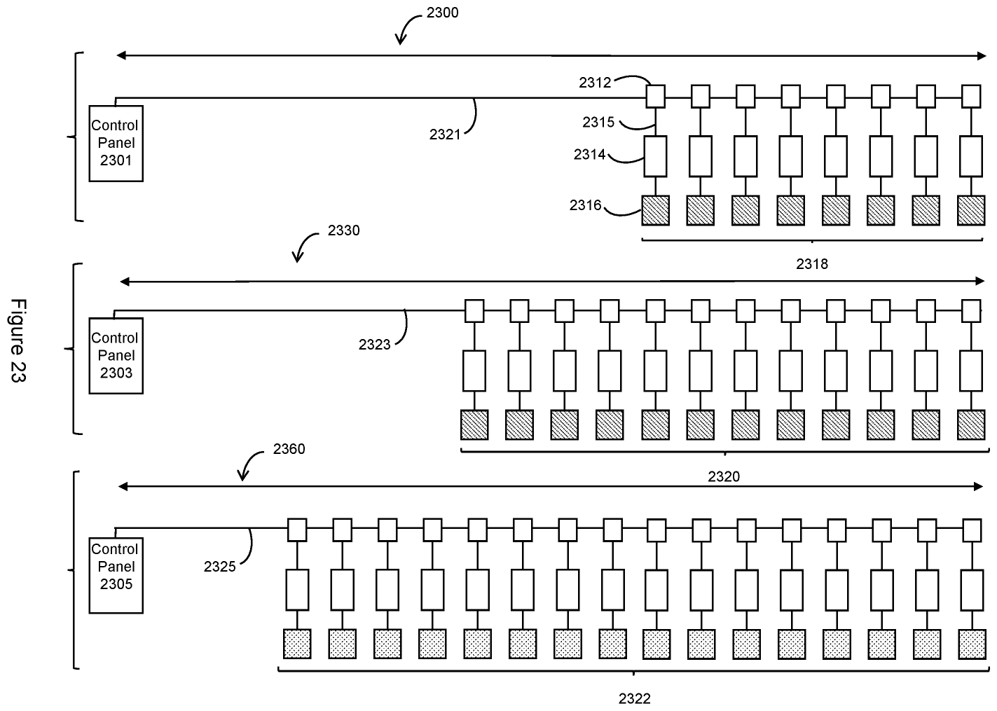

In some embodiments, the cabling network is configured to transmit electrical power and communication signal. The network may comprise a television (TV) related network. The network may be configured to transmit media (e.g., video, stills, movies, or television) communication. The network may be configured to transmit targeted communication (e.g., commercials and/or alerts). The network (e.g., cable thereof) may be configured to transmit electrical signal (e.g., DC current) while providing low-noise communication of a communication (e.g., RF) signal. For example, the cabling network may be configured for minimal distortion of the RF signal passing through the cabling system, e.g., and through the distribution junction that joins various cables of the cabling system. In some embodiments, a problem may arise when an excessive electrical (e.g., DC) current causes oversaturation of inductors that are part of the distribution junction. This may cause reduction in quality of the communication signal passing thorough the inductor, e.g., due to attenuation (e.g., lower amplitude of signal), distortion (e.g., alters frequency of the signal), and/or crosstalk (e.g., signal in one frequency transferred to another frequency). To keep high signal to noise ratio of the communication signal, the end-to-end attenuation of the communication (e.g., RF) signal transmitted through the trunk line should not be too high. High may be defined with respect to the saturation current of the inductor, and/or with respect to the current required to reach a certain level of harmonic distortion of the communication (e.g., RF) signal. The inductor should preferably remain in its linear transfer regime. The inductor should preferably be in a non-saturated condition. The signal attenuation by the distribution junction should be such that the signal will be strong enough to communicate with the device(s) connect to the tap line, and travel through a maximum number of distribution junctions along the trunk line (e.g., and still be able to communicate with the last device coupled to the last distribution junction along the trunk line). In some embodiments, the power of the communication (e.g., RF) signal at the circuitry portion of the distribution junction dedicated to the branch is attenuated at a level from about −20 dB to about −26 dB of the communication signal power transmitted at the trunk line (e.g., from about ¼% to about 1% of the communication (e.g., RF) signal power transmitted at the trunk line). In some embodiments, the power of the communication (e.g., RF) signal at the circuitry portion of the distribution junction that is dedicated to the branch, is attenuated to a level that facilitates connection of at least about 2, 4, 6, 8, 10, 21, 14, 16, 20, 30, 32, 50, 60, or 64 distribution junctions along the trunk line (e.g., identical distribution junctions along the trunk line). In some embodiments, the power of the communication (e.g., RF) signal at the circuitry portion of the distribution junction that is dedicated to the branch, is attenuated to a level that facilitates connection of at least about 2, 4, 6, 8, 10, 21, 14, 16, 20, 30, 32, 50, 60, or 64 devices along the trunk line. In some embodiments, the power of the communication (e.g., RF) signal at the circuitry portion of the distribution junction that is dedicated to the branch, is attenuated to a level that facilitates connection of at least about 2, 4, 6, 8, 10, 21, 14, 16, 20, 30, 32, 50, 60, or 64 branch lines along the trunk line. (e.g., see FIG. 23). In some embodiments, the distribution junction is configured to minimize crosstalk between the communication signals transmitted in the trunk line and the communication signals transmitted to the branch line (e.g., to the tap line). For example, the distribution junction may comprise a directional distribution junction capable of transmitting communication (e.g., RF) signals and electrical (e.g., DC) power, which distribution junction may be configured to sustain a higher electrical current as compared to a distribution junction that is not a directional distribution junction. The directional coupler may provide an electrical power passing coupler that is configured to send most of the communication signal through the trunk line (e.g., connected to the control system), while providing sufficient (decipherable) communication signal to one or more devices connected to (e.g., tapped to) the distribution junction. The distribution junction may or may not offer impedance matching. The distribution junction can have at least 1, 2, 3, 4, 5, 6, 7, or 8 branch lines (e.g., taps). For example, the distribution junction can be a single drop coupler or a multidrop coupler. Type of distribution junction utilized may depend on installation configuration. The distribution junction can be configured for a Linear Ethernet type network. The fundamental length scale (FLS) of the distribution junction can be at most about 0.25 inch (″), 0.5″, 0.75″, 1″, 1.25″, 1.5″, 1.75″, or 2.0″. The FLS of the distribution junction can be of any value between the aforementioned values (e.g., from about 0.25″ to about 2.0″, from about 0.25″ to about 1″, from about 0.75″ to about 1.25″, or from about 1″ to about 2″).

In some embodiments, the distribution junction comprises a switch. The switch may comprise an automatically resetting thermal switch (e.g., fuse). The switch may be incorporated into the circuitry of the distribution junction. The switch may comprise a Positive Temperature Coefficient (PTC) switch. The switch may be triggered by a temperature increase above a threshold. The PTC can be included in the branching (e.g., tapping) portion of the circuitry. The switch may be a reset switch. The switch may be configured such that once electrical power is taken from the switch, the PTC returns to its original state (e.g., reset the switch). The switch may be configured to allow electrical (e.g., DC) power and communication (e.g., RF) signals to travel through the trunk line, e.g., during a temporary opening of the switch (e.g., that disables connection of the distribution junction to the branch line (e.g., tap line). The PTC switch may be implemented using a thermally-activated electromechanical on-off switch, an electromechanical thermal cutoff switch, a self-activated thermal switch, a mechanical thermal switch, a bimetallic temperature control switch, a fluid-filled temperature control switch, a digital temperature control switch, an electronic thermal switch, a thermal protector, or any switch, fuse, or link that is self-resetting after a thermal event has taken place. The switch may comprise a resistor such as a thermistor. The switch may comprise a positive (e.g., PTC) or a negative (e.g., NTC) temperature coefficient resistor (e.g., thermistor). The switch may comprise a semiconductor (e.g., metal oxide). The switch may comprise polycrystalline ceramic (e.g., doped polycrystalline ceramic such as, e.g., BaTiO₃). The switch may comprise a material whose resistance rises suddenly at a certain critical temperature. The switch may comprise a thermally sensitive silicon resistor. The switch may be a passive or a dynamic switch. The switch may comprise a fuse. The switch may comprise a polymer (e.g., a polyswitch). In some embodiments, when a current flows through the switch, it may generate heat, which may raise a temperature of the switch, e.g., above the ambient environment temperature. The switch may act as a protection circuitry element.

In some embodiments, the cabling system comprises a distribution junction. The distribution junction may be configured to distribute electrical power and communication (e.g., RF) power. The electrical power can be provided as a direct current (e.g., DC). The distribution junction may include a first port (e.g., an input port) configured for receiving communication and electrical power (e.g., RF power and DC power) from an upstream circuit. The distribution junction can include a second port (e.g., an output port) configured for distributing the communication and electrical power (e.g., RF power and the DC power) to a downstream circuit. The distribution junction may include a third port (e.g., a coupled port) configured for distributing the communication and electrical power (e.g., RF power and the DC power) to a branch circuit (e.g., operatively coupled to a target device).

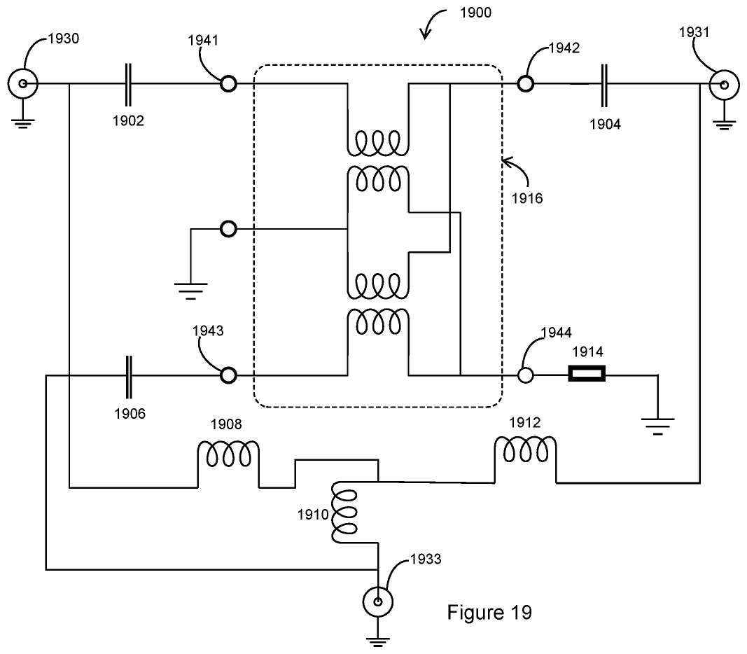

FIG. 19 shows an example of an electronic schematic of an example of a distribution junction 1900. It may be noted that other examples of distribution junctions were discussed herein, e.g., in connection with FIG. 3. In the example shown in FIG. 19, the distribution junction 1900 is configured to distribute electrical power and communication (e.g., RF) power. In the example shown in FIG. 19, the electrical power can be provided as a direct current (DC). The distribution junction 1900 may include a first port 1930 (e.g., an input port) configured for receiving communication and electrical power (e.g., RF power and DC power) from an upstream circuit. The distribution junction 1900 includes a second port 1931 (e.g., an output port) configured for distributing the communication and electrical power (e.g., RF power and the DC power) to a downstream circuit. The distribution junction 1900 includes a third port 1933 (e.g., a coupled port) configured for distributing the communication and electrical power (e.g., RF power and the DC power) to a branch circuit (e.g., operatively coupled to a target device). The distribution junction 1900 includes a first (DC) blocking capacitor 1902, a second (DC) blocking capacitor 1904, a third (DC) blocking capacitor 1906, a first series inductor 1908, a third series inductor 1910, a second series inductor 1912, a matched load 1914, a directional coupler 1916, an input port 1941, a transmitted port 1942, a coupled port 1943, and an isolated port 1944.

In some embodiments, the distribution junction may include a first circuit path for distributing the communication (e.g., RF) power, and a second circuit path for distributing the electrical (e.g., DC) power. For communication (e.g., RF) power distribution, the first circuit path may operate as follows: A first electrical power (e.g., DC) blocking capacitor can be operatively coupled (e.g., in series) between the first port of the distribution junction and an input port of a directional coupler. A second electrical power (e.g., DC) blocking capacitor can be operatively coupled (e.g., in series) between the second port of the distribution junction and a transmitted port of the directional coupler. A third electrical power (e.g., DC) blocking capacitor can be coupled between the third port of the distribution junction and a coupled port of the directional coupler. In some embodiments, the directional coupler may include one or more (e.g., RF) transformers. In some embodiments, the (e.g., RF) transformers may comprise coil windings that are disposed in proximity to ferrite material. Communication (e.g., RF) power may be applied to the first port of the distribution junction. At least some (e.g., all or most) of the applied communication (e.g., RF) power can pass through the first electrical power (e.g., DC) blocking capacitor, and reach the input port of the directional coupler. A first portion of the communication (e.g., RF) power reaching the input port may be outputted by the transmitted port, passing through the second DC blocking capacitor and then outputted by the second port of the distribution junction. A second portion of the communication (e.g., RF) power reaching the input port may be outputted by the coupled port. The second portion can be the difference between the communication (e.g., RF) power reaching the input port, minus the communication (e.g., RF) power that is outputted by the transmitted port. At least some (e.g., all or most) of the communication (e.g., RF) power from the coupled port can pass through the third electrical power (e.g., DC) blocking capacitor, and can be outputted by the third port of the distribution junction.

In some embodiments, the distribution junction comprises an isolated port (e.g., 1944). The directional coupler can be symmetric, with an isolated port (e.g., a fourth port) being provided. At least a portion of the communication (e.g., RF) power reaching the transmitted port may appear at the isolated port. In some embodiments, the directional coupler may not be used in this mode, and the isolated port may be terminated with a matched load (e.g., a resistor of at least a 50-ohm or 75-ohm). Such termination can be internal to the directional coupler, and/or the distribution junction, e.g., whereby the isolated port may not be accessible to the user.

In some embodiments, the distribution junction facilitates electrical power distribution. For electrical (e.g., DC) power distribution, the second circuit path may operate as follows: Electrical (e.g., DC) current applied to the first port may be distributed to the second port through a first series inductor (e.g., 1908) and a second series inductor (e.g., 1912), or any combination thereof. Electrical (e.g., DC) current applied to the first port may be distributed to the third port through the first series inductor (e.g., 1908) and a third series inductor (e.g., 1910), or any combination thereof. The first series inductor (e.g., 1908), the second series inductor (e.g., 1912), and the third series inductor (e.g., 1910), or any combination thereof, may be selected to have a high impedance across a range of frequencies corresponding to the communication (e.g., RF) power applied to the first port. The range of frequencies of the communication signal may comprise one or more frequency components indicative of amplitude as a function of frequency for one or more discrete frequencies, or for one or more discrete bandwidths of frequencies. In some embodiments, the frequency components may include (i) a lowest frequency component, (ii) a highest frequency component, or (iii) a lowest frequency component and a highest frequency component. In some embodiments, the electrical power can be provided as DC current.

In some embodiments, the electrical power can be provided as an alternating current (AC). For example, the AC can be a periodically-varying current at a frequency lower than the lowest frequency component(s) of the communication (e.g., RF) power. The AC electrical power can be a periodically-varying current at a frequency higher than the highest frequency component(s) of the communication (e.g., RF) power. The reactances of the first series inductor, the second series inductor, the third series inductor, first DC blocking capacitor, second DC blocking capacitor, and/or the third DC blocking capacitor, can be selected such that at least a (e.g., major, or substantial) portion of the electrical power (e.g., AC or DC) passes through the inductor(s), e.g., while at least a (e.g., major, or substantial) portion of the communication (e.g., RF) power passes through the capacitor(s). In some embodiments, a signal (e.g., low-pass) filter can be substituted for any of the first series inductor (e.g., 1908), the second series inductor (e.g., 1912), and/or the third series inductor (e.g., 1910). In some embodiments, a signal (e.g., high-pass) filter can be substituted for the first DC blocking capacitor (e.g., 1902), the second DC blocking capacitor (e.g., 1904), and/or the third DC blocking capacitor (e.g., 1906). In some embodiments one or more signal filters may be added to the electronic circuitry of the distribution junction. The filter(s) can include high pass filer and/or low pass filter.

In some embodiments, the distribution junctions housed in a housing (e.g., casing). The casing may have a plurality of connectors (e.g., at least 2, 3, 4, 5, 7, 8, 9, 10, or more connectors). The connectors may be ports. At least two of the plurality of connectors may connect the distribution junction to the bus line (e.g., main line). At least one of the distribution junction connectors may connect the distribution junction to a branch line (e.g., operatively coupled to at least one device). The connectors may be configured to connect to a cable or wire (e.g., a coaxial cable). The connectors may be configured for transmittal of electrical and communication signal (e.g., transmitted on the wire or cable). The housing may comprise an insulating material (e.g., a polymer or a resin). The housing may comprise an elemental metal, a metal alloy, a ceramic, or an allotrope of elemental metal. The housing may comprise a transparent or an opaque material. The housing may facilitate dissipation of heat from its interior. The housing may be configured to facilitate its coupling and/or attachment to a fixture (e.g., a wall or a framing). For example, the housing may comprise one or more incisions or protrusions that facilitate its coupling and/or attachment to a fixture (e.g., a wall or a framing). The housing may be configured to secure the electronic circuitry of the junction, e.g., from external influences (e.g., physical damage, water damage, corrosion, and/or heating). The housing may facilitate coupling of wires(s) and/or cable(s) to the electronic circuitry in the distribution junction, e.g., via connectors (e.g., ports). The ports may include an input port, a transmit port, a coupled port, or any combination or plurality thereof.

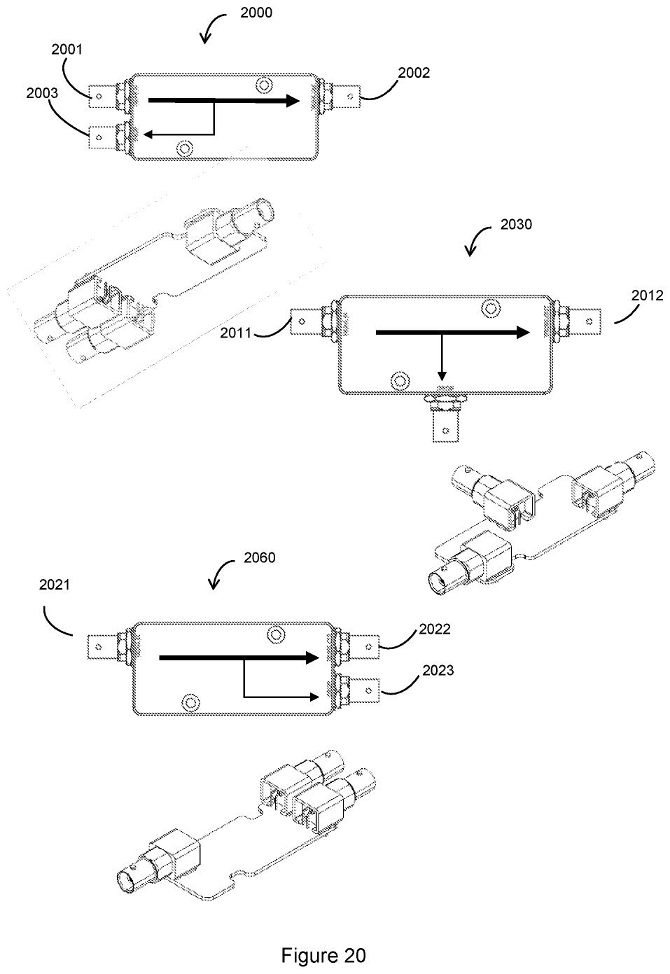

FIG. 20 depicts various illustrative mechanical housing portions and ports related to a first distribution junction 2000, a second distribution junction 2030, and a third distribution junction 2060. The first distribution junction 2000 may include a first port 2001 (corresponding, for example, to the first port 1930 of FIG. 19), a second port 2002 (corresponding, for example, to the second port 1931 of FIG. 19), and a third port 2003 (corresponding, for example, to the third port 1933 of FIG. 19). The first port 2001 (FIG. 20) may function as an input port, the second port 2002 may function as a transmit port, and the third port 2003 may function as a coupled port. A first portion of the communication (e.g., RF) power applied to the first port 2001 (e.g., the input port) can be outputted by the second port 2002 (e.g., the transmitted port). A second portion of the communication (e.g., RF) power applied to the first port 2001 can be outputted by the third port 2003 (e.g., the coupled port). The second portion may be the difference between the communication (e.g., RF) power applied to the first port 2001, minus the communication (e.g., RF) power that is outputted by the second port 2002.

In some embodiments, the distribution junction may comprise at least a first port, a second port, and a third port. The first port (e.g., 2001) and the third port (e.g., 2003) can be situated (for example) side-by-side at a first end of a distribution junction (e.g., 2000), with the second port (e.g., 2002) being situated at a second end of the distribution junction opposite the first end. The first, second, and third ports may be provided, for example, using male BNC connectors, female BNC jacks, male N connectors, female N jacks, male F connectors, female F jacks, male SMA connectors, female SMA jacks, male TNC connectors, female TNC jacks, various other types of connectors, various other types of jacks, and/or any of various combinations thereof. In some embodiments, the first distribution junction may be housed in a metal enclosure. In some embodiments, the first distribution junction may be housed in a non-metallic structure.

In the example shown in FIG. 20, the housing portions and ports related to a second distribution junction 2030 includes a first port 2011 (corresponding, for example, to the first port 1930 of FIG. 19), a second port 2012 (corresponding, for example, to the second port 1931 of FIG. 19), and a third port 2013 (corresponding, for example, to the third port 1933 of FIG. 19). The first port may function as an input port, the second port may function as a transmit port, and the third port may function as a coupled port. The first port can be situated at a first end of the distribution junction, and the third port can be situated at a second end of the distribution junction opposite the first end (e.g., see 2030 of FIG. 20).

In the example shown in FIG. 20, housing portions and ports related to the third distribution junction 2060 includes a first port 2021 (corresponding, for example, to the first port 1930 of FIG. 19), a second port 2022 (corresponding, for example, to the second port 1931 of FIG. 19), and a third port 2023 (corresponding, for example, to the third port 1933 of FIG. 19). The first port may function as an input port, the second port may function as a transmit port, and the third port may function as a coupled port. The first port can be situated at a first end of the distribution junction. The second and third ports respectively, can be situated at a second end of the distribution junction opposite the first end (e.g., see 2060 of FIG. 20).

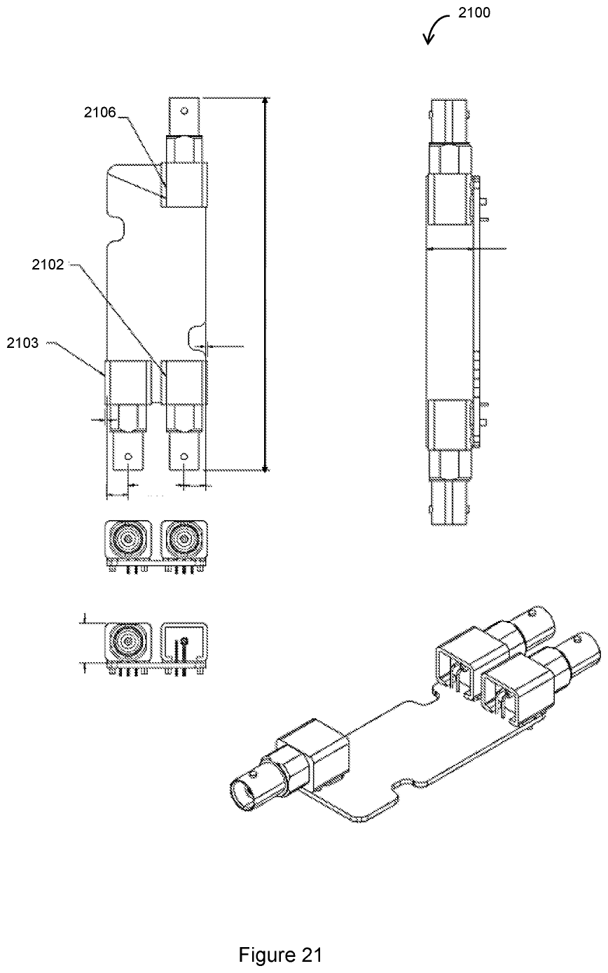

FIG. 21 depicts an illustrative mechanical configuration for a housing portions and ports related to distribution junction 2100 (corresponding, for example, to the third distribution junction 2060 of FIG. 20). The distribution junction 2100 includes a first port 2106 (corresponding to the first port 2021 of FIG. 20), a second port 2102 (corresponding to the second port 2022 of FIG. 20), and a third port 2103 (corresponding to the third port 2023 of FIG. 20).

In some embodiments, the distribution junction is connected to a plurality of branch lines, e.g., as disclosed herein. At least one electrical element of the distribution junction may repeat for each branch. For example, at connector to the branch, an inductor (e.g., series inductor), and/or a switch may be dedicated for a branch. At least one branch dedicated circuitry portion of the distribution junction circuitry may comprise a switch. At least one branch dedicated circuitry portion of the distribution junction circuitry may be devoid of a switch. At least one element of the electronic circuitry is common to a plurality of tap branch circuit portions, e.g., an inductor.

In some embodiments, the distribution junction circuitry comprises a plurality of electronic components. The plurality of electronic components may comprise at least one wire, port, directional coupler, capacitor, coupler (e.g., directional couplers), matched load, inductor (e.g., series inductor), or a switch. The ports may comprise an input port, an output port, a transmitted port, or an isolated port. The port may be configured for distributing the communication power and the electrical power a downstream and/or upstream circuit. The port may be a mono or bi-directional port. The capacitors may comprise an electrical power blocking capacitor. The matched load may having an impedance value that results in maximum absorption of energy from the signal source. The distribution junction may be configured for impedance matching. The distribution junction may be configured to maximize the electrical power transfer. The distribution junction may be configured to maximize the signal to noise ratio. The distribution junction may be configured to minimize signal reflection from the load.

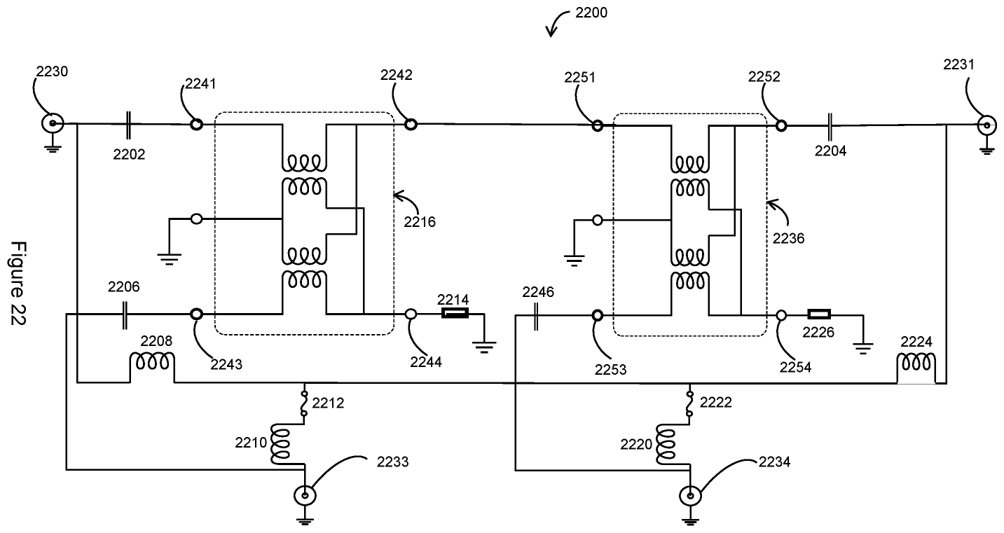

FIG. 22 shows an electronic schematic of a distribution junction 2200 circuitry. The distribution junction 2200 is a cascaded version of the distribution junction 1900 described herein, e.g., with reference to FIG. 19. The distribution junction 2200 may be configured to distribute electrical power and communication (e.g., RF) power. In the example of FIG. 22, the electrical power may be provided as a direct current (DC). The distribution junction 2200 includes a first port 2230 (e.g., an input port) configured for receiving communication (e.g., RF) power and electrical (e.g., DC) power from an upstream circuit. The distribution junction 2200 includes a second port 2231 (e.g., an output port) configured for distributing the communication power and the electrical power to a downstream circuit. The distribution junction 2200 includes a third port 2233 (e.g., a first coupled port) and a fourth port 2234 (e.g., a second coupled port). The third port 2233 and/or the fourth port 2234 can be configured for distributing the communication power and the electrical power to at least one branch circuit. The distribution junction 2200 includes a first directional coupler 2216 in cascade with a second directional coupler 2236. The third port and/or the fourth port may be each configured to operatively coupled to one or more target devices. The distribution junction 2200 includes a first electrical power (e.g., DC) blocking capacitor 2202 operatively coupled in series between the first port 2230 and an input port 2241 of the first directional coupler 2216. The distribution junction 2200 includes an input port 2241 of the first directional coupler 2216, a transmitted port 2242 of the first directional coupler 2216, an input port 2251 of the second directional coupler 2236, a transmitted port 2252 of the second directional coupler 2236, a second electrical power (DC) blocking capacitor 2204, a third electrical power (e.g., DC) blocking capacitor 2206 coupled between the third port 2233 of the distribution junction 2200 and the coupled port 2243 of the first directional coupler 2216, a port 2243 of the first directional coupler 2216, a transmitted port 2242, a fourth electrical power (e.g., DC) blocking capacitor 2246 coupled between a fourth port 2234 and coupled port 2253 of the second directional coupler 2236, an input port 2251 of the second directional coupler 2236 and the coupled port 2253 of the second directional coupler 2236, an isolated port 2244, a matched load 2214, an isolated port 2254, transmitted port 2252, a first series inductor 2208 and a second series inductor 2222, a third series inductor 2210, a fourth series inductor 2220, a first (e.g., automatically-resetting current-limiting cutoff) switch 2212, a second (e.g., automatically-resetting current-limiting cutoff) switch 2228, and a fourth port 2234.

In some embodiments, the distribution junction (e.g., 2200) may include a first circuit path for distributing the communication power, and a second circuit path for distributing the electrical power. For communication power distribution, the first circuit path may operate as follows: Communication power may be applied to the first port of the distribution junction. A first electrical power (e.g., DC) blocking capacitor may be operatively coupled in series between a first port and an input port of the first directional coupler. All or most of the RF applied to the first port may reach the input port of the first directional coupler. A first portion of the communication (e.g., RF) power reaching the input port can be outputted by the transmitted port of the first directional coupler, reaching an input port of the second directional coupler. A first portion of the communication (e.g., RF) power reaching the input port can be outputted by the transmitted port of the second directional coupler. All or most of the communication (e.g., RF) power reaching the transmitted port may pass through the second electrical power (e.g., DC) blocking capacitor and can be outputted by the second port of the distribution junction. A third electrical power (e.g., DC) blocking capacitor (e.g., 2206) may be coupled between the third port (e.g., 2233) of the distribution junction and the coupled port (e.g., 2243) of the first directional coupler (e.g., 2216). A second portion of the communication (e.g., RF) power reaching the input port (e.g., 2241) of the first directional coupler may be outputted by the coupled port of the first directional coupler. The second portion at the coupled port can be the difference between the communication (e.g., RF) power reaching the input port, minus the communication (e.g., RF) power that is outputted by the transmitted port (e.g., 2242). At least a portion (e.g., all or most) of the second portion at the coupled port may pass through the third electrical power (e.g., DC) blocking capacitor and reach the third port (e.g., 2233) of the distribution junction. The communication signal (e.g., RF) power at the third port can be used by one or more downstream devices on one or more branch circuits. A fourth electrical power (e.g., DC) blocking capacitor (e.g., 2246) may be coupled between the fourth port (e.g., 2234) of the distribution junction and the coupled port (e.g., 2253) of the second directional coupler (e.g., 2236). A second portion of the communication signal (e.g., RF) power reaching the input port (e.g., 2251) of the second directional coupler can be outputted by the coupled port of the second directional coupler. The second portion at the coupled port may be the difference between the communication signal (e.g., RF) power reaching the input port, minus the communication signal (e.g., RF) power that is outputted by the transmitted port. At least a portion (e.g., all or most) of the second portion at the coupled port may pass through the fourth electrical power (e.g., DC) blocking capacitor and reach the fourth port of the distribution junction. The communication signal (e.g., RF) power at the fourth port can be used by one or more downstream devices on one or more branch circuits.

In some embodiments, the directional coupler may include one or more communication signal (e.g., RF) transformers. In some embodiments, the communication signal (e.g., RF) transformers may comprise coil windings that are disposed in proximity to ferrite material. The first directional coupler (e.g., 2216) can be symmetric, with an isolated port such as 2244 (e.g., a fourth port) may be provided. A portion of the communication signal (e.g., RF) power reaching the transmitted port will appear at the isolated port. In some embodiments, the first directional coupler may not be used in this mode, and the isolated port (e.g., 2244) may be terminated with a matched load such as 2214 (e.g., having resistance of at least about 50-ohm or 75-ohm). This termination can be internal to the first directional coupler, and/or to the distribution junction, whereby the isolated port may not be accessible to the user. The second directional coupler can be symmetric, with an isolated port such as 2254 (e.g., a fourth port) being provided. A portion of the communication signal (e.g., RF) power reaching the transmitted port (e.g., 2252) may appear at the isolated port (e.g., 2254). In some embodiments, the second directional coupler may not be used in this mode, and the isolated port may be terminated with a matched load such as 2226 (e.g., having resistance of at least about 50-ohm or 75-ohm). Such termination can be internal to the second directional coupler, and/or to the distribution junction, e.g., whereby the isolated port may not be accessible to the user.

In some embodiments, the distribution junction facilitated electrical power distribution comprising a first circuitry path and a second circuitry path. For electrical (e.g., DC) power distribution, the second circuit path may operate as follows: electrical current applied to the first port can be distributed to the second port through a first series inductor (e.g., 2208) and a second series inductor (e.g., 2222). Electrical current applied to the first port (e.g., 2230) can be distributed to a third port (e.g., 2233) through the first series inductor, a first automatically-resetting current-limiting cutoff switch (e.g., 2212), and a third series inductor (e.g., 2210). Electrical current applied to the first port can be distributed to the fourth port (e.g., 2234) through the first series inductor, a second automatically-resetting current-limiting cutoff switch (e.g., 2228), and a fourth series inductor (e.g., 2220). The first series inductor, the second series inductor, the third series inductor and the fourth series inductor may be selected to have a high impedance across a range of frequencies corresponding to the communication signal power applied to the first port. The range of frequencies may comprise one or more frequency components indicative of amplitude as a function of frequency for one or more discrete frequencies, or for one or more discrete bandwidths of frequencies. In some embodiments, the frequency components may include a lowest frequency component and/or a highest frequency component. In some embodiments, the electrical power can be provided as electrical current.

In some embodiments, the electrical power can be provided as an alternating current (AC). For example, the AC can be a periodically-varying current at a frequency lower than the lowest frequency component(s) of the RF power. The AC electrical power can be a periodically-varying current at a frequency higher than the highest frequency component(s) of the communication signal power. The reactances of the first series inductor (e.g., 2208), second series inductor (e.g., 2222), third series inductor (e.g., 2210), fourth series inductor (e.g., 2220), first electrical power blocking capacitor (e.g., 2202), second electrical power blocking capacitor (e.g., 2204), third DC blocking capacitor 2206 and fourth electrical power blocking capacitor (e.g., 2246) can be selected so that at least a (e.g., substantial) portion of the electrical (e.g., AC or DC) power passes through these inductors, e.g., while at least a (e.g., substantial) portion of the communication signal power passes through these capacitors.

In some embodiments, the distribution junction includes at least one switch. The switch can be an automatically resetting switch. The switch can be a current limiting switch. The switch may protect the circuitry and/or device from malfunction e.g., (i) due to supply of harmful amount of electrical current, (ii) due to request of excessive amount of electrical current by the device(s), (iii) due to excessive temperature, or (iv) any combination of (i), (ii), and (iii). The switch may protect the circuitry and/or device from malfunction e.g., due to overheating. For example, the distribution junction may comprise an automatically-resetting current-limiting switch. For example, the distribution junction may comprise a plurality of switches. For example, the distribution junction may comprise a switch prior to the port configured for coupling one or more devices and/or branch lines to the distribution junction. The first (e.g., automatically-resetting current-limiting cutoff) switch (e.g., 2212) may provide protection against any device(s) that would otherwise drain an excessive amount of electrical current from the port (e.g., third port 2233). A second (e.g., automatically-resetting current-limiting cutoff) switch (e.g., 2228) or any other additional switch can provide protection against any device or devices that would otherwise drain an excessive amount of electrical current from the port to which it is coupled (e.g., a fourth port 2234). The switch(es) can comprise: (i) thermally-activated electromechanical on-off switches, (ii) electromechanical on-off switches, (iii) electromechanical thermal cutoff switches, (iv) self-actuated thermal switches, (v) mechanical thermal switches, bimetallic temperature control switches, (vi) fluid-filled temperature control switches, (vii) digital temperature control switches, (viii) electronic thermal switches, (ix) thermal protectors, or (x) any switch, fuse, or link that is self-resetting after an (e.g., thermal or electrical) event has taken place. For example, the cutoff switch(es) can be automatically-resetting thermal switches, fuses, circuit breakers, or positive temperature coefficient (PTC) switches. The switch may be triggered to open by any temperature increase above a threshold. After the PTC switch opens (e.g., creates an open electrical circuit) and electrical power is removed from the PTC, the PTC may reset itself, e.g., by returning to its original (electrically closed) state. In the circuit configuration of FIG. 22, the PTC switch (e.g., 2212 and/or 2228) allows electrical (e.g., DC) power and communication (e.g., RF) signal to travel through the trunk line during an (e.g., temporary) opening of the switch.

In some embodiments, a network infrastructure comprises a trunk line as part of a cabling network, which trunk line comprises a plurality of distribution junctions. The distribution junction can be operatively coupled to at least one controller and/or at least one target device. The trunk line may be operatively coupled (e.g., connected to) a power source and/or a control system (e.g., through a control panel). The control system comprises at least one controller. The control system may be a hierarchical control system.

FIG. 23 shows an example a network infrastructure for a first cabling network 2300, a second cabling network 2330, and a third cabling network 2360. The first cabling network 2300 includes a bus cable 2321 that is connected to a first control panel 2301. The second cabling network 2330 includes a bus cable 2323 that is connected to a second control panel 2303. The third cabling network 2360 includes a bus cable 2325 that is connected to a third control panel 2305. The first control panel 2301, second control panel 2303, and third control panel 2305 can each comprise a network (e.g., comprising floor) controller. The controller can be a main controller, or a controller lower in the hierarchy of controllers. A bus cable can be connected to a plurality of distribution junctions. For example, in FIG. 23, the first bus cable 2321 is connected to eight distribution junctions including a distribution junction 2312. The distribution junction 2312 is connected to one or more downstream devices over a branch cable 2315. The downstream devices include a first downstream device 2314 (e.g., local controller) and a second downstream device 2316 (e.g., a target device such as a sensor, emitter, antenna, tintable window, or display construct). The first cabling network 2300 can use eight distribution junctions to provide eight taps 2318 (e.g., drop lines), where each tap is configured for connection to one or more downstream target devices (e.g., and their local controller(s)). The second bus cable 2323 is connected to twelve distribution junctions to provide twelve taps 2320. The third bus cable 2325 is connected to sixteen distribution junctions to provide sixteen taps 2322. In some embodiments, the maximum number of taps can be determined by the current-producing capacity of a source of electrical power. In some embodiments, the maximum number of taps can be determined by the signal to noise ratio of the communication signal reaching from the signal source, to the most distant device from the source (e.g., traveling the longest trunk line distance and/or cabling distance). In some embodiments, the number of taps (e.g., drops) can be at least about 1, 2, 4, 8, 12, 16, 20, 24, 36, 48, or 72. In some embodiments, the communication signal (e.g., RF) power at each of the taps (e.g., taps 2318) is at most approximately 10 dB, 15 dB, 20 dB, 25 dB, 26 dB, or 30 dB less than the communication signal (e.g., RF) power on the bus cable 2321 (e.g., the trunk line).

In some embodiments, a cabling network (e.g., first cabling network 2300) may include a network bus (e.g., bus cable 2321, also referred to herein as a trunk line) and branch cables (e.g., branch cable 2315). The network bus and branch cables may distribute one or more time-varying (e.g., communication) signals and/or electrical (e.g., DC) power within a network infrastructure. The network bus and branch cables may include one or more signal conductors and one or more ground conductors. The network bus may be formed of multiple circuits coupled together. A first circuit of the network bus may couple together a controller (e.g., within the first control panel 2301) and a distribution junction (e.g., distribution junction 2312). Second and subsequent circuits of the network bus may couple together respective pairs of distribution junctions. A branch cable (e.g., branch cable 2315) may couple a branch circuit (e.g., branch circuit 2314) to a (e.g., respective) distribution junction (e.g., distribution junction 2312). The network bus and branch cables may (e.g., simultaneously) distribute multiple time-varying signals and/or electrical power.

The network bus and branch cables may convey electrical (e.g., DC) power at any desired nominal voltage. As an example, the network bus and branch cables may convey DC power at a voltage of at least about 12V, at 23V, or at 48 volts (V). The network bus and branch cables may follow any International Electrotechnical Commission (IEC) class such as class 0, I, II, or III. As an example, the network bus and branch cables may abide by class II of IEC and may thus carry a maximum of about 100 VA or 100 Watts. The network bus and branch cables may have a wire thickness (e.g., 12, 14, 16 or 18 gauge) sufficient to carry the requested current. The network bus and branch cables may include shielding (e.g., foil shielding, braided shielding, or quad shielding), e.g., to reduce crosstalk and/or interference. The network bus and branch cables may comprise (e.g., be formed from) LMR-200, LMR-240, LMR-400, RG-6, RG-8, RG-11, RG-59, RG-60, RG-174, RG-210, RG-213, 8233, or 8267 coaxial cable, or another type of cable suitable for its intended purpose, e.g., as disclosed herein. The network bus and/or branch cables may distribute any requested number (e.g., 1, 2, 3, 4, 5, or more) of distinguishable time-varying signal frequency sets. The time-varying signal frequency sets may be distributed over non-overlapping frequencies windows. As an example, the network bus and/or branch cables may distribute a first frequency set of time-varying signals over one or more first frequency windows and a second set of time-varying signal frequency over one or more second frequency windows. Frequency windows (in both the first and second sets) may be separated in the frequency-domain (e.g., there may be guard bands between the frequency windows). In some embodiments, some frequency windows (from the first and/or second sets) are not separated by a guard band and/or are partially overlapping in the frequency-domain (e.g., one frequency window end contact another frequency window beginning, e.g., FIGS. 5, 526 and 529). Separating frequency-adjacent frequency windows with guard bands may (i) reduce noise and/or interference, (ii) reduce the cost and/or complexity of network components (e.g., cables, filters, distribution junctions, etc.), or (iii) any combination of (i) and (ii).

In some embodiments, the network distributes time-varying signals. For example, the network may distribute a plurality of time varying signal types. The first set of time-varying signals distributed by the cabling network may include network data signals (e.g., control related signals). The first set of time-varying signals may be digital communications or digital data. The first set of time-varying signals may include signals configured to be transmitted by communications technology that transmits digital information over power lines that used to (e.g., only) deliver electrical power. The first set of time-varying signals may include signals configured to be transmitted by hardware devices designed for communication and transfer of data (e.g., Ethernet, USB and Wi-Fi) through electrical wiring of a building. The first set of time-varying signals may include signals configured to be transmitted by a data transfer protocol that facilitates data transmission rates of at least about 1 Megahertz (MHz), 5 MHz, 10 MHz, 50 MHz, 10 MHz 0, 500 MHz, 1 Gigabits per second (Gbit/s), 2 Gbit/s, 3 Gbit/s, 4 Gbit/s, or 5 Gbit/s. The data transfer protocol may operate over telephone wiring, coaxial cables, power lines, and/or (e.g., plastic) optical fiber. The data transfer protocol may be facilitated using a chip (e.g., comprising a semiconductor device). The first set of time-varying signals may include power line communications signals, such as G.hn, HomePlug®, or HD-PLC compatible signals. The first set of time-varying signals may include signals compatible with the multimedia over coax alliance (MoCA) protocol. The first set of time-varying signals may include signals compatible with other protocols including Ethernet protocols such as 802.3bw, 802.3 bp, 802.3ch, and/or 802.3cq. The first frequency window may extend from approximately 2 Megahertz (MHz) to approximately 200 MHz (e.g., such as used in the G.hn protocol). As an example, the first frequency window may extend from approximately 500 MHz to approximately 600 MHz, from approximately 875 MHz to approximately 1 Ghz, and/or from approximately 1.15 to approximately 1.5 GHz. The second set of time-varying signals distributed by the cabling network may include RF signals. The second-time varying signals may include signals received by or for transmission through an antenna. The second frequency windows may extend from approximately 600 MHz to approximately 1 GHz, from approximately 1.4 GHz to approximately 6 GHz, from approximately 1.7 GHz to approximately 6 GHz. The radio-frequency signals may include cellular network signals such as fourth-generation (4G) and/or fifth-generation (5G) cellular network signals. In some embodiments, the 4G and 5G cellular network signals include signals at or below approximately 6 GHz. The ranges of the first and second set of time varying signals may overlap. The ranges of the first and second set of time varying signals may be separate. The separation may by a signal domain that is not occupied by the first or by the second time varying signals.

In certain embodiments, the data plane infrastructure of FIG. 23, including, e.g., the first, second and third control panels 2301, 2303 and 2305, cabling such as coaxial cables, and network adaptors is used to provide electrical power to nodes on the network. In certain embodiments, electrical power (e.g., provided at about 48 volts DC) is injected into a cable used for the (e.g., horizontal) data plane (e.g., the coaxial cable). In certain embodiments, the control panel includes a power manager. The power manager may be configured to control distribution of power to individual network adaptors and/or end nodes on a network. The individual network adaptors or other nodes may be provided power according to a protocol implemented in the power manager. In some protocols, the end nodes will not be permitted to draw power whenever they want to (e.g., on demand). Various criteria may be employed to decide when and/or how much electrical power to deliver to individual nodes or network adaptors on a network. Such criteria may include, for example, ensuring that the total delivered power on the system does not exceed some threshold, such as a threshold set for a particular electrical standard in the jurisdiction (e.g., of about 100 Watts for class 2 networks in the United States). In some embodiments, one or more end nodes connected to the network are not permitted to draw electrical power (or permitted to draw only a limited amount of electrical power) until they have negotiated with the electrical power manager for electrical power. The electrical power manager, or another network component, may form a virtual network with the end nodes for the purposes of electrical power negotiation and/or network authentication.

In some embodiments, the control system is configured to facilitate power control in the cabling network. The control may comprise electrical power distribution in time and space domains (e.g., according to business logic and/or device requirements). The power manager may be configured to perform operations comprising (i) proposing at least one possible (e.g., optional) schedule for device operation, (ii) considering how long will it take for a given process to occur (from its beginning to its end), (iii) managing (e.g., 3^{rd}) party devices in terms of their operational mode and/or timing—for example, considering operational mode (e.g., continuous or intermittent operation), (iv) considering and/or purposing various intermittent operation schemes, (v) considering when devices are required, (vi) interlacing, aligning and/or matching operational requirement and requests of devices, (vii) disabling (e.g., shutting off) a given device that drains power, e.g., above a threshold value, (viii) delaying operation of a given device, or (ix) any combination of (i) to (viii). The device may have the option to request varied (e.g., higher or lower) power budget. The power manager (e.g., power controller) may be configured to propose priority listing of devices for power use. The power manager can utilize a pre-made priority listing of devices, e.g., in terms of their power usage. The power manager may know where to connect devices (e.g., to which trunk line) in the facility and/or network. The trunk line may be able to connect up to 8, 12, 16, or 32 devices, e.g., in series. The power manager may facilitate automatic electrical power load distribution. The power manager may identify which controller of the control system is connected to which channel and/or to which device(s). The device can be a tintable window, a media display (e.g., a transparent display), device ensemble (e.g., a sensor suite), (e.g., cellular) transceiver. For example, the power manager may consider which device is undergoing which operation (e.g., which transition, given IGU type and dimensions). The power manager may prioritize the power budget according to business logic. The prioritization may comprise product management. The prioritization may be based at least in part on (I) a reasonably inferred logic, (II) spaces of the facility (e.g., a space of a kind and/or having a characteristic), (Ill) occupancy in a space of the facility, (IV) a zone (e.g., occupant zone), (V) device prioritization (e.g., based on device type, device function, and/or device placement in the facility), (VI) external conditions, (VII) amount of power required, (VII) length of time for which power is required, (VIII) voltage draw source identification, or (IX) any combination of (I) to (VIII). The prioritization may utilized logic comprising a higher level abstract business logic. The prioritization may utilize an occupancy scheme of the facility. The prioritization may facilitate a (e.g., structural and/or architectural) model of the facility. For example, the model may comprise a Building Information Modeling (BIM) (e.g., Revit file) of the facility or any enclosure therein. The model may comprise two dimensional (e.g., floor plan) and/or three dimensional modeling (e.g., 3D model rendering) of the facility or any enclosure therein. The logic may or may not comprise a finite element analysis. The logic may comprise, or be utilized in, a simulation. The logic may comprise a generalization logic. The power manager may utilize artificial intelligence (e.g., ML). For example, for devices such as tintable windows, the ML may consider tint transition type, tint transition time for completion, dimension of the tintable window, and/or material properties of the tintable window (e.g., of the electrochromic construct). For example, for devices such HVAC, the ML may consider requested temperature, temperature gradient to requested temperature, enclosure type to adjust temperature, enclosure dimensions, material properties of the fixtures of the enclosure, pressure of the atmosphere of the enclosure, and/or velocity of gas (e.g., air) propelled by the HVAC into and/or out of the enclosure (e.g., room or other facility space). The power manager may identify from where the electrical power demand is coming from, e.g., from which device(s). The power manager may prioritize the supply of power. The power manager may identify the device(s) by their network identification code.

In some embodiments, the power manager utilizes modeling. The modeling may be based at least in part on known forms of behavior that can expected from a controller driving particular operations of the device (e.g., transitioning tint of tintable windows, playing a movie on a display construct, adjusting temperature of a room, broadcasting a message). The power manager may learn and/or utilize known (e.g., historic) power use of the device(s). The historic power usage may be of the device in the facility, of similar devices in the facility, or of similar devices in other facilities. The modeling may include a learning stage. The modeling may utilize a learning set (e.g., based on real-time data gathering and/or historic data gathering). The learning set may comprise synthesized data. The learning set may utilize historical information from this or other sites (e.g., having similar network and/or similar devices coupled to the cabling network). The power manager may include a hardware and/or software interface. For example, the power manager may have a graphical user interface (GUI). The program manager may include an application programming interface (API). The power manager may receive input from a user, e.g., via an GUI of the API. For example, the power manager may solicit and/or accept input regarding a user's preference in terms of device usage. For example, a preference for a tint level of a tintable window at a room of the user, a start time preference and/or a selection of a particular media projected on the media display, a timing preference and/or selection of a message broadcast, at least one environmental preference at and/or selection of a room, or any combination thereof. The environmental preferences may comprise lighting, humidity, temperature, gas velocity, gas pressure, volatile organic compound (VOC) level, particulate level, sound level, or any combination thereof. The lighting may comprise lighting intensity, direction, source arrangement, source selection, and/or color. The color may comprise color type, color wavelength, or color gradient. The power manager may or may not be able to override requests by the user. For example, when the request by the user causes a drainage of the electrical power, the power manager may not satisfy the user request. The GUI may communication (e.g., visually project or sound) to the user a denial of the request. The API of the power manager may be installed in a processor of the user, e.g., in a stationary or mobile processor (such as a tablet, mobile phone, or laptop).

The model may comprise Building Information Modeling (BIM) software (e.g., Autodesk Revit) product (e.g., file). The BIM product may allow a user to design a building with parametric modeling and drafting elements. In some embodiments, the BIM is a Computer Aided Design (CAD) paradigm that allows for intelligent, 3D and/or parametric object-based design. The BIM model may contain information pertaining to a full life cycle for a building, from concept to construction to decommissioning. This functionality can be provided by the underlying relational database architecture of the BIM model, that may be referred to as the parametric change engine. The BIM product may use .RVT files for storing BIM models. Parametric objects—whether 3D building objects (such as windows or doors) or 2D drafting objects—may be referred to as families, can be saved in .RFA files, and can be imported into the RVT database. There are many sources of pre-drawn RFA libraries.

The BIM (e.g., Revit) may allow users to create parametric components in a graphical “family editor.” The model can capture relationships between components, views, and annotations, such that a change to any element is automatically propagated to keep the model consistent. For example, moving a wall updates neighboring walls, floors, and roofs, corrects the placement and values of dimensions and notes, adjusts the floor areas reported in schedules, redraws section views, etc. The BIM may facilitate continuous connection, updates, and/or coordination between the model and (e.g., all) documentation of the facility, e.g., for simplification of update in real time and/or instant revisions of the model. The concept of bi-directional associativity between components, views, and annotations can be a feature of BIM.

The BIM model can use a single file database that can be shared among multiple users. Plans, sections, elevations, legends, and schedules can be interconnected. The BIM can provide (e.g., full) bi-directional associativity. Thus, if a user makes a change in one view, the other views can be automatically updated. Likewise, BIM files can be updated automatically in response to an input received from a sensor. BIM drawings and/or schedules can be fully coordinated in terms of the building objects shown in drawings. A base facility (e.g., building) can be drawn using 3D objects to create fixtures (e.g., walls, floors, roofs, structure, windows, and/or doors) and other objects as needed. The BIM model (e.g., BIM virtual model, or BIM virtual file) can incorporate information regarding the structure and/or material associated with the facility. Generally, if a component of the design is going to be seen in more than one view, it can be created using a 3D object. Users can create their own 3D and 2D objects for modeling and drafting purposes. Small-scale views of building components may be created using a combination of 3D and 2D drafting objects, or by importing drafting work done in another computer aided design (CAD) platform, for example, via DWG, DXF, DGN, SAT or SKP.

In some embodiments, when a project database is shared using BIM, a central file can be created which stores a master copy of the project database on a file server. A user can work on a copy of the central file (known as the local file), stored on his/her workstation. Users can save to the central file to update the central file with their changes, and to receive changes from other users. The BIM model can check with the central file whenever a user starts working on an object in the database to see if another user is editing the object. This procedure may prevent two people from making the same change simultaneously and causing a conflict. Multiple disciplines working together on the same project can make their own project databases and link in databases from other consultants for verification. BIM can perform interference checking, which may detect if different components of the building are occupying the same physical space.

In some embodiments, when a structural change takes place in the facility (including in any portion thereof), the BIM model may require manual updates to at least one document associated with the facility to document the change and remain updated. The control system (e.g., using the sensor(s)) of the facility) may (e.g., automatically) feed structural updates to the BIM model, to the logic (e.g., to the AI engine, and/or to the simulation). The structural updates fed by the control system may be done in real time (e.g., as the changes occur), or at a time in which the facility is not occupied (e.g., at night, during the weekend, or during a holiday). The update may be scheduled (e.g., pre-scheduled). The update may take place at a closest time frame to the structural change made (e.g., the first time in which the facility is idle after the structural change has been made). The update may be at a predetermined (e.g., pre-scheduled) intervals, and/or sensed by the sensors operatively coupled to the network.

In some embodiments, one or more models (as disclosed herein) are used by the logic (e.g., by the AI engine). The model may incorporate non-fixed materials, for example, water that occupies pipes, heat capacity of materials, optical absorbance/reflectivity, heat signature, acoustic properties, and/or outgassing/VoC's of materials versus temperature. The model may incorporate openings, time of day, sun angle, and/or penetration depth. The model may be applied to a scenario where room assignments and/or walls are unknown. The model may be applied to a scenario where a dry wall, hallway, open area, reception area, stairs, and/or a closed area are known. The model may include building elements such as fixtures and non-fixtures. The building elements may comprise partitions, walls, floors, roofs, structure, windows, doors, ceilings, cabinets, furniture, desks, cubicles, tables, chairs, ventilation ducts, electrical conduits, lighting fixtures, water supply lines, roof vents, and/or piping for utilities. The model may associate a fixture with one or more physical properties, such as a material for the fixture, a heat capacity for the fixture, an acoustical property for the fixture, and/or any of a number of other physical properties.

The model can include information about the energy-related characteristics of commercial and/or residential buildings. For example, as mentioned previously, the model can include information from a Building Performance Database (BPD) maintained by the U.S. Department of Energy. In some embodiments, the BPD combines, cleanses and/or anonymizes data collected from buildings by jurisdictional authorities (e.g., federal, state and local governments), utilities, energy efficiency programs, building owners and/or private companies. A variety of physical and operational characteristics for a plurality of building types can be stored in the BPD, e.g., to document trends in energy performance. The BPD can allow users to create and/or save customized datasets based on specific variables, e.g., including building types, locations, sizes, ages, equipment, and/or operational characteristics. The BPD can allow users to compare buildings using statistical or actuarial methods. The BPD can comprise a graphical web interface and/or an API (e.g., of the power manager and/or a web API), which may allow applications and/or services to dynamically query the BPD.

In some embodiments, various target devices (e.g., IGUs) are grouped into zones of target devices (e.g., of EC windows). At least one zone can include a subset of the target devices (e.g., media displays, sensors, emitters, and/or IGUs). For example, at least one (e.g., each) zone of target devices may be controlled by one or more controllers of the control system. At least one (e.g., each) zone can be controlled by a single floor controller (e.g., network controller) and two or more local controllers (e.g., window controllers) controlled by the single floor controller. For example, a zone can represent a logical grouping of the target devices. At least one (e.g., each) zone may correspond to a set of target devices in a specific location or area of the facility that are driven together based at least in part on their location. For example, a building may have four faces or sides (a North face, a South face, an East Face, and a West Face) and ten floors. In such an example, each zone may correspond to the set of target devices (e.g., electrochromic windows, antenna, lighting, or vents) on a particular floor and on a particular one of the four faces. At least one (e.g., each) zone may correspond to a set of target devices that share one or more physical characteristics (for example, device parameters such as size, material, type, or age). In some embodiments, a zone of target devices is grouped based at least in part on one or more non-physical characteristics of the target devices such as, for example, placement in the facility, intended purpose, or a security designation or a business hierarchy. For example, IGUs bounding managers' offices can be grouped in one or more zones while IGUs bounding non-managers' offices can be grouped in one or more different zones. The zones may be defined according to occupancy (e.g., occupant zones) in the facility, functionality of various enclosures of the facility (e.g., offices, conference rooms, cafeterias, entrance halls, corridors, laboratories, and the like), non-fixture (e.g., mobile furniture) placement within the enclosure, and/or fixture (e.g., wall) location within the facility.

In some embodiments, at least one (e.g., each) floor controller is able to address all of the target devices in at least one (e.g., each) of one or more respective zones. For example, the master controller can issue a primary tint command to the floor controller that controls a target zone. The primary tint command can include an (e.g., abstract) identification of the target zone (hereinafter also referred to as a “zone ID”). For example, the zone ID can be a first protocol ID. The floor controller may receive the primary tint command including the tint value and the zone ID. The floor controller may map the zone ID to the second protocol IDs associated with the local controllers (e.g., window controllers) within the zone. In some embodiments, the zone ID is a higher level abstraction than the first protocol IDs. The floor controller can first map the zone ID to one or more first protocol IDs, and subsequently map the first protocol IDs to the second protocol IDs.

In some embodiments, an electrical power management protocol may employ a defined set of communications between the electrical power manager and one or more network adaptors or nodes. For examples, requests for electrical power may be issued by network adaptors and requests for information may be issued by an electrical power manager. Data containing the timing and/or conditions of electrical power delivery, may be issued from the electrical power manager before electrical power is actually delivered. In certain embodiments, such communications are provided using the (e.g., G.hn) communications protocol. Power over Ethernet (PoA) may be implemented with its own protocol. In certain embodiments, a link layer discovery protocol (LLDP) is employed to provide the relevant communications for electrical power management, whether or not using a Power over Ethernet protocol.

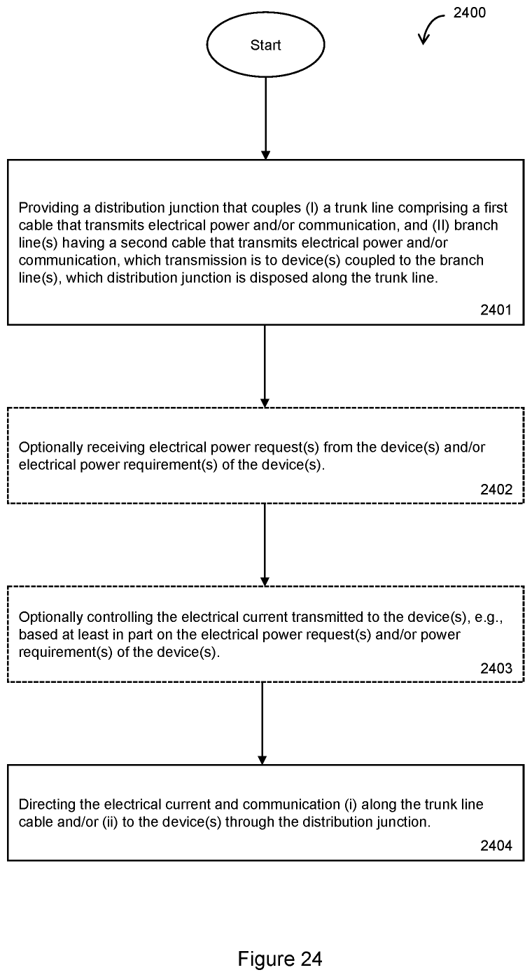

FIG. 24 shows an example of a flowchart depicting an illustrative method 2400 of utilizing a distribution junction. At block 2401, a distribution junction may be provided. The distribution junction may couple a trunk line to one or more branch lines. The trunk line may comprise a first cable that transmits electrical power and/or communication. The branch line(s) may comprise a second cable that transmits electrical power and/or communication. The transmission of electrical power and/or communication may be to one or more devices. The one or more devices can be coupled to the branch line(s). The distribution junction can be disposed along the trunk line. The electrical power may be DC power. At optional block 2402, electrical (e.g., DC) power request(s) can be received from the device(s). Electrical power requirement(s) of the devices can be received. At optional block 2403, the electrical current transmitted to the device(s) can be controlled. The control can be based at least in part on the electrical power request(s) and/or the power requirement(s) of the device(s). At block 2404, the electrical current and the communication may be transmitted and directed along the trunk line cable and/or to the device(s) through the distribution junction.

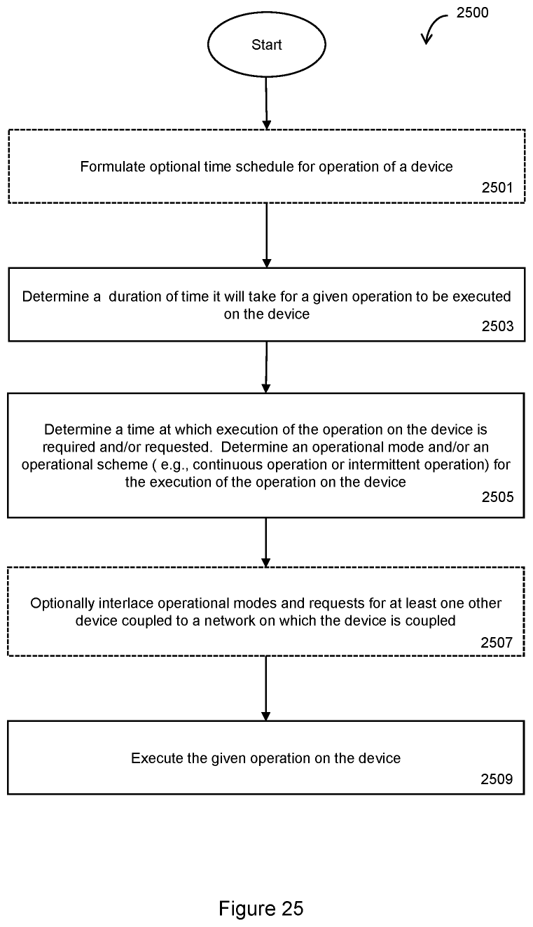

FIG. 25 is a flowchart depicting an illustrative method 2500 of managing a device. The device can be a third-party device, an internal device of the facility and/or network provider. In the method 2500, the order of operations is unrestricted. The operations may be performed in any order, as applicable. At optional block 2501, a time schedule for operation of the device may be formulated. At block 2503, a determination can be made of the duration of time it will take for a given process to be executed on the device (e.g., how much time will it take for a tintable window to reach a requested tint level, or how much time will it take to cool an environment of a room to a requested temperature level). A determination can be made of a time at which execution of the operation on the device is required and/or requested (block 2505). At block 2505, a determination can be made of an operational mode and/or an operational scheme for execution of the operation on and/or by the device. For example, an operational mode can specify a continuous operation or an (regularly or irregularly) intermittent operation. The determination of block 2505 can be based at least in part on operation of at least one other device operatively coupled to the network. At optional block 2507, two or more operational modes may be timewise interlaced (e.g., operational modes of two or more devices may be interlaced in time). Requests can be interlaced for at least one other device coupled to a network on which the device is coupled. For example, a first device may receive intermittent power at a frequency, and a second device may receive intermittent power at the frequency, and the two power frequency may be adjusted such that when the first device does not receive power, the second device will receive power. The given operation may be executed on the device at block 2509.

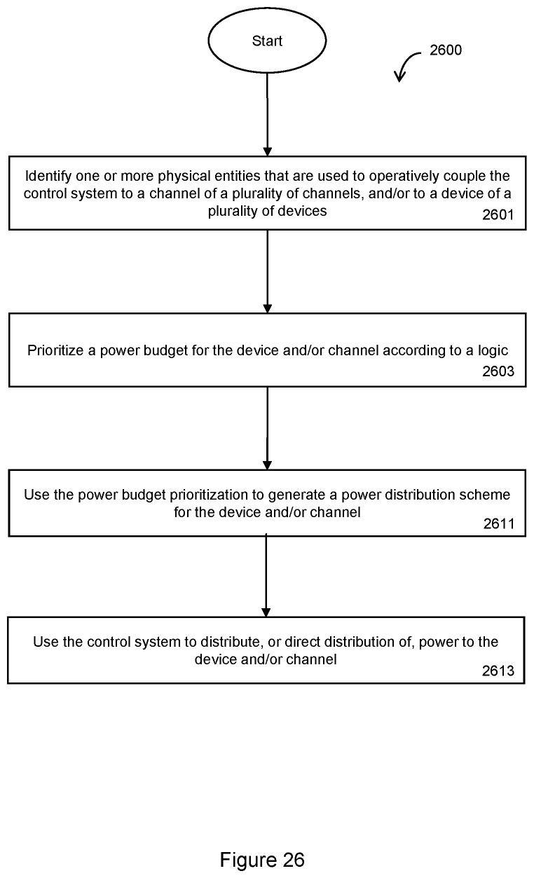

FIG. 26 shows an example of a flowchart depicting an illustrative method 2600 of prioritizing a power budget for a device. At block 2601, a procedure may be performed to identify one or more physical entities that are used to operatively couple the control system to a channel of a plurality of channels, and/or to a device of a plurality of devices. For example, the control system can be operatively coupled to a device via a trunk line, a distribution junction, and a branch cable. At block 2603, a power budget may be prioritized for the device and/or the channel according to a logic. The logic may include (I) business logic, (II) spatial designation, (Ill) device specification, (IV) device power request, (V) a schedule, (VI) external conditions, (VII) device power requirements (e.g., an amount of power and/or a timing for the power), (VIII) power request, and/or (VIII) predicted power usage by the device (e.g., using machine learning (ML), scheduling, and/or historical data). The spatial designation may comprise prioritization of spaces, a space of a kind, a space having a characteristic, an occupancy level, and/or an occupancy zone. The logic may include product management and/or one or more reasonable inferences. The historical data can be drawn from the control system (e.g., from the local controller) that services the device. At block 2611, the power budget prioritization determined at block 2603 can be used to generate a power distribution scheme or plan for the device and/or the channel. Then, at block 2613, the control system can be used to distribute, or direct distribution of, power to the device and/or to the channel.

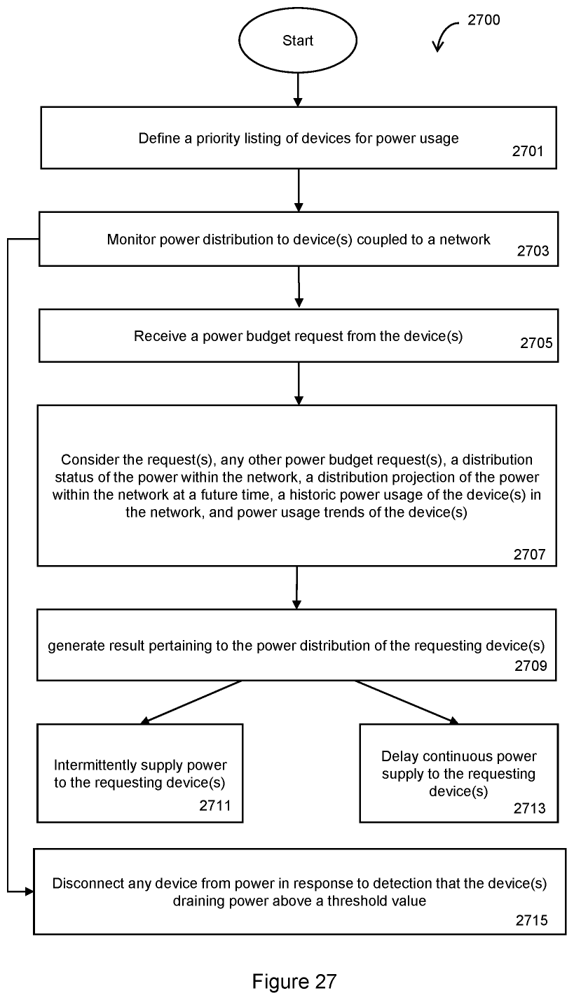

FIG. 27 shows an example of a flowchart depicting an illustrative method 2700 of managing power distribution for a device. A priority listing of devices for power usage may be defined at block 2701. For example, power usage may comprise electrical power usage such as consumption of electrical (e.g., DC) power. Power usage can comprise communication signal (e.g., RF) power usage. The priority listing can be defined at least in part using business logic (for example, such as described with reference to block 2603 of FIG. 26). At block 2703, power distribution can be monitored for devices coupled to a network. This power distribution may comprise electrical power and/or communication signal power. Upon detecting that the device is draining power above a threshold value (e.g., DC power and/or RF power), the method 2700 advances to block 2715 where the device is disconnected from electrical power and/or communication signal power (e.g., respectively—depending on the type of power drainage). Otherwise, the method 2700 advances from block 2703 to block 2705 where a power budget request is received from the device(s). In some embodiments, the power budget request can be for an altered power budget. At block 2707, the power budget request may be considered along with any other power budget request(s). A distribution status of the power within the network (e.g., DC power and/or RF power) can be considered, along with a distribution projection of the power within the network at a future time. A historic power usage of the device(s) in the network may be considered, along with any power usage trends of the device(s). The power usage trends may be compiled using artificial intelligence, e.g., using a machine learning (ML) module. Then, at block 2709, a result is generated pertaining to the power distribution of the requesting device(s). Based at least in part on the result, the method advances to either block 2711 or block 2713. At block 2711, power (e.g., DC power and/or RF power) can be intermittently supplied to the requesting device(s). The intermittent power may be supplied at regular or irregular intervals. At block 2713, a continuous power supply to the requesting device(s) can be delayed.

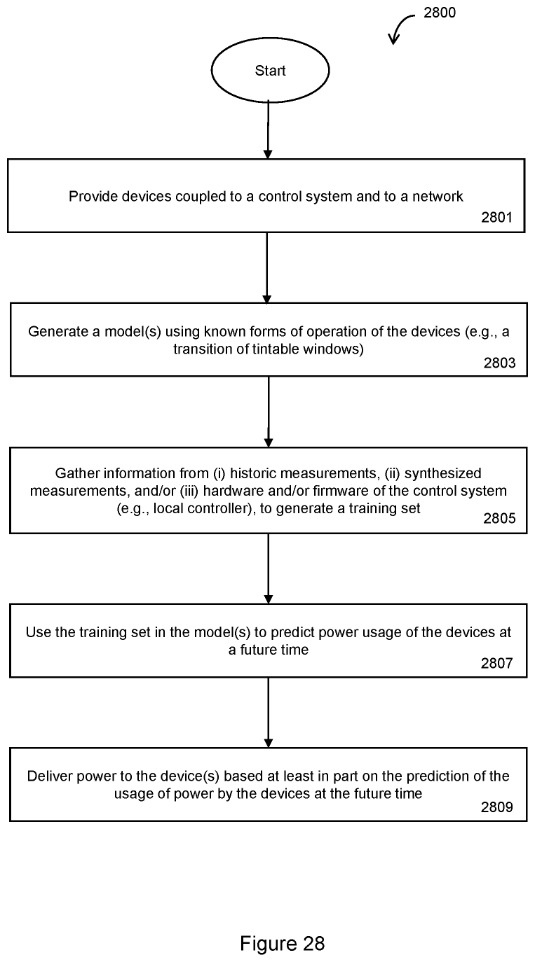

FIG. 28 is a flowchart depicting an illustrative method of managing devices in the context of tintable windows. At block 2801, devices (e.g., tintable windows, media display, sensors, lighting, alarm system, or HVAC system) may be provided. The devices can be coupled to a control system and to a network. At block 2803, one or more models may be generated using known forms of operation of the devices (e.g., a transition of tintable windows, adjusting temperature of a room, displaying media, sounding alarm, or sensing). The modeling can include Artificial Intelligence (AI) such as ML. At block 2805, information is gathered from (i) historic measurements, (ii) synthesized measurements, and/or (iii) hardware and/or firmware of the control system (e.g., local controller), to generate a training set utilized by the AI engine. The training set is used in the model(s) to predict power usage of the devices at a future time (block 2807). Power is delivered to the devices based at least in part on the prediction of the usage of power by the devices at the future time, in block 2809.

In some embodiments, the devices are (e.g., manually) installed by an installer. For example, the tintable (e.g., optically switchable) windows may be installed by an installer (e.g., glazier). The installer (e.g., a glazier or suitably skilled technician) may install other types of branch targets (e.g., devices), such as sensors, emitters, or security devices, for example at the same time as installing the windows or at a different (e.g., earlier or later) time. Electrical power supply connections, such as AC power supply connections, may be installed by an installer (e.g., electrician). The installer can be an electrician licensed to work with low-voltage electrical systems, e.g., in the jurisdiction in which the building is located. The installer can be an electrician licensed to work with high-voltage electrical systems, e.g., in the jurisdiction in which the building is located. Wiring (e.g., coaxial cabling) can be installed by such an installer, or it may be installed by an installer who is an electrician or tradesperson permitted to work with lower voltages or powers (e.g. a low-voltage electrician) in the jurisdiction in which the building is constructed. The term “licensed electrician” is used herein to refer to an electrician authorized to carry out both low and high voltage and/or power (i.e. class 1 and class 2) installations in the given jurisdiction.

For example, in one embodiment, an installer (e.g., a glazier) installs optically switchable windows in the skin of a building in such a way that optically switchable window connectors (e.g. pigtail cables of each window) extend out of the window curtainwall into plenum space. The installer can install interior vertical mullion channels between adjacent optically switchable windows and lays wiring (e.g., RG-6 coaxial cable) drop lines through the mullion channels, coiling excess wiring (e.g., RG-6 coaxial cable) in the plenum space. The installer may install target(s) (e.g., sensor devices) in the vertical mullions, connected to the wiring drop lines. Alternatively, such targets may be connected to the wiring drop lines at a different (e.g., later) time. An installer (e.g., licensed electrician) can install distributed control panels, e.g., in the plenum space or open space around the perimeter of the building to form the primary ring and optionally, in the interior of the building to form a secondary ring. The installer can connect the distributed control panels to a high-voltage AC power supply and can install a wiring (e.g., fiber optic or other cabling) that form the primary (and, if present, secondary) ring. An installer (e.g., low-voltage electrician) can connect the distributed control panels to the target (s) (e.g., optically switchable windows and/or the sensor devices) by way of wiring (e.g., RG-11 coaxial cable) branch lines extending through the plenum space. The installer (e.g., low-voltage electrician) may connect the target(s) (e.g., optically switchable windows) to the branch lines by way of window controllers and wiring (e.g., RG-6) drop line.

In some embodiments, at least a portion (e.g., all) of the electrical installation work is carried out by a licensed electrician. However, the design of the network topologies shown in, for example, FIGS. 16A, 17A, 17B, and 18 enable an unlicensed electrician or other type of tradesperson to install much of the network once the primary ring of distributed control panels has been installed and/or connected up to the power supply, e.g., during construction of the building framework and/or skin or (e.g., shortly) thereafter. Shortly thereafter may be before occupants inhabit the building, and/or before the building is released for occupation. Accordingly, the overall cost of installing the network of targets (e.g., devices) is reduced. When an excess of wiring (e.g., coaxial cable) drop lines is connected to the wiring (e.g., coaxial cable) branch lines during initial installation, a subsequent addition of branch targets (e.g., devices) to the network may be rendered simpler and more cost-effective as compared to a linear network (e.g., without branch lines, drop lines, and/or taps).

In some embodiments, the cabling network may be coupled to an antenna. The antenna can be coupled to the trunk line extending from the control panel before any distribution junction (T junction) or other devices (that add loss) are coupled to the trunk line. Amplifiers and/or pre-amplifies can be included in the control panel (e.g., of a head controller such as a network controller). Passive antennas can be coupled (e.g., anywhere) on the cabling network, e.g., for DAS-like operation. The signal damping can be reduced at the antenna level and/or at the distribution junction level. Reduction of the signal damping at the distribution junction level may increase a probability that the signal will be distinct (e.g., distinguishable over the noise) after long distance from the source antenna and/or passage through (e.g., many) junctions. Reduction of the signal damping at the antenna level (e.g., using an active antenna) may add cost, power, and/or heat for local amplification and/or filtering.

In some embodiments, the cabling system may be coupled to an external antenna. The external antenna may be an active antenna. The active antenna may comprise a signal amplifier and pre-amplifier. The active antenna may minimize signal coupling (e.g., by the distribution junctions) from antenna to control panel, e.g., by directly connecting the external antenna to the control panel and/or by placing antennas upstream of other devices, such as before the distribution junction, on the first or one of the distribution junctions along the trunk line. The amplifier and/or pre-amplifier may utilize RF power. The active antenna may increase a probability that the signal traveling in the cabling system is strong enough to be deciphered (e.g., above noise level), and weak enough to abide by jurisdictional safety restrictions and cabling specification. The active antennas may add noise and/or signal distortion. The active antenna may complicate the link budget and/or tuning to avoid interference, oscillations, or both interference and oscillations. In some embodiments, the (e.g., external) antenna is a passive antenna.

In some embodiments, the cabling system may be coupled to an internal antenna. Internal antennas. The internal antenna may be an active antenna (e.g., having RF power amplifier and/or pre-amplifier) or a passive antenna. The internal antenna may be a dome antenna, antenna coupled or inscribed on a window, in a window frame (e.g., mullion). Bus bars of the IGU can serve as antenna. 5G communication signal may have a low divergence angle, requiring a plurality of antennas to provide (e.g., cellular) reception coverage (e.g., may require line of site with cell phone). The internal antenna may comprise a dome antennas, e.g., disposed on a corner of an enclosure. The internal antenna may be part of a distributed antenna system (DAS). The antenna may comprise a MIMO antenna. The internal antennas may require a (e.g., dedicated) distribution junction (e.g., a distribution junction having about 50 ohm resistance). The antenna may comprise a transformer that provides impedance matching to the cabling system. The signal communication (e.g. 5G signal below about 6 GHz) may utilize 2×2, or 4×4 MIMO antennas. The signal communication (e.g., 5G millimeter wave) may utilize directional antenna arrays (e.g., 2×2, 4×4 Multi-/Massive-MIMO, having at least 16, 32, 64, or 128 elements).

The protocol(s) used to transmit data to the branch devices may be selected based at least in part on the data transmission speeds required. For example, a branch device such as a weather sensor may require high-speed data communication. Accordingly, coaxial cable network branches including branch devices requiring high-speed data communication may include high-speed devices such as ones configured to implement the G.hn protocol.

In order to implement MoCA power-line communication in a coaxial cable network branch, a MoCA headend device is installed in the headend unit in the corresponding distributed control panel and a MoCA transceiver is installed at each branch device (and/or at the corresponding device controller) to receive and/or transmit MoCA communications. Use of the MoCA 2.5 standard enables data transmission at rates of up about 2.5 Gbit/s across different frequency bands (for example, the MoCA AA band corresponds to frequencies of from about 400 MHz to about 900 MHz, while the MoCA AC band corresponds to frequencies of from about 110 MHz to about 1660 MHz).

In some embodiments, an end device such as an electrochromic window may (e.g., only) require low-speed data communication. Accordingly, coaxial cable network branches including branch devices requiring lower-speed data communication may include low-speed devices such as G.hn devices. In order to implement G.hn power-line communication in a coaxial cable network branch, a G.hn headend device may be provided in the headend unit in the corresponding distributed control panel. In order to implement G.hn power-line communication in a coaxial cable network branch, a G.hn transceiver may be installed at each branch device (and/or at the corresponding device controller), e.g., to receive and/or transmit G.hn communications. Although the G.hn standard may enable data transmission at rates of up to about 2 Gbit/s, transmission rates may (e.g., only) be up to about 200 Mbit/s in practice. G.hn devices may transmit data over a frequency band from about 10 MHz to about 70 MHz.

In some embodiments, transmission of data across different frequency bands (e.g., also referred to herein as “frequency windows,” and “signal frequency set”) and/or at different rates across the same coaxial cable branch line may be achieved, e.g., by communicating using multiple protocols simultaneously (for example by transmitting a first signal frequency set compliant with MoCA protocol, and transmitting a second signal frequency set compliant with G.hn protocol). Appropriately tuned filters (e.g., Inductor and Capacitor filters (LC filters)) can be used to selectively inject signals in desired communication bands from the coaxial cable branch line into the appropriate drop lines, or to hinder (e.g., block) transmission of PLC signals, e.g., to avoid interference such as when different branch devices are controlled on a single branch line.

Power inserts may be used to maintain power, supplement power, and/or increase density. On a given branch line, there may be inserts directly from a control panel. For example, when there are a plurality (e.g., six) devices on a branch, a first portion of (e.g., three) devices closest to the control panel may receive power directly from the main power line (e.g., not from a power insert). For example, the device closest to the control panel may receive power directly from the control panel, the device second closest to the control panel receives power downstream from a tap providing power to the first device, and the device third closest to the control panel receives power downstream from a tap providing power to the second device. To provide more direct power to the fourth through sixth devices, the power distribution system may include a power insert between taps for the third and fourth devices on the branch line (e.g., to supplement adequate supply of power such as for the targets). In this example, the fourth device can receive some or all of its power via the power insert.

In some embodiments, elements of a vertical data plane network are installed in the skin of the building, for example during or (e.g., immediately) following the initial construction of the building framework and/or skin. For example, in some embodiments, one or more elements of the wiring (such as the first wiring (e.g., fiber optic or other cabling of the) ring, the second wiring (e.g., coaxial or other cabling) of network branch lines and/or drop lines, the distributed control panels and/or the branch devices) are installed in the skin of the building.

In some embodiments, the branch targets are devices such as tintable (e.g., optically switchable) windows, sensors or security devices which can be installed in the skin of the building. For example, optically switchable windows may form part of a curtainwall which surrounds the building. Sensors, emitters, and/or security devices may be installed in a curtainwall, for example in frames (such as vertical mullions or channels and/or horizontal sashes or transoms) which surround windows. Sensors, emitters, and/or security devices can be installed in the interior of the building. Windows (e.g., tintable windows) can be installed in the interior of a building (e.g., as at least a portion of an interior wall).

In one embodiment, optically switchable windows are installed in the skin of a building, thereby forming a curtainwall façade which surrounds the framework of the building. Coaxial cabling (such as RG-6 coaxial cabling) drop lines may be connected to at least one of (e.g., each) optically switchable window. The coaxial cabling drop lines can extend away from the optically switchable windows, out of the curtainwall, into a space provided between structural floors or ceilings of the building framework and corresponding raised floors or dropped ceilings (e.g., a plenum space of the building (e.g.,). Distributed control panels can also be installed in the plenum space, or in other open spaces of the building, spaced apart from one another around the perimeter of the building to form nodes of a primary ring. For example, each distributed control panel may be separated from each adjacent distributed control panel around the primary ring by a plurality of (e.g. two or more, three or more, four or more, five or more or six or more) targets such as optically switchable windows. The distributed control panels may be fixedly attached (e.g. bolted) to the building framework, for example to structural support columns of the building framework. AC power supply lines can be installed and/or connected to the distributed control panels. Wiring (e.g., fiber optic or other cabling) can be installed in the plenum space around the perimeter of the building, e.g., connecting the distributed control panels to form a primary ring. Wiring (e.g., Coaxial cabling such as RG-11 coaxial cabling) branch lines can also be installed in the plenum space around the perimeter of the building. The wiring (e.g., coaxial cable) drop lines can be connected to the wiring (e.g., coaxial cable) branch lines, e.g., by way of one or more distribution junctions (e.g., inductive taps). The wiring (e.g., coaxial cable) branch lines can be connected to the corresponding distributed control panels.

In some embodiments, secondary network rings in the interior of the building are installed. Secondary network rings may be installed at the same time as installation of the primary ring around the perimeter of the building, or at a different (e.g., later) time, for example when interior walls of the building are being constructed.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-50. (canceled)

51. A system for a facility, the system comprising:
a trunk line cable configured to transmit an electrical current, a first communication type utilized for control of at least one device, and a second communication type configured for media communication;
a branch line cable configured to transmit (i) the electrical current, (ii) the first communication type, and/or (iii) the second communication type, wherein the branch line cable is configured to couple to the at least one device; and
a distribution junction having a first connection, a second connection, and a third connection, wherein the distribution junction is configured to:
couple along the trunk line cable by the first connection and by the second connection,
couple to the branch line cable by the third connection,
direct the electrical current along the trunk line cable from the first connection to the second connection,
direct the first communication type and/or the second communication type along the trunk line cable from the first connection to the second connection,
direct the electrical current from the trunk line cable to the branch line cable,
direct the first communication type and/or the second communication type from the trunk line cable to the branch line cable, and
operatively couple to the at least one device.

52. The system of claim 51, wherein the distribution junction is configured to facilitate bidirectional communication.

53. The system of claim 51, wherein the distribution junction is configured to direct the electrical current along the trunk line cable from the second connection to the first connection.

54. The system claim 51, wherein directing the electrical current, the first communication type and/or the second communication type, is passive.

55. The system of claim 51, wherein directing the electrical current, the first communication type and/or the second communication type is (i) active, (ii) dynamic, or (iii) active and dynamic.

56. The system of claim 51, wherein directing the electrical current, the first communication type and/or the second communication type is facilitated by at least one controller.

57. The system of claim 56, wherein the at least one controller is disposed in the distribution junction.

58. The system of claim 51, wherein the distribution junction is configured to:
direct the first communication type and/or the second communication type along the trunk line cable from the second connection to the first connection, and
direct the first communication type and/or the second communication type from the branch line cable to the trunk line cable.

59. The system of claim 51, wherein the distribution junction is configured to connect to the at least one device through the branch line cable.

60. An apparatus for controlling at least one device of a facility, the apparatus comprising at least one controller having a circuitry, wherein the at least one controller is configured to:
operatively couple to a cabling system comprising:
a trunk line cable configured to transmit electrical current, a first communication type utilized for control of at least one device, and a second communication type configured for media communication, and
a branch line cable configured to transmit the electrical current, and (i) the first communication type, and/or (ii) the second communication type, wherein the branch line cable is configured to couple to the at least one device;
operatively couple to a distribution junction comprising a first connection, a second connection, and a third connection, wherein the distribution junction is configured to:
couple along the trunk line cable by the first connection and by the second connection,
couple to the branch line cable by the third connection,
direct the electrical current along the trunk line cable from the first connection to the second connection,
direct the first communication type and/or the second communication type along the trunk line cable from the first connection to the second connection,
direct the electrical current from the trunk line cable to the branch line cable, and
direct the first communication type and/or the second communication type from the trunk line cable to the branch line cable;
operatively couple to the at least one device; and
use, or direct usage of, the first communication type to control the at least one device.

61. The apparatus of claim 60, wherein the at least one controller is configured to receive, or direct receipt of, an electrical power request and/or an electrical power requirement from the at least one device.

62. The apparatus of claim 61, wherein the at least one controller is configured to direct the electrical current along the trunk line cable to the at least one device, wherein the electrical current is transmitted through the distribution junction.

63. The apparatus of claim 60, wherein the at least one controller is configured to formulate, or direct formulation of, a time schedule for operation of the at least one device.

64. The apparatus of claim 63, wherein the at least one controller is configured to:
determine, or direct determination of, a duration of time it will take for a given process to occur on the at least one device, and
determine, or direct determination of, when the at least one device is required to operate.

65. The apparatus of claim 60, wherein the at least one device includes a first device configured to issue a first request, and a second device configured to issue a second request, and wherein the at least one controller is configured to interlace, or direct interlacing of, the first request and the second request.

66. The apparatus of claim 60, wherein the at least one controller is configured to prioritize, or direct prioritization of, a power budget for the at least one device and/or the channel according to a logic.

67. The apparatus of claim 66, wherein the logic comprises (i) a device specification (ii) a device power request, (iii) a device power requirement for the at least one device, (iv) a power request from the at least one device, (v) a predicted power usage by the at least one device, (vi) machine learning (ML), (vii) one or more scheduling constraints, (vii) historical data, (viii) product management, or (ix) one or more reasonable inferences.

68. The apparatus of claim 66, wherein the at least one controller is configured to use, or direct usage of, the power budget prioritization to generate a power distribution scheme for the channel of a plurality of channels, and/or a device of the at least one device.

69. The apparatus of claim 60, wherein:
the at least one device comprises a plurality of devices, and the at least one controller is configured to define, or direct defining of, a priority listing of devices for electrical power usage among the plurality of devices, and.
the at least one controller is configured to monitor, or direct monitoring of, electrical power distribution to the plurality of devices, and wherein the plurality of devices is coupled to a network.

70. A system for power and communication transmission in a facility, the system comprising:
a cabling system having a cable configured to transmit electrical current, a first communication type utilized for control of at least one device of the facility, and a second communication type configured for media communication, wherein the cabling system is configured to operatively couple to the at least one device;
a first antenna configured to receive signals of the second communication type external to the facility and transmit signals of the second communication type externally to the facility, wherein the first antenna is operatively coupled to the cabling system;
a second antenna configured to (i) receive signals of the second communication type internal to the facility, and (ii) transmit signals of the second communication type internally in the facility, wherein the second antenna is operatively coupled to the cabling system; and
at least one controller operatively coupled to the cabling system and configured to control the at least one device using the first communication type.
